(19) United States
(12) Patent Application Publication
(10) Pub. No.: US 2008/0174818 A1
(43) Pub. Date: Jul. 24, 2008

(54) SYSTEM AND PROGRAM PRODUCT

(75) Inventor: Yoshiji Kanamoto, Tokyo (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: CANON KABUSHIKI KAISHA, Tokyo (JP)

(21) Appl. No.: 12/015,838

(22) Filed: Jan. 17, 2008

(30) Foreign Application Priority Data
Jan. 23, 2007 (JP) 2007-012963

(51) Int. Cl. G06K 15/00

(52) U.S. Cl. 358/1.15

(57) ABSTRACT

A system adapted to enable a printing system to perform a plurality of print jobs, the system comprises a checker adapted to check data about processing conditions of a certain print job having a certain attribute, a markup language being used for the certain print job and a controller adapted to control the printing system to give priority to printing of another print job over printing of the certain print job based on a checking result by the checker.

### BACKGROUND OF THE INVENTION

1. Field of the Invention

The present invention relates to a system and a program product.

2. Description of the Related Art

In a conventional printing industry, a publication is issued through various processes. These processes include entry of a document, designing of the document, layout editing, comprehensive layout (presentation by printing), proofreading (layout correction and color correction), proof (proof print), block copy preparation, printing, post-process, and shipping.

The commercial printing industry uses an offset reproduction printing press in the printing step, and the block copy preparation step is inevitable. However, once the block copy is prepared, it is difficult and disadvantageous in cost to correct it. In block copy preparation, therefore, careful proofreading (i.e., careful layout check and color confirmation) is indispensable. Some period of time is generally taken until a publication is issued.

Most of apparatuses used in respective processes are bulky and require expert knowledge, and know-how of experts is essential.

In this situation, a POD (Print On Demand) printing system using an electrophotographic or inkjet print apparatus has been proposed in recent years (see Japanese Patent Laid-Open Nos. 2004-310746 and 2004-310747).

The POD printing system eliminates the aforementioned block copy preparation and other complicated processes.

Recently, JDF-compatible printing apparatuses have prevailed in the POD printing system. The JDF (Job Definition Format) is a promising digital format (also called an instruction statement or job ticket) common to all printing processes in the POD printing system that is defined by CIP4 (Cooperation for the Integration of Processes in Prepress, Press and Postpress). The JDF format uses the basic Web format “XML”. The JDF instruction statement can manage all printing processes such that production control, and confirmation of the operating states of devices such as a printing apparatus and bookbinding apparatus can be done on a Web site.

The JDF instruction statement can describe not only instructions to a single device, but also instructions associated with a series of work processes achieved by cooperation between devices, including document entry to delivery of printed materials serving as a final product. Only one JDF instruction statement can also manage a workflow of processes using a plurality of devices. The JDF instruction statement enables cooperation between devices engaged in all printing processes and automation of various devices.

In this situation, JDF-compatible printing apparatuses have been developed for printing systems aimed at the POD market in order to make full use of JDF advantages.

However, practical application of the POD printing system must consider various user needs as follows.

For example, when a digital multifunction peripheral supports the JDF, a job ticket must be allowed to designate print settings. The job ticket is a job instruction statement which can be created without knowing any device specification or configuration information, unlike a printer driver. A variety of job ticket-compliant devices can process jobs in a common format independent of a single device.

If a printing apparatus and system are actually configured considering this, new problems and user needs arise. For example, a printing apparatus (printing system) may not be able to completely execute operations designated by a job ticket depending on the execution environment (e.g., device capability or mounted accessories).

For a user, for example, when he designates printing using a job ticket but the printing apparatus (printing system) cannot create designated printed materials, he may want to cancel processing of the job. Printed materials created by a POD printing system are highly likely to be handled as products to be delivered to customers. In the printing system, printed materials which cannot be delivered to customers are assumed to be dealt as wasteful outputs. In a printing environment such as the POD environment, if the printing system cannot create designated printed materials, it leads to the cost of failure and should be avoided as much as possible. The printing system desirably meets the demand of the user (operator) in the POD environment to reduce the cost of defective outputs.

In some cases, a user may want a printing apparatus (printing system) to output printed materials even if some settings are not reflected. For example, in a printing environment (printing site) such as the POD environment, a finisher other than one directly connected to a printing apparatus may be installed independently of the printing apparatus. In this printing environment, a user may want the printing system to output a print job which can be processed not by the finisher connected to the printing apparatus but by the independent finisher.

As described above, JDF data is promising for versatility, device automation, cooperation between devices, device management, and the like. However, JDF data is not prepared for only one device or a specific type of device. This will result in cases of use and user needs which are hardly dealt with by a JDF-compatible printing apparatus and printing system provided in a printing environment such as the POD environment. At present, practical application of JDF-compatible products and systems is only under examination, and how to cope with such cases of use and user needs is not examined yet, leaving room for study.

It is important to minimize creation of an output result the user does not want, as described above. However, the system productivity, device use efficiency/convenience, and the like should not be sacrificed in order to meet this demand. For example, as a result of inputting a plurality of jobs to a digital multifunction peripheral in the POD system, a plurality of print execution standby jobs may be accumulated in the digital multifunction peripheral. In this configuration, it is important to shorten the print standby time in order to increase the device use efficiency and improve user friendliness. However, the conventional technique cannot minimize creation of an output result the user does not want, while maintaining the system productivity and the like.

Problems arising when the digital multifunction peripheral is used as a component of the POD system have been described. However, the digital multifunction peripheral is not used only as a component of the POD system. Depending on the use environment of the user, the digital multifunction peripheral is used even for an application purpose other than POD. It is also conceivable to use the digital multifunction peripheral in an operational form complying with POD application purposes and other application purposes. This is because the digital multifunction peripheral is a general-purpose device which is manufactured not only for the POD system and has functions other than various POD functions.

More specifically, the digital multifunction peripheral is connected to the POD system and used as an output apparatus in the POD environment. Also, for example, the digital multifunction peripheral is used as a printer which generally receives print jobs from a plurality of users via a network or the like and prints. For descriptive convenience, an output job in the POD environment will be called a JDF job, and a print job except one in the POD environment will be called a normal print job.

When performing printing processing on the basis of a JDF job, as described above, a printing apparatus (printing system) may not be able to completely execute an operation designated by a job ticket depending on the execution environment (device performance, mounting accessories, and the like). When performing printing processing on the basis of a normal print job, a printer driver running on a client PC generates print data. In general, the printer driver generates print data after recognizing the configuration of a printer serving as a print data transmission destination, specifications about its performance information, and its status. For this reason, when performing printing processing on the basis of a normal print job, the problem in printing processing based on a JDF job, i.e., the case where the printing apparatus (printing system) cannot completely execute an operation designated by a job ticket is less likely to occur.

In a case where a normal print job is used, a configuration in which a printing apparatus is shared between a plurality of client PCs connected via a network is generally employed. Hence, a case where a plurality of print execution standby jobs are accumulated in a device as a result of inputting a plurality of print jobs from a plurality of client PCs may frequently occur. In a case where the printing apparatus is used as a shared printer, it is important to shorten the print standby time in order to increase the device use efficiency and improve user friendliness.

In this manner, the purpose of printing processing based on a normal print job is different from that of printing processing based on a JDF job. It is desired to perform proper printing control in accordance with the type of job. However, the conventional configuration cannot execute proper printing processing in accordance with the type of job while minimizing creation of an output result the user does not want.

### SUMMARY OF THE INVENTION

The present invention has been made to solve the above-described problems, and has as its object to provide a technique capable of increasing the system productivity while suppressing an output result the user does not want, in a configuration in which printing processing of a print job (e.g., JDF job) describing printing conditions in a specific format is performed. It is another object of the present invention to provide a technique capable of performing proper printing processing without any cumbersome user operation in a configuration in which the system operates based on a print job (e.g., JDF job) describing printing conditions in a specific format. It is still another object of the present invention to provide a technique capable of improving the job processing productivity of the overall system, the device use efficiency, the device convenience, and the operability of the operator in a configuration in which printing processing is performed based on various types of jobs such as a JDF job and non-JDF job.

According to one aspect of the present invention, a system adapted to enable a printing system to perform a plurality of print jobs, the system comprises:

a checker adapted to check data about processing conditions of a certain print job having a certain attribute, a markup language being used for the certain print job; and

a controller adapted to control the printing system to give priority to printing of another print job over printing of the certain print job based on a checking result by the checker.

Further features of the present invention will become apparent from the following description of exemplary embodiments with reference to the attached drawings.

### BRIEF DESCRIPTION OF THE DRAWINGS

FIG. 1 is a view for explaining an overall POD system 10000;

FIG. 2 is a block diagram for explaining an example of the internal configuration of a printing system 1000;

FIG. 3 is a sectional view for explaining an example of the configuration of the printing system 1000;

FIG. 4 is a sectional view showing an example of the internal structure of a large-volume stacker;

FIG. 5 is a sectional view showing an example of the internal structure of a glue binding apparatus;

FIG. 6 is a sectional view showing an example of the internal structure of a saddle stitching apparatus;

FIG. 7 is a view showing an example of an operation unit 204;

FIG. 8 is a view showing an example of a user interface window;

FIG. 9 is a view showing an example of a user interface window;

FIG. 10 is a view showing an example of a user interface window;

FIG. 11 is a view for explaining various data stored in a ROM 207 included in the configuration of the printing system 1000 to be controlled in an embodiment;

FIG. 12 is a view for explaining various data stored in an HDD 209 included in the configuration of the printing system 1000 to be controlled in the embodiment;

FIG. 13 is a view for explaining the structure of job data of a JDF print job processible by the printing system 1000 to be controlled in the embodiment;

FIGS. 14A and 14B are views for explaining a concrete example of the JDF part of the JDF print job in FIG. 13 processible by the printing system 1000 to be controlled in the embodiment;

FIG. 15 is a table for explaining the internal structure of a mounted option table shown in FIG. 11 among various data stored in the ROM 207 included in the configuration of the printing system 1000 to be controlled in the embodiment;

FIG. 16 is a table for explaining the structure of a device configuration management table stored in a RAM 208 included in the configuration of the printing system 1000 to be controlled in the embodiment;

FIG. 17 is a table for explaining the internal structure of a processing rule table 3302 shown in FIG. 12 among various data stored in the HDD 209 included in the configuration of the printing system 1000 to be controlled in the embodiment;

FIG. 18 is a table for explaining the structure of a JDF analysis result table stored in the RAM 208 included in the configuration of the printing system 1000 to be controlled in the embodiment;

FIG. 19 is a flowchart for explaining the operation of the overall printing system controlled by a controller 205 of the printing system 1000 to be controlled in the embodiment;

FIG. 20 is a flowchart for explaining the detailed operation of a device configuration management program in step S4702 shown in FIG. 19;

FIG. 21 is a flowchart for explaining a detailed operation of executing a JDF print job in step S4710 shown in FIG. 19;

FIG. 22 is a flowchart for explaining the detailed operation of JDF part analysis processing in step S5103 shown in FIG. 21;

FIG. 23 is a flowchart for explaining the detailed operation of device configuration change processing in step S4709 shown in FIG. 19;

FIG. 24 is a view showing a display example of a device setup window in a display control example of a UI unit to be controlled in the embodiment;

FIG. 25 is a view showing a display example of a setup window displayed immediately after a JDF setting button in FIG. 24 is pressed in the display control example of the UI unit to be controlled in the embodiment;

FIG. 26 is a table for explaining the state of the processing rule table rewritten by the controller 205 as a result of pressing an ignore button 6302 by an operation to the JDF setup window shown in FIG. 25;

FIG. 27 is a table for explaining the state of the processing rule table rewritten by the controller 205 as a result of pressing a cancel button 6301 by an operation to the JDF setup window shown in FIG. 25;

FIG. 28 is a flowchart for explaining the operation of the overall printing system controlled by the controller 205 of the printing system 1000 to be controlled in the embodiment; and

FIG. 29 is a flowchart for explaining details of processing rule table change processing in step S4712 of FIG. 28.

FIG. 30 is a view showing an example of a window displayed immediately after a JDF setting button is pressed;

FIG. 31 is a view showing an example of a window displayed in response to press of an advanced setting button;

FIG. 32 is a view showing an example of a print job status confirmation window;

FIG. 33 is a view showing an example of the print job status confirmation window;

FIG. 34 is a view showing an example of the print job status confirmation window;

FIG. 35 is a view showing an example of the print job status confirmation window;

FIG. 36 is a view showing an example of the print job status confirmation window;

FIG. 37 is a view showing an example of the print job status confirmation window;

FIG. 38 is a view showing an example of the print job status confirmation window;

FIG. 39 is a view showing an example of a hold window for a job queued in a hold queue;

FIG. 40 is a flowchart showing the sequence of print job acceptance processing;

FIG. 41 is a flowchart showing the main sequence of print job execution; and

FIGS. 42A and 42B are flowcharts showing the detailed sequence of print job execution processing.

### DESCRIPTION OF THE EMBODIMENTS

Preferred embodiments of the present invention will now be described in detail with reference to the drawings. It should be noted that constituent elements set forth in these embodiments are merely examples and do not limit the scope of the present invention.

### First Embodiment

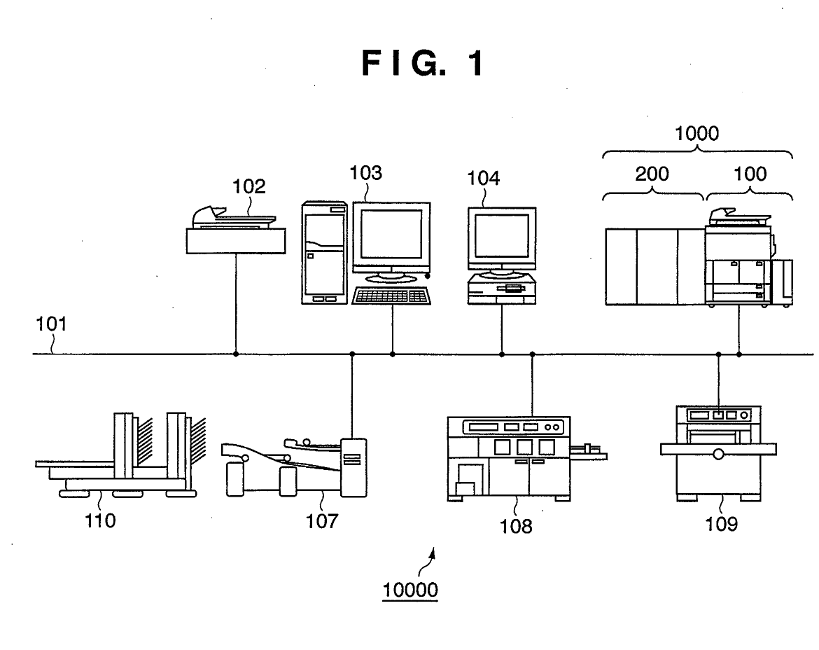

A POD system 10000 in FIG. 1 comprises a printing system 1000, scanner 102, server computer 103 (PC 103), and client computer 104 (PC 104), which are connected to each other via a network 101. The POD system 10000 also comprises a paper folding apparatus 107, cutting apparatus 109, saddle stitching apparatus 110, case binding apparatus 108, and the like.

The printing system 1000 comprises a print apparatus 100 and sheet processing apparatus 200. As the print apparatus 100, the embodiment will exemplify an MFP (Multi Function Peripheral) having a plurality of functions such as the copy and printer functions. However, the print apparatus 100 may be a single function type print apparatus having only the copy or printer function.

The PC 103 manages data exchange with a variety of apparatuses connected to the network 101. The PC 104 transmits image data to the print apparatus 100 and PC 103 via the network 101. The paper folding apparatus 107 folds sheets printed by the print apparatus 100. The case binding apparatus 108 case-binds sheets printed by the print apparatus 100. The cutting apparatus 109 cuts each bundle of sheets printed by the print apparatus 100. The saddle stitching apparatus 110 saddle-stitches sheets printed by the print apparatus 100.

In the use of the paper folding apparatus 107, case binding apparatus 108, cutting apparatus 109, and saddle stitching apparatus 110, the user takes out sheets printed by the print apparatus 100 from the printing system 1000, sets them in an apparatus for use, and causes the apparatus to process them. A plurality of apparatuses in the POD system 10000 of FIG. 1 except for the saddle stitching apparatus 110 are connected to the network 101 so as to communicate data with each other.

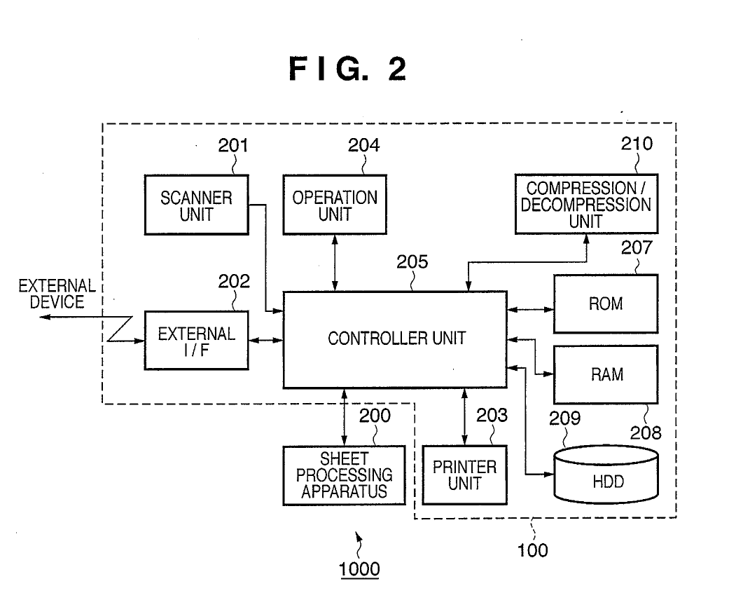

The configuration of the printing system 1000 will be explained with reference to the system block diagram of FIG. 2.

The print apparatus 100 incorporates units shown in FIG. 2 in the printing system 1000 except for the sheet processing apparatus 200. An arbitrary number of sheet processing apparatuses 200 are connectable to the print apparatus 100.

The printing system 1000 is configured so that the sheet processing apparatus 200 connected to the print apparatus 100 can execute sheet processing for sheets printed by the print apparatus 100. It is also possible to form the printing system 1000 from only the print apparatus 100 without connecting the sheet processing apparatus 200.

The sheet processing apparatus 200 can communicate with the print apparatus 100, and execute sheet processing (to be described later) upon receiving an instruction from the print apparatus 100. A scanner unit 201 scans an image on a document, converts the image into image data, and transfers the image data to another unit. An external I/F 202 exchanges data with other apparatuses connected to the network 101. A printer unit 203 prints an image based on input image data on a sheet. An operation unit 204 has a hard key input unit (key input unit) 402 and touch panel unit 401 (to be described later), and accepts an instruction from the user via them. The operation unit 204 provides various displays on its touch panel.

A control unit 205 comprehensively controls the processes and operations of various units and the like in the printing system 1000. The control unit 205 also controls the operation of the print apparatus 100 and that of the sheet processing apparatus 200 connected to the print apparatus 100. A ROM 207 stores various computer programs to be executed by the control unit 205. For example, the ROM 207 stores programs to cause the control unit 205 to execute various processes of flowcharts to be described later, and display control programs necessary to display various setup windows to be described later. The ROM 207 further stores a program to cause the control unit 205 to interpret PDL (Page Description Language) code data received from the PC 103, PC 104, or the like and expand the PDL code data into raster image data. In addition, the ROM 207 stores a boot sequence, font information, and the like. A RAM 208 stores image data sent from the scanner unit 201 and external I/F 202, various programs loaded from the ROM 207, and setting information. The RAM 208 also stores information on the sheet processing apparatus 200 (e.g., information on the number of (0 to n) sheet processing apparatuses 200 connected to the print apparatus 100, information on the function of each sheet processing apparatus 200, or the connection order of the sheet processing apparatuses 200).

An HDD (Hard Disk Drive) 209 includes a hard disk, and a drive unit which reads/writes data from/in the hard disk. The HDD 209 is a large-capacity storage device which stores image data input from the scanner unit 201 and external I/F 202 and compressed by a compression/decompression unit 210. The control unit 205 can cause the printer unit 203 to print image data stored in the HDD 209 on the basis of an instruction from the user. The control unit 205 can also transmit image data stored in the HDD 209 to an external apparatus such as the PC 103 via the external I/F 202 on the basis of an instruction from the user.

The compression/decompression unit 210 compresses/decompresses image data and the like stored in the RAM 208 and HDD 209 in accordance with various compression schemes such as JBIG and JPEG.

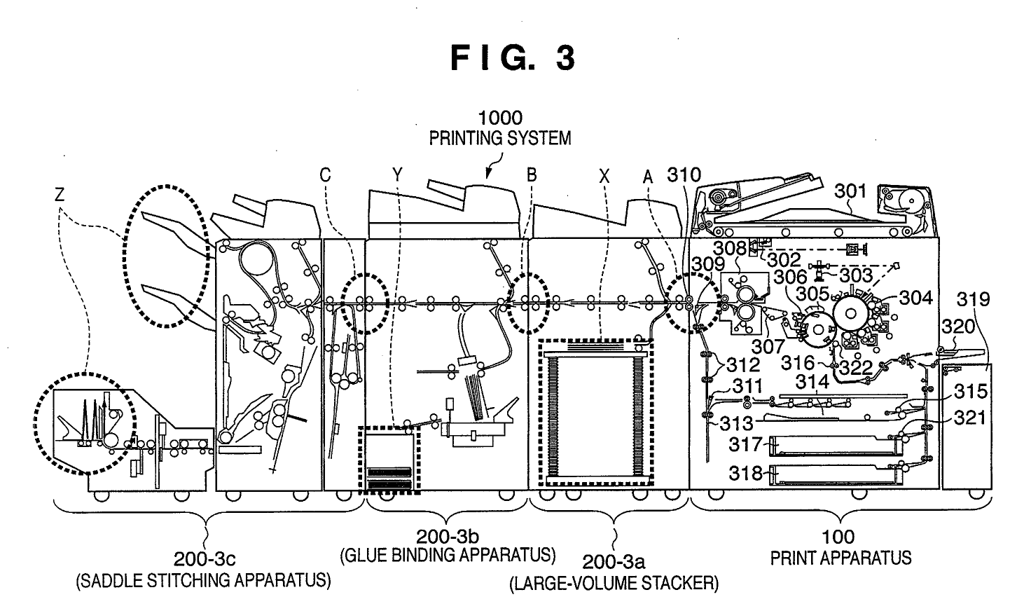

The configuration of the printing system 1000 will be explained with reference to FIG. 3. FIG. 3 is a sectional view of the print apparatus 100 and the sheet processing apparatus 200 connected to it.

An auto document feeder (ADF) 301 separates a document bundle on the support surface of the document tray sequentially in the order of pages from the first document sheet, and feeds each document sheet to the glass document table in order to scan the document sheet by a scanner 302.

The scanner 302 scans the image of the document sheet fed onto the glass document table, and converts the image into image data by a CCD. A rotary polygon mirror 303 receives a light ray (e.g., a laser beam) modulated in accordance with the image data, and irradiates a photosensitive drum 304 with the light ray as a reflected scan beam via a reflecting mirror. A latent image formed by the laser beam on the photosensitive drum 304 is developed with toner, and the toner image is transferred onto a sheet material on a transfer drum 305. A series of image forming processes are executed sequentially with yellow (Y), magenta (M), cyan (C), and black (K) toners, forming a full-color image. After four image forming processes, the sheet material bearing the full-color image is separated by a separation gripper 306 from the transfer drum 305, and conveyed to a fixing unit 308 by a pre-fixing conveyor 307. The fixing unit 308 has a combination of rollers and belts, and incorporates a heat source such as a halogen heater. The fixing unit 308 fuses and fixes, by heat and pressure, toner on a sheet material bearing a toner image. A delivery flapper 309 is swingable about the swing shaft, and regulates the sheet material conveyance direction. When the delivery flapper 309 swings clockwise in FIG. 3, a sheet material is conveyed straight, and discharged outside the apparatus by delivery rollers 310.

The control unit 205 controls the print apparatus 100 to execute single-sided printing according to this sequence.

To form images on the two surfaces of a sheet material, the delivery flapper 309 swings counterclockwise in FIG. 3, and the course of the sheet material changes downward to supply the sheet material to the double-sided conveyor. The double-sided conveyor has a reverse flapper 311, reverse rollers 312, a reverse guide 313, and a double-sided tray 314. The reverse flapper 311 swings about the swing shaft, and regulates the sheet material conveyance direction. To process a double-sided print job, the control unit 205 controls to swing the reverse flapper 311 counterclockwise in FIG. 3 and supply a sheet having the first surface printed by the printer unit 203 to the reverse guide 313 via the reverse rollers 312. While the reverse rollers 312 clamp the trailing end of the sheet material, the reverse rollers 312 temporarily stop, the reverse flapper 311 swings clockwise in FIG. 3, and the reverse rollers 312 rotate backward. The sheet is switched back to replace its trailing and leading ends, and then the sheet is guided to the double-sided tray 314. The double-sided tray 314 temporarily supports the sheet material, and a refeed roller 315 supplies the sheet material again to registration rollers 316. At this time, the sheet material is sent while a surface opposite to the first surface in the transfer process faces the photosensitive drum. The second image is formed on the second surface of the sheet by the same process as that described above. After the images are formed on the two surfaces of the sheet material, the sheet undergoes the fixing process and is discharged outside from the main body of the print apparatus 100 via the delivery rollers 310. The control unit 205 controls the print apparatus 100 to execute double-sided printing according to this sequence.

The print apparatus 100 comprises a paper feed section which stores sheets necessary for print processing. The paper feed section has paper feed cassettes 317 and 318 (each capable of storing, e.g., 500 sheets), a paper feed deck 319 (capable of storing, e.g., 5,000 sheets), and a manual feed tray 320. The paper feed cassettes 317 and 318 and the paper feed deck 319 allow setting sheets of different sizes and materials discriminatively in the respective paper feed units. The manual feed tray 320 also allows setting various sheets including a special sheet such as an OHP sheet. The paper feed cassettes 317 and 318, the paper feed deck 319, and the manual feed tray 320 respectively have paper feed rollers, which successively feed sheets one by one.

The sheet processing apparatuses 200 shown in FIG. 3 will be explained.

In the printing system 1000 according to the embodiment, an arbitrary number of sheet processing apparatuses 200 of arbitrary types are connectable as long as they can convey a sheet from an upstream apparatus to a downstream apparatus via the sheet feeding path. For example, as shown in FIG. 3, a large-volume stacker 200-3a, glue binding apparatus 200-3b, and saddle stitching apparatus 200-3c are connected in the order named closer from the print apparatus 100, and selectively available in the printing system 1000. Each sheet processing apparatus 200 has a sheet discharge portion, and the user can take out a processed sheet from the sheet discharge portion of the sheet processing apparatus.

The control unit 205 accepts, together with a print execution request via the operation unit 204, a request to execute sheet processing of a type desired by the user among sheet processing candidates of types executable by the sheet processing apparatuses 200 connected to the print apparatus 100. Upon accepting a print execution request for a target job from the user via the operation unit 204, the control unit 205 causes the printer unit 203 to execute print processing necessary for the job. The control unit 205 controls to convey printed sheets of the job via the sheet feeding path to a sheet processing apparatus capable of executing sheet processing desired by the user. Then, the control unit 205 causes the sheet processing apparatus to execute the sheet processing.

Assume that a target job whose print execution request is accepted from the user requires large-volume stacking processing by the large-volume stacker 200-3a when the printing system 1000 has a system configuration shown in FIG. 3. This job is called a “stacker job”.

When processing the stacker job in the system configuration of FIG. 3, the control unit 205 controls to convey sheets of the job printed by the print apparatus 100 into the large-volume stacker 200-3a via point A in FIG. 3. Then, the control unit 205 causes the large-volume stacker 200-3a to stack the sheets of the job. The control unit 205 causes the large-volume stacker 200-3a to hold the printed materials of the job stacked in the large-volume stacker 200-3a at delivery destination X inside the large-volume stacker 200-3a without conveying them to another apparatus (e.g., a succeeding apparatus).

The user can directly take out, from delivery destination X, the printed materials of the stacker job held at delivery destination X in FIG. 3. This can omit a series of apparatus operations and user operations to convey sheets to the most downstream delivery destination Z in the sheet conveyance direction in FIG. 3 and take out the printed materials of the stacker job from delivery destination Z.

Assume that a target job whose print execution request is accepted from the user requires sheet processing (e.g., either glue binding of case binding and pad binding) by the glue binding apparatus 200-3b in the system configuration of FIG. 3. This job is called a “glue binding job”.

When processing the glue binding job in the system configuration of FIG. 3, the control unit 205 controls to convey sheets printed by the print apparatus 100 into the glue binding apparatus 200-3b via points A and B in FIG. 3. Then, the control unit 205 causes the glue binding apparatus 200-3b to bind the sheets of the job with glue. The control unit 205 causes the glue binding apparatus 200-3b to hold the printed materials of the job glue-bound by the glue binding apparatus 200-3b at delivery destination Y inside the glue binding apparatus 200-3b without conveying them to another apparatus (e.g., a succeeding apparatus).

Assume that a target job whose print execution request is accepted from the user requires sheet processing by the saddle stitching apparatus 200-3c in the system configuration of FIG. 3. The sheet processing by the saddle stitching apparatus 200-3c includes, e.g., saddle stitching, punching, cutting, shift delivery, and folding. This job is called a “saddle stitching job”.

When processing the saddle stitching job by the system configuration in FIG. 3, the control unit 205 controls to convey sheets of the job printed by the print apparatus 100 into the saddle stitching apparatus 200-3c via points A, B, and C. Then, the control unit 205 causes the saddle stitching apparatus 200-3c to process the sheets of the job. The control unit 205 causes the saddle stitching apparatus 200-3c to hold the printed materials of its saddle stitching job at delivery destination Z in the saddle stitching apparatus 200-3c.

Delivery destination Z has a plurality of delivery destination candidates. This is because the saddle stitching apparatus 200-3c can execute a plurality of types of sheet processes and the delivery destination changes in each sheet process.

As described with reference to FIGS. 1 to 3, the printing system 1000 according to the embodiment allows connecting a plurality of sheet processing apparatuses to the print apparatus 100. These sheet processing apparatuses can be arbitrarily combined and connected to the print apparatus 100. The connection order of the sheet processing apparatuses can be freely changed as long as the sheet feeding paths of the apparatuses link with each other. There are a plurality of types of sheet processing apparatus candidates connectable to the print apparatus 100.

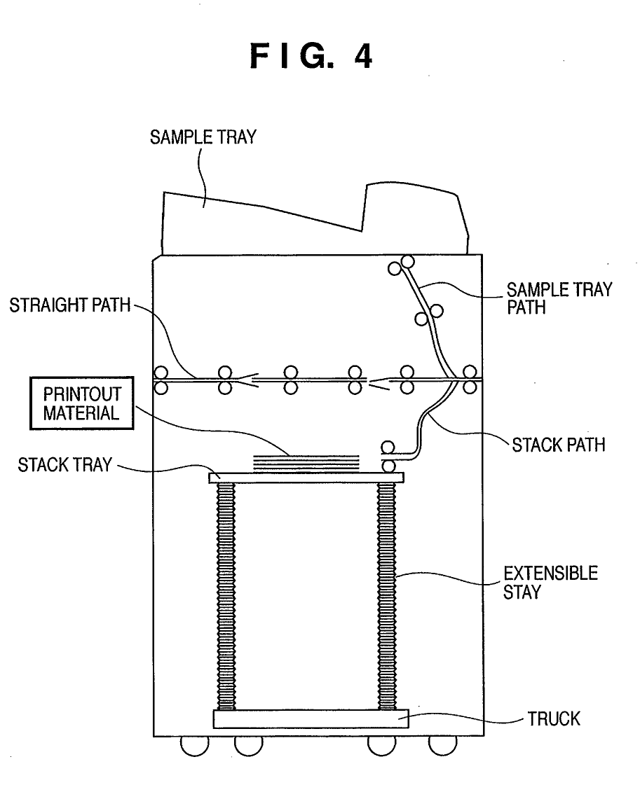

The internal structures of the sheet processing apparatuses 200 connectable to the print apparatus 100 will be explained for each type with reference to FIGS. 4 to 6.

The internal structure of the large-volume stacker applicable as the sheet processing apparatus 200 will be explained with reference to the sectional view shown in FIG. 4. The large-volume stacker conveys a sheet from an upstream apparatus selectively to one of three feeding paths: a sample tray path, stack path, and straight path.

The stack path in the large-volume stacker is a sheet feeding path for conveying sheets to the stack tray. The stack tray in FIG. 4 is a stacking unit mounted on an extensible stay. A demountable truck supports the extensible stay from below it. With the truck, the operator can carry sheets stacked on the stack tray.

Assume that the control unit 205 accepts a request from the user via the operation unit 204 to execute a job set to perform sheet stacking processing by the large-volume stacker. In this case, the control unit 205 conveys sheets printed by the print apparatus 100 to the stack path of the large-volume stacker, and delivers them to the stack tray via the stack path.

The straight path of the large-volume stacker shown in FIG. 4 is a sheet feeding path for conveying, to a succeeding apparatus, sheets of a job requiring no sheet stacking processing using the stack tray of the large-volume stacker.

The sample tray path is a sheet feeding path for discharging sheets to the sample tray. The sample tray path is used to easily take out an output material from the stack tray when performing, e.g., work requiring a check on an output. In this case, for example, the control unit 205 causes the large-volume stacker to convey sheets printed by the print apparatus 100 to the sample tray path, and discharge them onto the sample tray.

A plurality of sheet sensors necessary to detect the sheet conveyance status and jam are arranged on the sheet feeding path in the large-volume stacker.

The CPU (not shown) of the large-volume stacker notifies the control unit 205 of sheet detection information from each sensor via a signal line for data communication. Based on the information from the large-volume stacker, the control unit 205 grasps the sheet conveyance status and jam in the large-volume stacker. When another sheet processing apparatus is connected between the large-volume stacker and the print apparatus 100, the CPU (not shown) of the sheet processing apparatus notifies the control unit 205 of sensor information of the large-volume stacker.

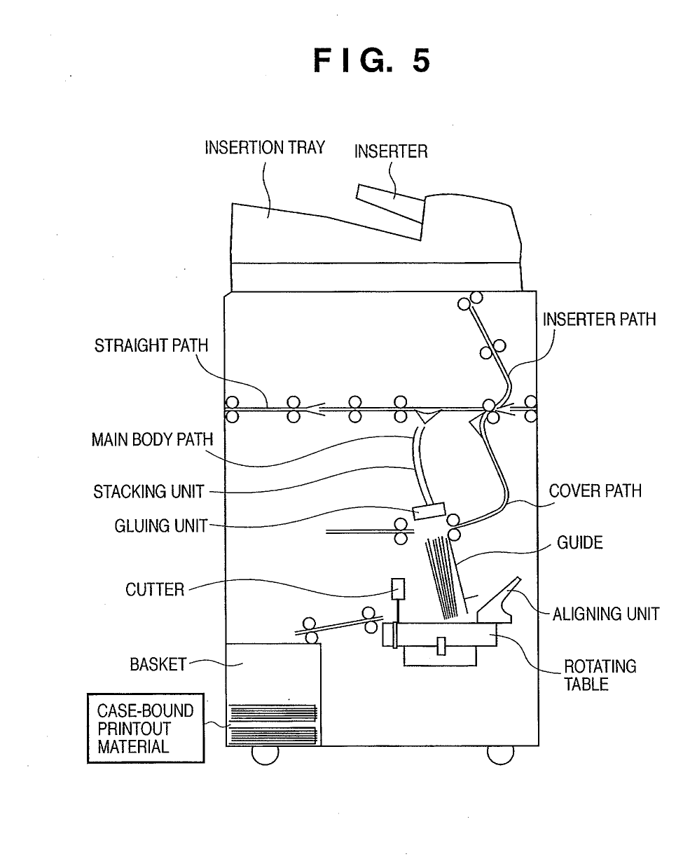

The internal structure of the glue binding apparatus will be explained with reference to the sectional view shown in FIG. 5.

The glue binding apparatus conveys a sheet from an upstream apparatus selectively to one of three feeding paths: a cover path, main body path, and straight path. The glue binding apparatus also has an inserter path. The inserter path is a sheet feeding path for conveying a sheet on the insertion tray to the cover path.

The straight path of the glue binding apparatus in FIG. 5 is a sheet feeding path for conveying, to a succeeding apparatus, sheets of a job requiring no glue binding by the glue binding apparatus.

The main body path and cover path of the glue binding apparatus shown in FIG. 5 are sheet feeding paths for conveying sheets necessary to create case-bound printed materials.

For example, when creating case-bound printed materials using the glue binding apparatus, the control unit 205 causes the printer unit 203 to print image data of the body on sheets serving as the body of the case-bound printed materials. Case-bound printed materials of one booklet are created by wrapping a bundle of body sheets for one booklet with one cover. The body sheet bundle in case binding will be called a “main body”.

The control unit 205 controls to convey sheets printed by the print apparatus 100 to the main body path shown in FIG. 5. In case binding, the control unit 205 causes the glue binding apparatus to wrap the main body printed by the print apparatus 100 with a cover sheet conveyed via the cover path.

For example, the control unit 205 causes the glue binding apparatus to sequentially stack main body sheets conveyed from an upstream apparatus on the stacking unit via the main body path in FIG. 5. After stacking sheets bearing body data on the stacking unit by the number of sheets of one booklet, the control unit 205 controls to convey one cover sheet necessary for the job via the cover path. The control unit 205 controls a gluing unit in FIG. 5 to glue the spine of the sheet bundle of one set corresponding to the main body. Then, the control unit 205 controls the gluing unit to bond the spine of the main body to the center of the cover. In bonding the main body to the cover, the main body is conveyed and pushed down in the apparatus. As a result, the cover is folded to wrap the main body with one cover. The sheet bundle of one set is stacked on a rotating table in FIG. 5 along the guide.

After the sheet bundle of one set is set on the rotating table in FIG. 5, the control unit 205 causes a cutter in FIG. 5 to cut the sheet bundle. At this time, the cutter can execute three-side cutting processing to cut three edges of the sheet bundle of one set other than an edge serving as the spine.

The control unit 205 uses an aligning unit to push the sheet bundle having undergone three-side cutting processing toward a basket, putting the sheet bundle into the basket.

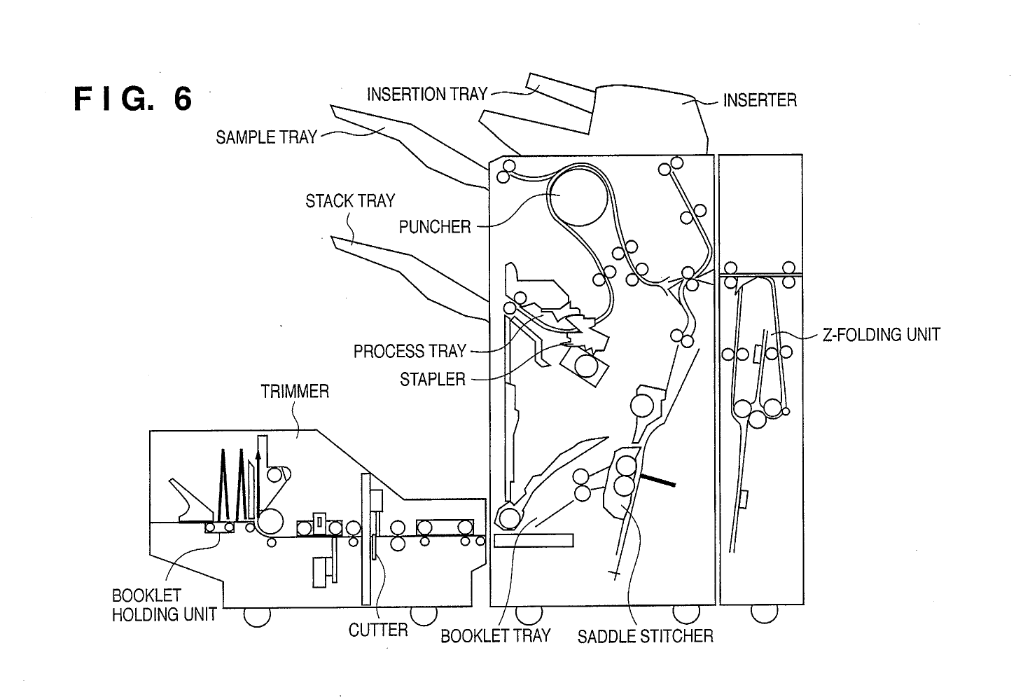

The internal structure of the saddle stitching apparatus will be explained with reference to the sectional view shown in FIG. 6.

The saddle stitching apparatus comprises various units for selectively executing stapling, cutting, punching, folding, shift delivery, saddle stitching, and the like for sheets from the print apparatus 100. The saddle stitching apparatus does not have a straight path for conveying sheets to a succeeding apparatus. For this reason, the saddle stitching apparatus is connected last, as shown in FIG. 3, when connecting a plurality of sheet processing apparatuses to the print apparatus 100.

As shown in FIG. 6, the saddle stitching apparatus has a sample tray and stack tray outside the apparatus, and a booklet tray inside the apparatus.

Upon accepting an instruction to staple sheets by the saddle stitching apparatus, the control unit 205 causes the saddle stitching apparatus to sequentially stack sheets printed by the print apparatus 100 on the process tray inside the saddle stitching apparatus. After stacking sheets of one bundle on the process tray, the control unit 205 causes a stapler to staple them. The control unit 205 causes the saddle stitching apparatus to discharge the stapled sheet bundle from the process tray to the stack tray in FIG. 6.

When executing a job for which the control unit 205 accepts an instruction to Z-fold sheets by the saddle stitching apparatus, the control unit 205 causes a Z-folding unit to Z-fold sheets printed by the print apparatus 100. The control unit 205 controls to make the folded sheets pass through the saddle stitching apparatus and deliver them onto a discharge tray such as the stack tray or sample tray.

Upon accepting an instruction to perform punching by the saddle stitching apparatus, the control unit 205 causes a puncher to punch sheets printed by the print apparatus 100. The control unit 205 controls to make the punched sheets pass through the saddle stitching apparatus and deliver them onto a discharge tray such as the stack tray or sample tray.

When executing a job for which the control unit 205 accepts an instruction to saddle-stitch sheets by the saddle stitching apparatus, the control unit 205 causes a saddle stitcher to stitch a bundle of sheets by one set at two center portions. The control unit 205 causes the saddle stitcher to clamp the sheet bundle at the center by rollers and fold the sheets into two at the center, thereby creating a booklet such as a brochure. The sheet bundle saddle-stitched by the saddle stitcher is conveyed onto the booklet tray.

Upon accepting a cutting instruction for a job for which the control unit 205 accepts an instruction to saddle-stitch sheets, the control unit 205 controls to convey a saddle-stitched sheet bundle from the booklet tray to a trimmer. The control unit 205 causes a cutter to cut the sheet bundle conveyed to the trimmer, and a booklet holding unit to hold the sheet bundle. The saddle stitching apparatus in FIG. 6 can also cut three edges of a saddle-stitched sheet bundle.

When the saddle stitching apparatus does not have any trimmer, the user can take out a sheet bundle bound by the saddle stitcher from the booklet tray.

The saddle stitching apparatus can also attach a sheet (e.g., a cover sheet printed in advance) set on the insertion tray in FIG. 6 to a sheet (printed by the print apparatus 100) conveyed from the print apparatus 100.

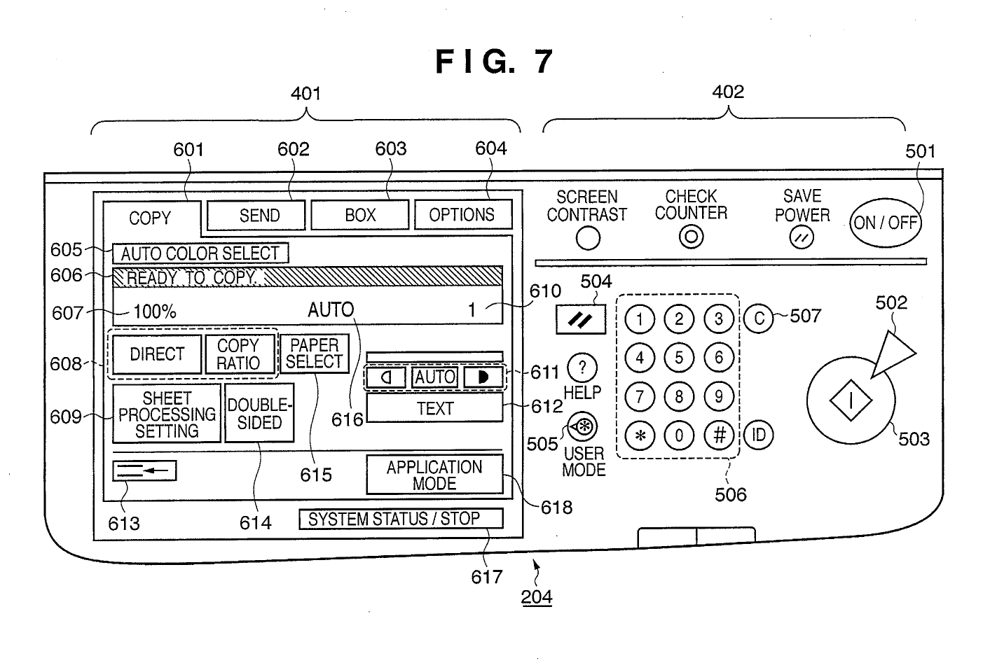

The arrangement of the operation unit 204 will be described with reference to FIG. 7.

The operation unit 204 comprises the touch panel unit 401 and key input unit 402. The touch panel unit 401 is formed from an LCD (Liquid Crystal Display) and a transparent electrode adhered onto the LCD, and displays various setup windows for accepting an instruction from the user. The touch panel unit 401 has both a function of displaying various windows and an instruction input function of accepting an instruction from the user. The key input unit 402 comprises a power key 501, start key 503, stop key 502, user mode key 505, and ten-key pad 506. The start key 503 is used to cause the print apparatus 100 to execute a copy job and send job. The ten-key pad 506 is used to set a numerical value such as the number of copies.

The control unit 205 controls the printing system 1000 to perform various processes based on user instructions accepted via various windows displayed on the touch panel unit 401 and user instructions accepted via the key input unit 402.

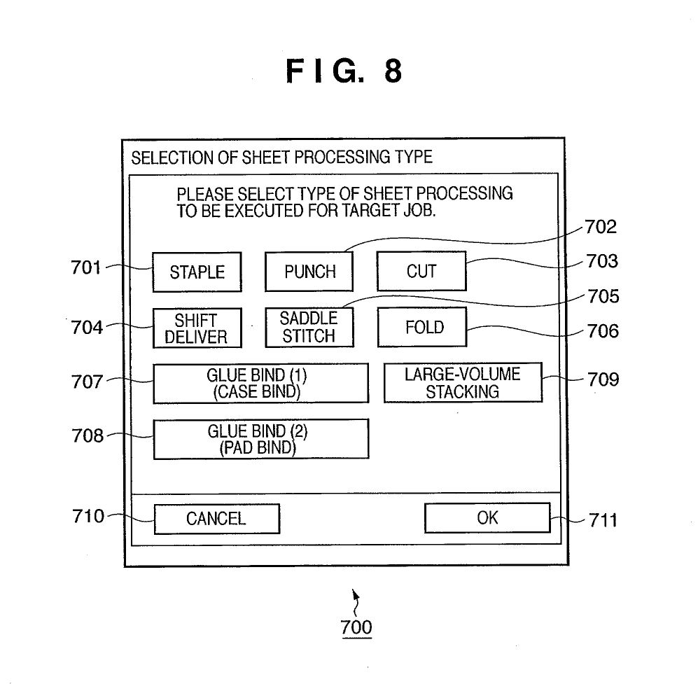

FIG. 8 is a view showing a display example of a setup window for prompting the user to select the type of sheet processing to be executed for sheets printed by the print apparatus 100. When the user presses a sheet processing setting key 609 shown in FIG. 7 in the window displayed on the touch panel unit 401, the control unit 205 causes the touch panel unit 401 to display the window in FIG. 8. The window in FIG. 8 is a setup window which allows the user to select the type of sheet processing executable by the sheet processing apparatus 200 in the printing system 1000. The control unit 205 accepts, from the user via the window in FIG. 8, settings of sheet processing to be executed for a target job, and causes the sheet processing apparatus 200 to execute the sheet processing according to the settings.

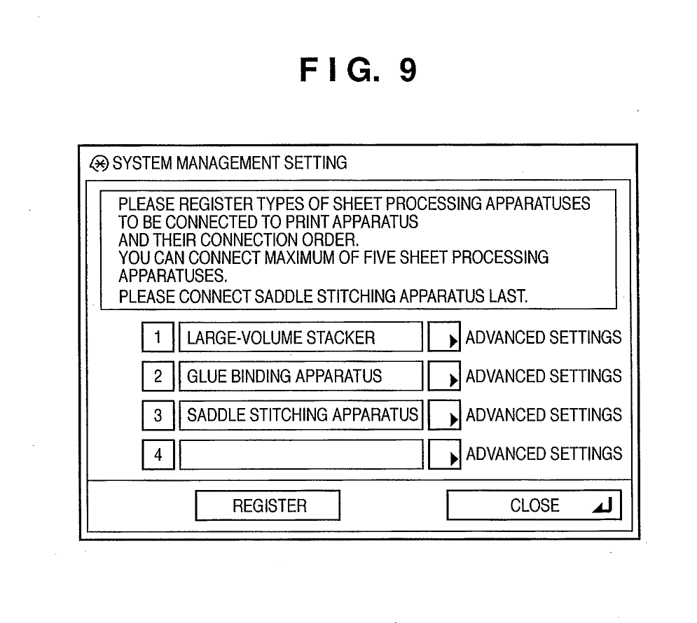

A window shown in FIG. 9 is a setup window which allows the user to register information for specifying the number, types, and connection order of sheet processing apparatuses connected to the print apparatus 100 in the case where the sheet processing apparatuses 200 are connected to the print apparatus 100. When the user presses the user mode key 505, the control unit 205 controls the touch panel unit 401 to display the window shown in FIG. 9.

For example, when the printing system 1000 has the system configuration as shown in FIG. 3, the user sets registration information that three sheet processing apparatuses, i.e., the large-volume stacker, glue binding apparatus, and saddle stitching apparatus are connected to the print apparatus 100 sequentially from the large-volume stacker, as shown in FIG. 9. The control unit 205 causes the RAM 208 to hold, as system configuration information, the information on the sheet processing apparatuses 200 that is set by the user via the window in FIG. 9. The control unit 205 properly reads out and refers to the system configuration information. From the system configuration information, the control unit 205 confirms the number, types, and connection order of sheet processing apparatuses connected to the print apparatus 100.

Assume that the user makes a setting in the window of FIG. 9 to connect the saddle stitching apparatus having no straight path between sheet processing apparatuses. In this case, the control unit 205 causes the touch panel unit 401 to present an error display and notify the user that the setting is invalid. Further, as shown in FIG. 9, the control unit 205 causes the touch panel unit 401 to display guidance information and notify the user of canceling this setting and connecting the saddle stitching apparatus last.

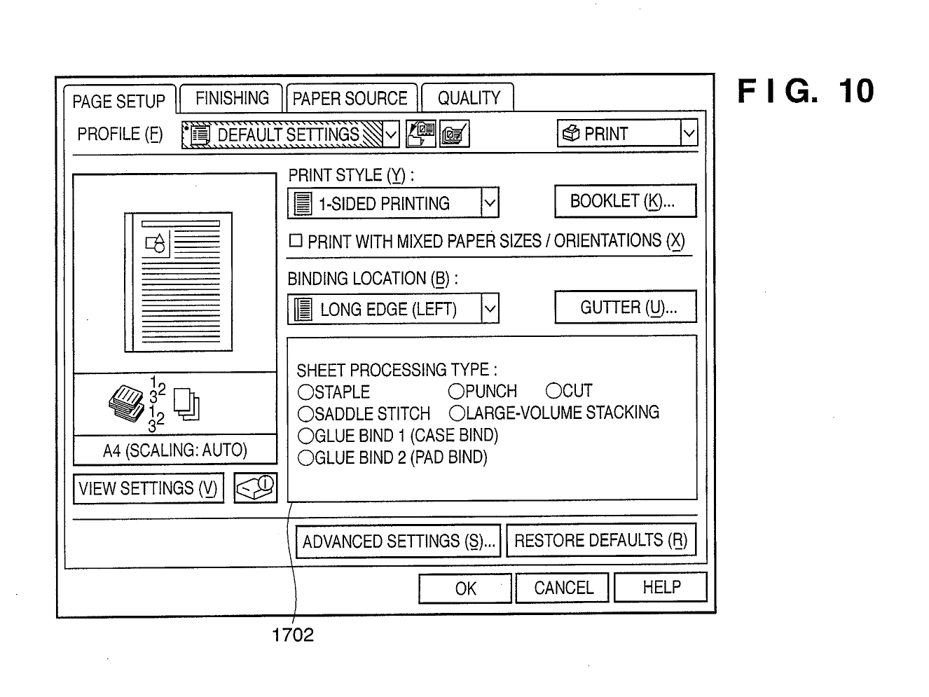

The embodiment exemplifies the operation unit 204 of the print apparatus 100 as an example of a user interface unit applied to the printing system 1000, but another user interface unit is also available. For example, the printing system 1000 may execute processing based on an instruction from the user interface unit of an external apparatus such as the PC 103 or PC 104. When the external apparatus remote-controls the printing system 1000, the display unit of the external apparatus displays a setup window relevant to the printing system 1000, as shown in FIG. 10. This will be exemplified using the PC 104. FIG. 10 shows an example of a window on the display of the PC 104.

Upon accepting a print request from the user, the CPU of the PC 104 causes the display to present the window as shown in FIG. 10. The CPU accepts the settings of print processing conditions from the user of the PC 104 via the window. For example, the CPU of the PC 104 accepts, from the user via a setting field 1702, the type of sheet processing to be executed by the sheet processing apparatus 200 for a print job subjected to a print execution request. Upon accepting the print execution request in response to a press of an OK key in FIG. 10, the CPU of the PC 104 associates the print processing conditions accepted via the window with image data to be printed. The CPU of the PC 104 controls to transmit the resultant data as one job to the printing system 1000 via the network 101.

In the printing system 1000, the control unit 205 accepts the print execution request of the job via the external I/F 202. Then, the control unit 205 controls the printing system 1000 to process the job from the PC 104 on the basis of the print processing conditions from the PC 104.

In this manner, various units are available as the user interface of the printing system 1000.

As a point of the embodiment in the POD environment 10000 having the above-described building components, the embodiment classifies the above-described sheet processing apparatuses into three categories and defines them as follows.

[Definition 1] A sheet processing apparatus which satisfies both (condition 1) and (condition 2) listed below is defined as an “in-line finisher”. The embodiment also refers to an apparatus satisfying this definition as an in-line type sheet processing apparatus.

(Condition 1) A sheet processing apparatus has a paper path (sheet feeding path) physically connected to the printing apparatus 100 so as to directly receive sheets conveyed from the printing apparatus 100 without any operator intervention.

(Condition 2) A sheet processing apparatus is electrically connected to another apparatus so as to communicate data necessary for an operation instruction, status confirmation, or the like with it. More specifically, a sheet processing apparatus is electrically connected to the printing apparatus 100 so as to communicate data with it, or electrically connected to an apparatus (e.g., the PC 103 or 104) other than the printing apparatus 100 via the network 101 so as to communicate data. A sheet processing apparatus which satisfies at least either condition meets (condition 2).

More specifically, the sheet processing apparatus 200 of the printing system 1000 corresponds to an “in-line finisher”. This is because the sheet processing apparatus 200 is physically and electrically connected to the printing apparatus 100, as described above.

[Definition 2] A sheet processing apparatus which does not satisfy (condition 1) out of (condition 1) and (condition 2) listed above but satisfies (condition 2) is defined as a “near-line finisher”. The embodiment also refers to an apparatus satisfying this definition as a near-line type sheet processing apparatus.

For example, a sheet processing apparatus has a paper path not connected to the printing apparatus 100, and requires intervention work by an operator such as carrying of printed materials. However, the sheet processing apparatus can electrically exchange information such as an operation instruction or status confirmation via a communication means such as the network 101. A sheet processing apparatus which meets these conditions is defined as a “near-line finisher”.

More specifically, the paper folding apparatus 107, trimmer 109, saddle stitching apparatus 110, and case binding apparatus 108 in FIG. 1 correspond to “near-line finishers”. This is because these sheet processing apparatuses are not physically connected to the printing apparatus 100, but electrically connected to another apparatus such as the PC 103 or 104 via the network 101 so as to communicate data.

[Definition 3] A sheet processing apparatus which satisfies neither (condition 1) nor (condition 2) listed above is defined as an “off-line finisher”. The embodiment also refers to an apparatus satisfying this definition as an off-line type sheet processing apparatus.

For example, a sheet processing apparatus has a paper path not connected to the printing apparatus 100, and requires intervention work by an operator such as carrying of printed materials. Further, the sheet processing apparatus does not comprise any communication unit necessary for an operation instruction and status confirmation, and cannot communicate data with another apparatus. Thus, the operator carries and sets outputs, manually inputs an operation, and manually delivers a status report issued from the device. A sheet processing apparatus which meets these conditions is defined as an “off-line finisher”.

More specifically, the saddle stitching apparatus 110 in FIG. 1 corresponds to an “off-line finisher”. This is because this sheet processing apparatus is not physically connected to the printing apparatus 100, cannot be connected to the network 101, cannot be electrically connected to another apparatus, and cannot communicate data with it.

Various sheet processes are executable in the POD environment 10000 having various sheet processing apparatuses classified into these three categories.

For example, these sheet processing apparatuses can execute various sheet processes such as trimming, saddle stitching, case binding, sheet folding, punching, sealing, and collation for printed media of a job printed by the printing apparatus 100. They can execute sheet processes in a bookbinding printing style desired by an end user (customer).

Near-line finishers and off-line finishers managed by the server PC 103 include various finishers such as a dedicated stapler, dedicated puncher, inserter, and collator. The server 103 grasps a device status and job status from near-line finishers via the network 101 by sequential polling or the like using a predetermined protocol. In addition, the server 103 manages the execution statuses (progresses) of many jobs processed in the environment 10000.

In the embodiment, different sheet processing apparatuses may execute a plurality of print sheet processes, or one sheet processing apparatus may execute them. The system may comprise any of sheet processing apparatuses.

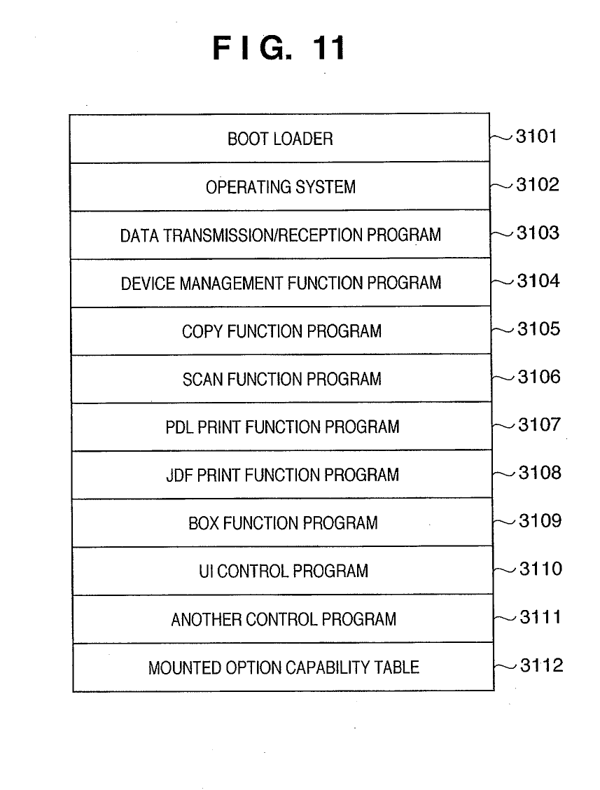

FIG. 11 is a view illustrating a variety of programs which are stored in the ROM 207 in FIG. 2, and read out and executed by the controller unit 205 in the printing system 1000, and data used by the programs and the like. As shown in FIG. 11, the ROM 207 stores programs for implementing various functions the printing system 1000 can provide.

A boot loader 3101 is a program executed upon turning on the printing system 1000. The boot loader 3101 executes various boot sequences necessary to boot the system. An operating system 3102 provides an execution environment for various programs which implement the functions of the printing system 1000. For this purpose, the operating system 3102 mainly provides a function of managing the memory resource of the printing system 1000, and a function of performing basic input/output control of various devices shown in FIG. 2. The memory of the printing system 1000 includes the ROM 207, RAM 208, and hard disk 209 in FIG. 2.

A data transmission/reception program 3103 is a control program to perform transmission/reception processing when a data input/output request is received via the external I/F 202 in FIG. 2. More specifically, the data transmission/reception program 3103 is a control program which contains a protocol stack such as TCP/IP and controls communication of various data with a connected external device or the like via the network 101 in the printing environment 10000 shown in FIG. 1. This communication processing is specialized in an HTTP server and the transmission/reception level of data packets input/output between the printing system 1000 and the network 101. The communication processing does not include analysis processing of received data contents, which will be described later. The data analysis processing is executed by the controller unit 205 on the basis of the description contents of another program, which will be described later.

A device management function program 3104 integrally manages the connection states, statuses, and capabilities of various devices which are managed by the printing system 1000 and implement the functions of the MFP. These devices include detachable and undetachable devices such as the printer unit 203, scanner unit 201, and sheet processing apparatus 200. The device management function program 3104 runs when the controller unit 205 activates the system or is notified of a change of the state of a connected device.

A copy function program 3105 causes the controller unit 205 to execute the copy function in accordance with an instruction from the operation unit 204 when the user designates execution of the copy function via the operation unit 204. The copy function becomes available when the printing system is completely activated and can provide the functions of the MFP. To provide the copy function, the controller unit 205 controls to finally execute copy processing by sequentially instructing device resources in the printing system 1000 on operations in an appropriate order on the basis of the processing order and processing conditions described in the program 3105. The device resources for providing the copy function include the scanner unit 201, printer unit 203, sheet processing apparatus 200, hard disk 209, compression/decompression unit 210, and RAM 208.

A scan function program 3106 causes the controller unit 205 to execute the scan function in accordance with an instruction from the operation unit 204 when the user designates execution of the scan function via the operation unit 204. The scan function also becomes available when the printing system is completely activated and can provide the functions of the MFP. To provide the scan function, the controller unit 205 controls to finally execute scan processing by sequentially instructing device resources in the printing system 1000 on operations in an appropriate order on the basis of the processing order and processing conditions described in the program 3106. The device resources for providing the scan function include the scanner unit 201, hard disk 209, compression/decompression unit 210, and RAM 208.

A PDL print function program 3107 causes the controller unit 205 to execute the PDL print function in accordance with an instruction from the operation unit 204 upon receiving PDL print job data via the external I/F 202. The PDL print function also becomes available when the printing system is completely activated and can provide the functions of the MFP. The controller unit 205 controls to finally execute PDL print processing by sequentially instructing device resources in the printing system 1000 on operations in an appropriate order on the basis of the processing order and processing conditions described in the program 3107. The device resources for executing PDL print processing include the sheet processing apparatus 200, printer unit 203, hard disk 209, compression/decompression unit 210, and RAM 208.

A JDF print function program 3108 causes the controller unit 205 to execute the JDF print function in accordance with an instruction from the operation unit 204 upon receiving JDF job ticket-containing job data via the external I/F 202. The JDF print function also becomes available when the printing system is completely activated and can provide the functions of the MFP. The controller unit 205 controls to finally execute JDF print processing by sequentially instructing device resources in the printing system 1000 on operations in an appropriate order on the basis of the processing order and processing conditions described in the program 3108. The device resources for executing the JDF print function include the sheet processing apparatus 200, printer unit 203, hard disk 209, compression/decompression unit 210, and RAM 208.

A BOX function program 3109 causes the controller unit 205 to execute the BOX function in accordance with an instruction from the operation unit 204 when the user of the printing system 1000 designates execution of the BOX function via the operation unit 204. The BOX function also becomes available when the printing system is completely activated and can provide the functions of the MFP. The controller unit 205 controls to finally execute BOX processing by sequentially instructing device resources in the printing system 1000 on operations in an appropriate order on the basis of the processing order and processing conditions described in the program 3109. The device resources include the scanner unit 201, printer unit 203, sheet processing apparatus 200, hard disk 209, compression/decompression unit 210, and RAM 208.

A UI control program 3110 is a control program for the touch panel unit 401 and key input unit 402 of the operation unit shown in FIG. 7 when the printing system is completely activated and can provide the functions of the MFP. The UI control program 3110 identifies contents input by the user of the printing system 1000 via the operation unit 204, shifts to a proper window, and issues a processing request to the controller unit 205.

Another control program 3111 implements functions not supported by the above-described programs, and executes various operations. However, details of the control program 3111 are not important for a description of the effects of the embodiment, and a description thereof will be omitted.

A mounted option capability table 3112 is table information which statically holds capability information of apparatuses mountable/demountable in/from the printing system 1000. The ROM 207 stores the capability information so that the controller unit 205 in the printing system 1000 refers to it and performs processing to, e.g., change processing contents in accordance with the capability of a mounted option when executing various jobs or managing devices. The table name is a mounted option capability table. Mounted options are not limited to apparatuses designed to be mountable/demountable, like the large-volume stacker 200-3a, glue binding apparatus 200-3b, and saddle stitching apparatus 200-3c shown in FIG. 3. For example, this table may also manage the printing apparatus main body 100 and the scanner of the printing apparatus main body 100 as special mounted options. The embodiment is based on a case where a single table manages even information on the printing apparatus main body 100 similarly to mountable/demountable apparatuses.

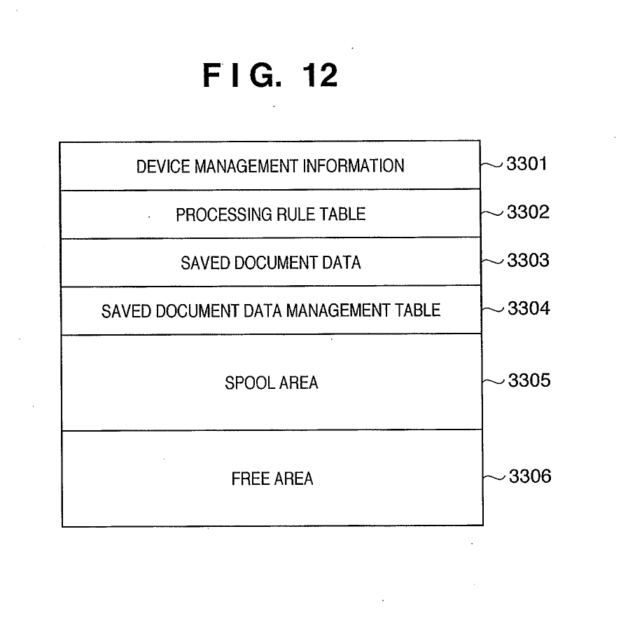

FIG. 12 is a view showing a storage status of various data which are stored in the hard disk 209 in FIG. 2, and read out or written by the controller unit 205 in the printing system 1000. Information stored in the hard disk 209 dynamically changes depending on the device use status, device configuration, and job progress, unlike the internal state of the ROM 207 shown in FIG. 11. It should be noted that the state shown in FIG. 12 is at the time when the printing system 1000 runs, and the internal state of the hard disk 209 is not always the same as that in FIG. 12. As another case different from that in FIG. 12, a plurality of large-volume print jobs are accepted and occupy the entire free area shown in FIG. 12.

Device management information 3301 holds information such as the connection state of the sheet processing apparatus 200 mountable/demountable in/from the printing system 1000, and the connection state, status, and capability of a device which may or may not exist depending on the optional configuration of the printing system 1000. The device management function program 3104 shown in FIG. 11 manages the device management information 3301. Information stored and managed in the device management table will be described later. When and how the controller unit 205 uses information in this table will also be described later.

A processing rule table 3302 describes operation specifications concerning the operation of a device when the printing system 1000 tries to process a JDF print job but cannot physically execute it at job settings owing to the device configuration, device capability, or the like. Information stored in the processing rule table 3302 will also be described later. When and how the controller unit 205 uses information in this table will also be described later. Job execution control based on the processing rule table is not limited to a JDF print job. It is also possible to define a processing rule table concerning another job type, and execute a job of this type similarly to the JDF print job. The embodiment targets only the JDF print job for descriptive convenience.

Saved document data 3303 corresponds to document data held in the printing system using the BOX function provided by the BOX function program shown in FIG. 11. A saved document data management table 3304 holds management information of the saved document data 3303.

A spool area 3305 temporarily holds print data transmitted to the printing system 1000 till the completion of executing the job. The print data includes one transmitted by the PDL print function provided by the PDL print function program shown in FIG. 11, and one transmitted by the JDF print function provided by the JDF print function program. Upon completion of executing the print job, the print job data is deleted from the spool area 3305 to free the area for a subsequent print job. The controller unit 205 controls to store data in the spool area 3305 and free the spool area 3305 upon completion of a job while executing the PDL print function and JDF print function.

A free area 3306 corresponds to an area in the hard disk 209 except for all the above-described areas. The capacity of the free area 3306 changes along with the progress of processing in the printing system 1000. The free area 3306 may run out and disappear depending on the use load of the hard disk 209.

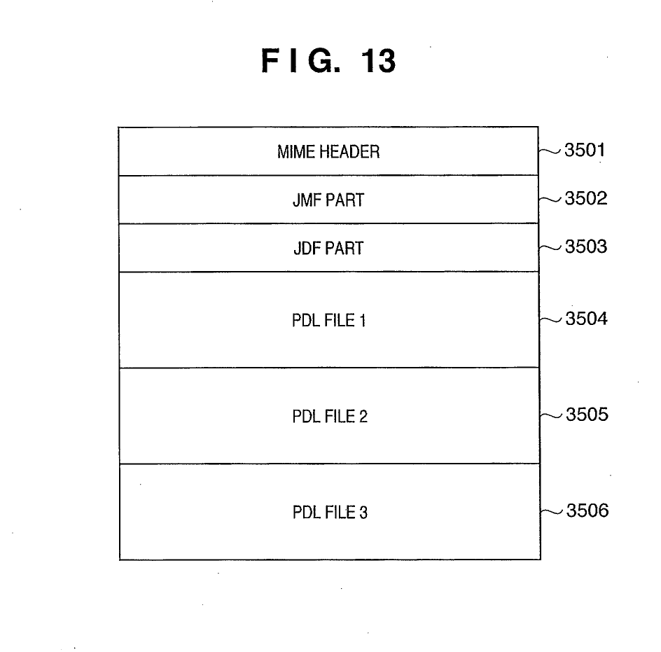

FIG. 13 is a view showing a structure of job data to be processed by the JDF print function provided by the JDF print function program 3108 shown in FIG. 11. A JDF print job assumes that the following components are assembled into a single package in the MIME format and data encoded in the MIME format is accepted:

content data corresponding to image information to be printed.

a job ticket area holding only job setting information.

a management area for communication and status management between POD workflows.

The JDF print function in the embodiment also assumes processing of job data in the MIME format. JDF specifications also refer to handling of job data other than a MIME package. However, data packaging specifications are not essential to a description of the effects of the embodiment, so job data of the MIME format will be explained. However, a JDF job can also be input in a format other than the MIME format.

A MIME header 3501 is a header area always necessary to assemble a plurality of parts into a single package in the MIME format. The MIME header 3501 holds MIME management information such as the total data size of the MIME package.

A JMF part 3502 is an area holding the above-mentioned management information for communication and status management between POD workflows.

A JDF part 3503 is an area holding the above-mentioned job setting information. A JDF specification form issued by CIP4 as JDF specifications describes setting information held in a JDF job ticket and the format of the setting information. The JDF print function in the printing system 1000 is assumed to be implemented on the basis of matters described in the specification form, and a detailed description thereof will be omitted. As a minimum example for describing the effects of the embodiment, a concrete example of a job ticket is shown in drawings subsequent to FIG. 13, and its outline will be explained.

A PDL file 1 3504, PDL file 2 3505, and PDL file 3 3506 are content data to be printed. In FIG. 13, the MIME package contains three content data. However, the specifications do not limit the number of PDL content parts, and the same processing applies to even more than three contents, unlike FIG. 13. Depending on the JDF specifications, PDL contents are held not in the MIME package but in, e.g., an external file system, and the JDF describes only the URL of the file held in the external file system. Some specifications designate processing of content data by pulling a file held in the external file system on the basis of the URL. The JDF print function in the printing system 1000 can also attain this function. Since the basic operation is the same, details of the content file pulling operation will not be described in the embodiment. The specifications of the MIME format are defined by RFC, and a detailed description thereof will be omitted.

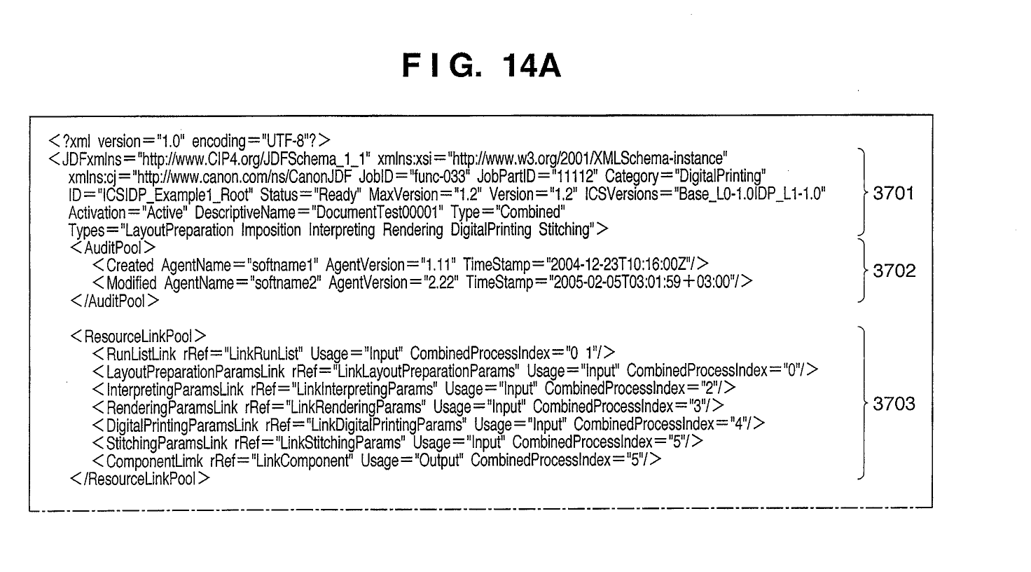

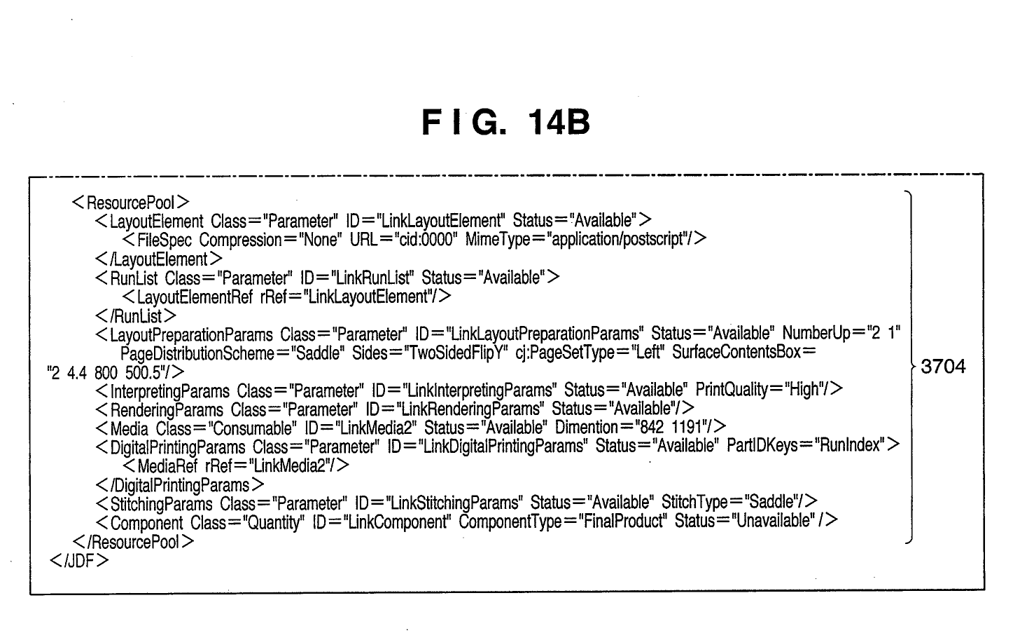

FIGS. 14A and 14B are views showing a concrete example of the JDF description contents of the JDF part 3503 in the MIME package in FIG. 13. Needless to say, the JDF shown in FIGS. 14A and 14B are merely examples of the JDF description based on the JDF specifications, and is not limited to this. In other words, a concrete example of the JDF shown in FIGS. 14A and 14B merely contain minimum contents in order to efficiently describe the following functions.

The JDF part shown in FIGS. 14A and 14B mainly comprises the following four parts:

a JDF node 3701 holding JDF management information.

an audit pool 3702 holding a job log.

a resource link pool 3703 describing the relationship between resources defined by the JDF and processes.

a resource pool 3704 holding setting information in processes defined by the JDF.

Each part can have concrete specifications, described contents, and schema complying with the JDF specifications. The JDF specifications are described in the JDF specification form, and details thereof will not be described in the embodiment of the present invention.

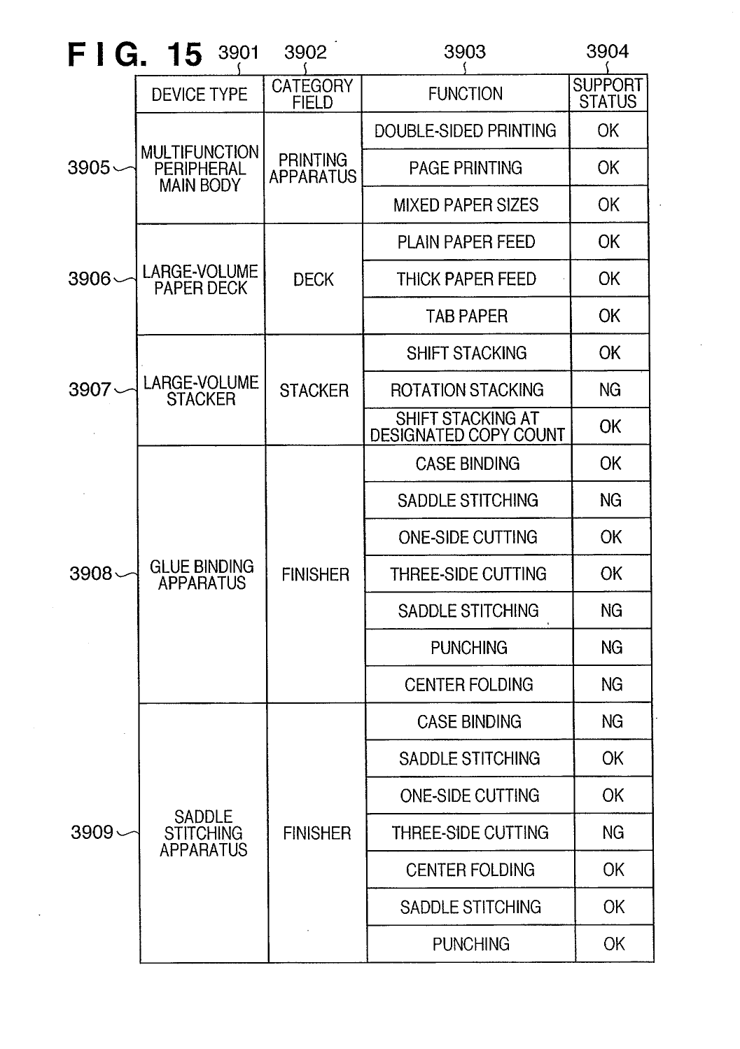

FIG. 15 is a table for explaining details of information stored and managed in the mounted option capability table 3112 shown in FIG. 11. The mounted option capability table 3112 is made up of four fields, and pieces of information in the four fields are managed and stored for each connected device.

A device type field 3901 is used to identify the type of sheet processing apparatus 200 mountable in the printing system 1000, and the type of mountable/demountable device such as the paper deck 319 shown in FIG. 3. Strictly speaking, in the embodiment, the printing apparatus main body 100 is not a mounted option, but is regarded as a special mounted option in terms of management by a single table and managed in this table. If mounted options and the printing apparatus main body 100 need to be strictly discriminated and managed, the table shown in FIG. 15 may be divided into two to manage them. However, the embodiment will not describe the latter case. In the description of FIG. 15, mountable/demountable devices and the printing apparatus main body 100 will be referred to devices.

A category field 3902 holds a category to which a device held in the device type field 3901 belongs. For example, the following categories can be defined as ones to be held, and the category field 3902 holds one of the categories:

a printing apparatus capable of printing on the paper surface.

a deck dedicated to only stocking media to be printed.

a stacker capable of holding many printed output media.

a finisher capable of performing processes such as folding, binding, and punching for various output sheets.

There is a printing apparatus which has a paper feed port and can feed paper without attaching any deck. In practice, the printing system 1000 according to the embodiment comprises the paper feed cassettes 317 and 318, as shown in FIG. 3. When managed by the table, even such a device is categorized not as a deck but as a printing apparatus. In other words, the mounted option capability table 3112 is so managed as to always classify each device into one of the four categories.

A function field 3903 holds the types of functions provided by a device. Since functions supported by a device change depending on the category to which the device belongs, the contents of the table in FIG. 15 reflect them. In other words, the mounted option capability table 3112 is managed such that devices belonging to the same category have the same set of function fields.

A support status field 3904 holds flag information representing whether each function of each device described in the function field 3903 can be implemented. Possible values are a value meaning OK when the device supports the function, and a value meaning NG when the device does not support the function. Data in the mounted option capability table 3112 in FIG. 11 stored in the ROM 207 is stored as a specific binary numerical value. Thus, the character string “OK” or “NG” itself shown in FIG. 15 is not stored. For descriptive convenience, the embodiment adopts the expressions “OK” and “NG” as values equivalent to binary numerical values as if the character string “OK” or “NG” were stored. This expression merely aims at easy understanding of the embodiment. In the following description of the embodiment, the same description method applies to a value held in the table.

The mounted option capability table 3112 shown in FIG. 15 holds information on five types of devices. The five types of devices are a MFP main body, large-volume paper deck, large-volume stacker, glue binding apparatus, and saddle stitching apparatus. Of these devices, the glue binding apparatus and saddle stitching apparatus belong to the same category “finisher”, as shown in FIG. 15.

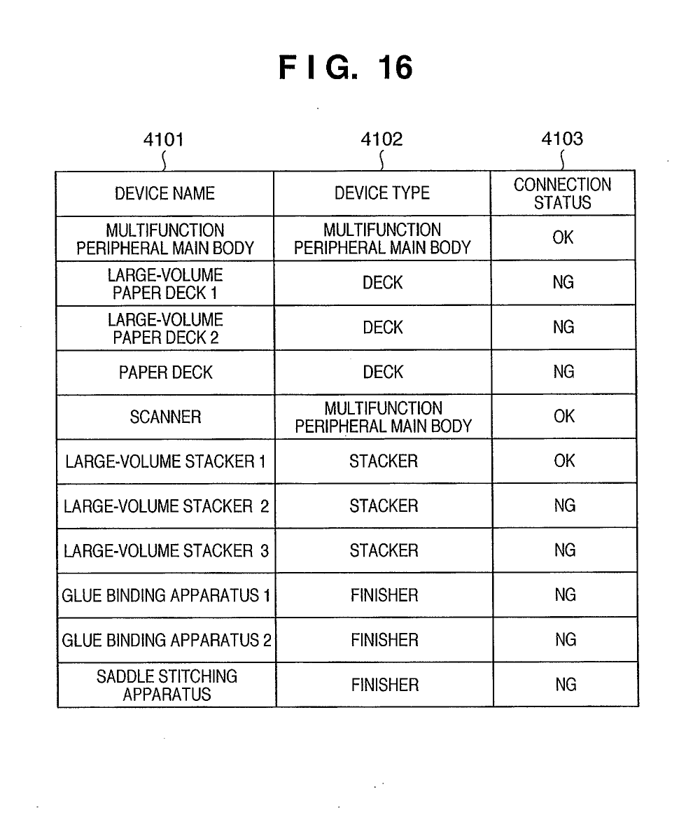

FIG. 16 is a table for explaining the contents of a device configuration management table. The device configuration management table is managed by the device management function program 3104 shown in FIG. 11, and held in the RAM 208 according to the method and conditions described with reference to the device management function program 3104 in FIG. 11. The device configuration management table manages the connection states of the demountable sheet processing apparatus 200 installed in the printing system 1000, the paper deck 319 shown in FIG. 3, a subdevice of the printing apparatus main body 100, and the like. This table is made up of three fields, which will be described below.

A device name field 4101 lists all devices mountable/demountable in/from the printing system 1000. When devices of the same type are mountable, they are distinctively managed with figures added to the end of their device names. The printing system 1000 allows selecting a complicated combination of options in accordance with user needs. However, not all devices can always be combined depending on their types, and there are impossible combinations depending on the physical or device configuration, as described above. The device name field 4101 of the mounted option capability table 3112 shown in FIG. 16 does not manage the validity of each combination, and only lists all devices which may be mounted in the printing system 1000. Whether each device is actually mounted is indicated by a value in another field of this table.

A device type field 4102 holds the category of a device described in the device name field 4101. The device type field 4102 holds a value equivalent to the contents of the category field 3902 in the mounted option capability table shown in FIG. 15.

A connection status field 4103 holds whether a device described in the device name field 4101 is connected to the printing apparatus. A possible value is a value meaning OK when a device which supports a target function and is described in the device name field 4101 is connected to the printing apparatus. Another possible value is a value meaning NG when a device described in the device name field 4101 is not connected to the printing apparatus. In the example of the table in FIG. 16, one scanner and one large-volume stacker are connected in the printing system 1000.

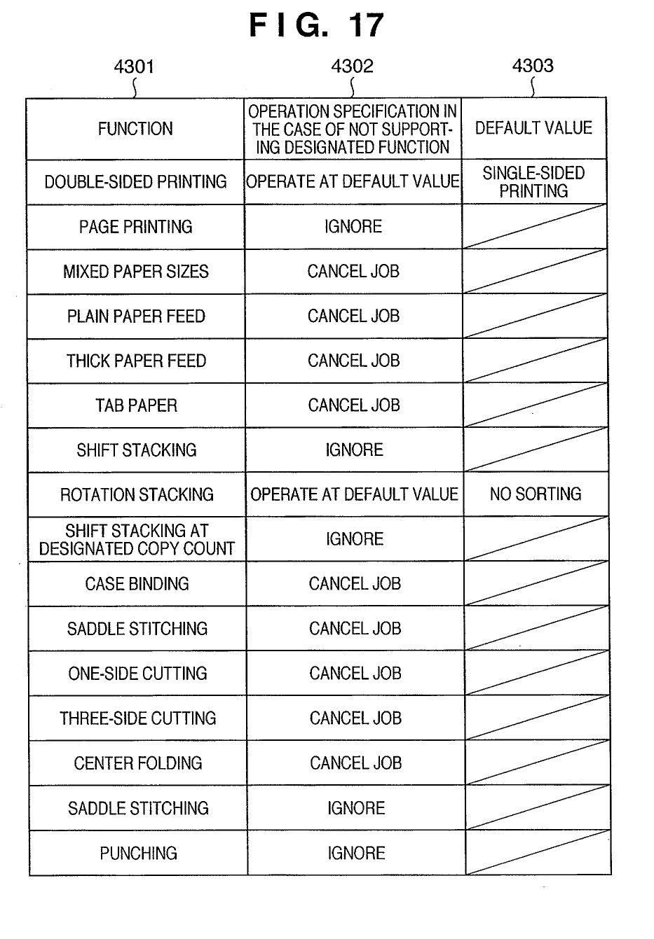

FIG. 17 is a table for explaining the detailed contents of information held in the processing rule table 3302 which is stored in the hard disk 209 and has already been described with reference to FIG. 12. As shown in FIG. 17, this table is made up of three fields, which will be described below.

A function field 4301 holds the type of setting attribute of a function necessary to execute a job settable by a JDF job ticket. In FIG. 17, 16 different setting items are registered. The number of setting items processible by an actual JDF print job is larger than that shown in FIG. 17. However, only limited types of setting attributes will be exemplified for descriptive convenience, and the effects of the embodiment will be explained based on them.

An operation specification field 4302 in the case of not supporting a designated function describes the contents of processing which should be employed when the printing system 1000 cannot execute a designated function and the controller unit 205 is to execute a JDF print job input to the printing apparatus. For each print function, the operation specification field 4302 holds a value corresponding to operation designation information which designates an operation performed when the printing apparatus cannot provide a print function necessary to satisfy designated printing conditions. This field may take the following three values:

“Operate at a default value”: The first value represents that, when no target function can be executed, the default value of a device replaces the setting value of the function in a job ticket to continue the job.

“Ignore”: The second value represents that, when no target function can be executed, the job ticket is assumed not to have the setting of the function, continuing the job.

“Cancel”: The third value represents that, when no target function can be executed, execution of a job by a job ticket having the setting of the function is invalidated.

In the embodiment, the system sets in advance a value in the operation specification field in correspondence with each function described in the function field 4301. However, the system may allow the user to change a value in this field.

A default value field 4303 holds a default value selected when the operation specification field 4302 in FIG. 17 takes the value “operate at a default value”. When the operation specification field 4302 takes another value, this field is blank.

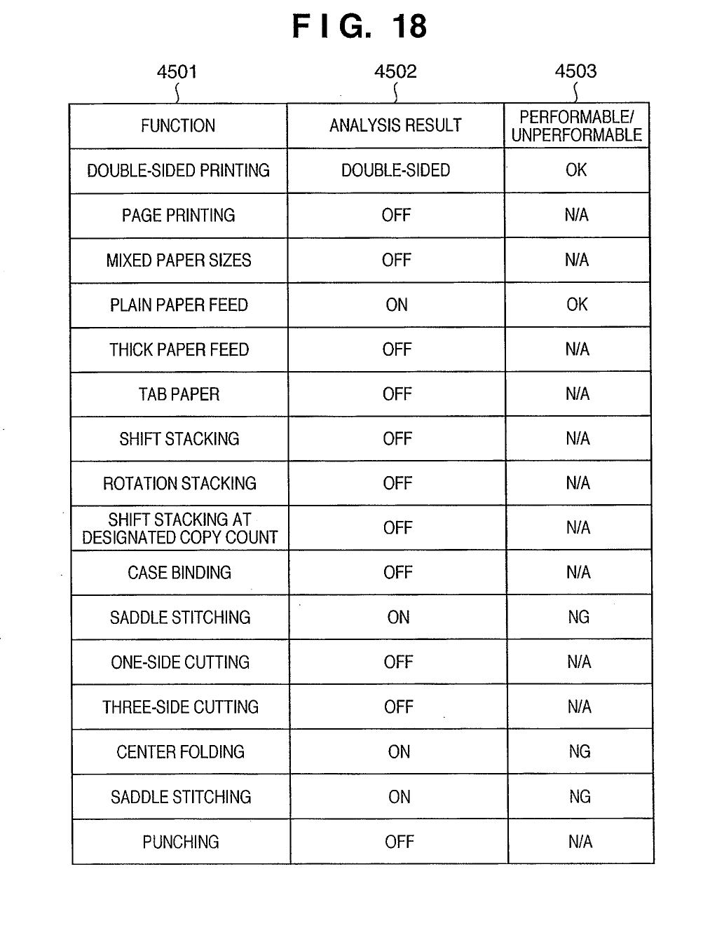

FIG. 18 is a table for explaining details of a JDF analysis result table generated upon completion of analyzing the JDF part 3503 in a job ticket shown in FIG. 13 when a JDF print job by a job ticket as illustrated in FIG. 13 is input. The JDF print job is input to the printing apparatus via the external I/F 202 on the basis of, e.g., the JDF print function program 3108 which is stored in the hard disk 209 and executed by the controller unit 205 in FIG. 2. As shown in FIG. 18, this table is made up of three fields, which will be described below.

A function field 4501 holds the type of setting attribute of each function that is turned out as a result of analyzing a JDF job ticket. An analysis result field 4502 holds the analysis result of a JDF job ticket in accordance with the type in the function field 4501.

A performable/unperformable field 4503 holds a result of determining, for each setting item, whether to continue execution of a JDF print job when the controller unit 205 collates the analysis result of each function with the function field of the processing rule table. A value is set in the performable/unperformable field 4503 upon completion of analyzing a JDF part. The analysis result of each function is set in, e.g., the analysis result field 4502. The processing rule table is illustrated in FIG. 17. The performable/unperformable field 4503 may take the following three values:

OK: This value represents that a job can continue as a result of collating the analysis result of a JDF part for a given function with the operation specification field of the processing rule table shown in FIG. 17 when this function is not supported.

NG: This value represents that a job cannot continue and must be canceled as a result of collating the analysis result of a JDF part for a given function with the operation specification field of the processing rule table shown in FIG. 17 when this function is not supported.

N/A: This value represents that a target function does not concern determination of whether a job can continue because, for example, the function is not set from the beginning or the printing system 1000 does not support the function.

The JDF analysis result table shown in FIG. 18 is an example generated when a JDF job ticket illustrated in FIGS. 14A and 14B are analyzed while the device configuration management table shown in FIG. 16 is in the state shown in FIG. 16. The job ticket in FIGS. 14A and 14B designate execution of saddle stitching by a saddle stitcher, but the device configuration management table shown in FIG. 16 shows that a finisher capable of executing saddle stitching is not mounted. A value in the operation specification field in the case of not supporting the saddle stitching function in the processing rule table shown in FIG. 17 represents job cancellation. Thus, the value in the performable/unperformable field for the saddle stitching function in FIG. 18 is NG. That is, when the printing system 1000 has a configuration and state shown in FIG. 16, a JDF print job containing the JDF job ticket illustrated in FIGS. 14A and 14B are canceled without being executed.

(Basic Processing)

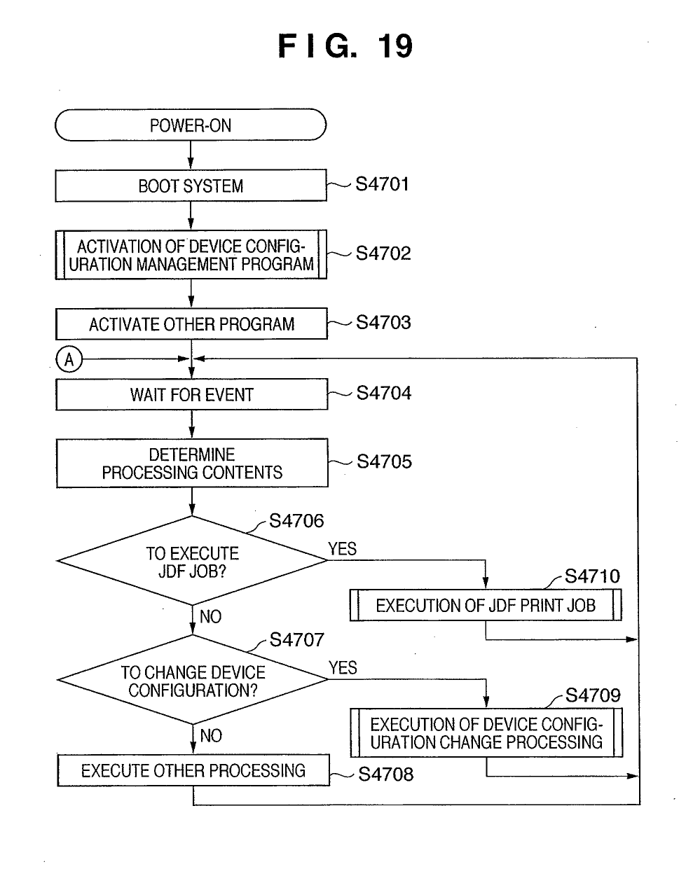

The operation of the printing system 1000 under the control of the controller unit 205 will be explained with reference to FIG. 19. FIG. 19 explains a processing sequence concerning control of the overall system serving as an MFP after the controller unit 205 in FIG. 2 activates the system.

Upon power-on, the system is booted (step S4701). More specifically, the controller unit 205 reads out the boot loader 3101 shown in FIG. 11 from the ROM 207, and executes the readout program. Processing in this step includes execution of all initialization processes such as issuing of initialization commands to various devices, resources, and the like connected to the printing system, and cleaning performed immediately upon activation of devices. Processing performed by the boot loader 3101 also includes a process to read out the operating system 3102 shown in FIG. 11 from the HDD 209 by the controller unit 205 shown in FIG. 2 and start the services of the operating system.

Upon completion of boot processing, the controller unit 205 reads out the device management function program 3104 from the ROM 207, and executes it (step S4702). According to the device management function program 3104 executed in this step, the controller unit 205 checks the device connection state, and creates the device configuration management table shown in FIG. 16 in the RAM 208. Details of the operation in step S4702 will be described later.

The process advances to step S4703, and the controller unit 205 reads out other programs from the ROM 207 and executes them. In this step, various programs in FIG. 11 stored in the ROM are loaded except for those which have already been loaded, but details thereof will be omitted.

At the stage of step S4703, all preparations for the printing system 1000 to function as an MFP are complete, and the process shifts to step S4704 to wait for an event. The event includes the following:

a job execution instruction or setting change by the user via the operation unit 204.

a print job input from an external device to the printing system 1000 via the external I/F 202.

reception of a JDF print job and a request to execute the received job.

a processing request such as acquisition of a device status, or change of various setting information and management information stored in a device, other than input of a job from an external device to the printing system 1000.

various events generated inside the printing system, such as the absence of paper and change of a device status, which trigger the printing system to change from the idle state.

In other words, the controller unit 205 which controls the whole printing system does not shift from step S4704 unless an event occurs.

In step S4704, if any event occurs in the printing system 1000 and the controller unit 205 is notified of it, the process advances to step S4705 and subsequent steps. The controller unit 205 identifies the generated event and executes an operation corresponding to it. First, in step S4705, the controller unit 205 determines the type of event generated in step S4704.

As a result of the determination performed in step S4705 upon occurrence of the event, the controller unit 205 determines whether the generated event is a JDF job execution start request. The JDF job execution start request is an event issued to the controller unit 205 when it is determined that the I/F unit 202 in FIG. 2 has received JDF job data from an external device. If the controller unit 205 determines in step S4706 that the generated event is the JDF job execution start request (YES in step S4706), the process advances to step S4710. If the controller unit 205 determines in step S4706 that the generated event is not the JDF job execution start request (NO in step S4706), the process advances to step S4707.

In step S4710, the controller unit 205 executes printing processing for the JDF print job input from an external device to the printing system 1000 via the external I/F 202. Details of the operation in step S4710 will be described later.

If the controller unit 205 determines in step S4706 that the generated event is not the JDF job execution start request as a result of the determination performed in step S4705 upon occurrence of the event (NO in step S4706), the process advances to step S4707. In step S4707, the controller unit 205 determines whether the generated event is change of the device configuration. If the controller unit 205 determines in step S4707 that the generated event is change of the device configuration (YES in step S4707), the process advances to step S4709 to execute device configuration change processing. Details of the device configuration change processing will be described later.

If the controller unit 205 determines in step S4707 that the event determined in step S4705 is neither the JDF job execution start request nor device configuration change processing (NO in step S4707), the process advances to step S4708. In step S4708, the controller unit 205 executes processing corresponding to the generated event type except for execution of the JDF job and change of the device configuration. In this step, processes of various contents are executed. However, the type and contents of each operation are not important for a description of the embodiment, so these operations are combined into a single step. However, this step includes execution of various processes, as described above.

After the controller unit 205 completes the processes in steps S4708, S4709, and S4710, the process moves to step S4704, and the controller unit 205 waits again for the next event processing.

(Device Configuration Management)

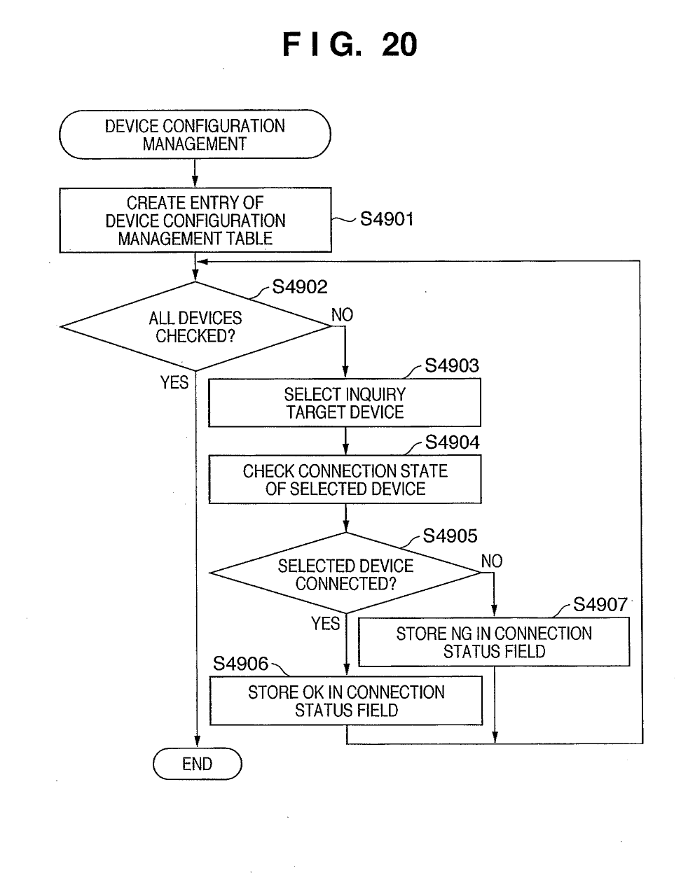

FIG. 20 is a flowchart for explaining the detailed operation of the device configuration management program executed by the controller unit 205 in step S4702 shown in FIG. 19. First, the controller unit 205 creates the entry of the device configuration management table in the RAM 208. The device configuration management table has already been described in detail with reference to FIG. 16, and a description thereof will not be repeated. The device configuration management table created in step S4901 holds information in only the device name field 4101 and device type field 4102, and the connection status field 4103 is blank. Processing in step S4902 and subsequent steps corresponds to processing to store a proper value in the connection status field 4103. In step S4902 as the first step of this processing, the controller unit 205 determines whether all devices registered in the device name field 4101 of the device configuration management table have been checked. When the process reaches step S4902 immediately after step S4901, the determination result in step S4902 is always NO.

If the controller unit 205 determines in step S4902 that a device to be checked remains (NO in step S4902), the process advances to step S4903 to select an inquiry target device. At this time, devices are selected in the order of device names in the device name field 4101 of the device configuration management table created in step S4901.

After executing the processing in step S4903, the controller unit 205 determines in step S4904 whether the device selected in step S4903 is connected to the printing system 1000. In the determination process executed at this time, the connection status is confirmed in accordance with a specific protocol via a connection means for electrically connecting devices, and a detailed description thereof will be omitted. In this step, for example, if the inquiry target device exists, the controller unit 205 receives a status to this effect and confirms the connection. To the contrary, if no response is sent back within a predetermined period even upon outputting an inquiry request and time-out occurs, the controller unit 205 determines that the inquiry target device is not connected.

In step S4905, the controller unit 205 determines the inquiry result of step S4904. If the controller unit 205 determines that the inquiry target device is connected (YES in step S4905), the process advances to step S4906 to update the status of the device in the connection status field 4103 of the device configuration management table to “OK”. If the controller unit 205 determines that no inquiry target device is connected (NO in step S4905), the process advances to step S4907 to update the status of the device in the connection status field 4103 of the device configuration management table to “NG”.

Upon completion of the processing in step S4906 or S4907, the process returns to step S4902 again to check the next device. Steps S4902 to S4906 and S4907 form a loop, and these steps are repetitively executed till the completion of checking all devices described in the device name field 4101 of the device configuration management table.

If the controller unit 205 determines in step S4902 that the connection states of all devices have been checked (YES in step S4902), the sequence in FIG. 20 ends.

(Printing Processing for JDF Print Job)

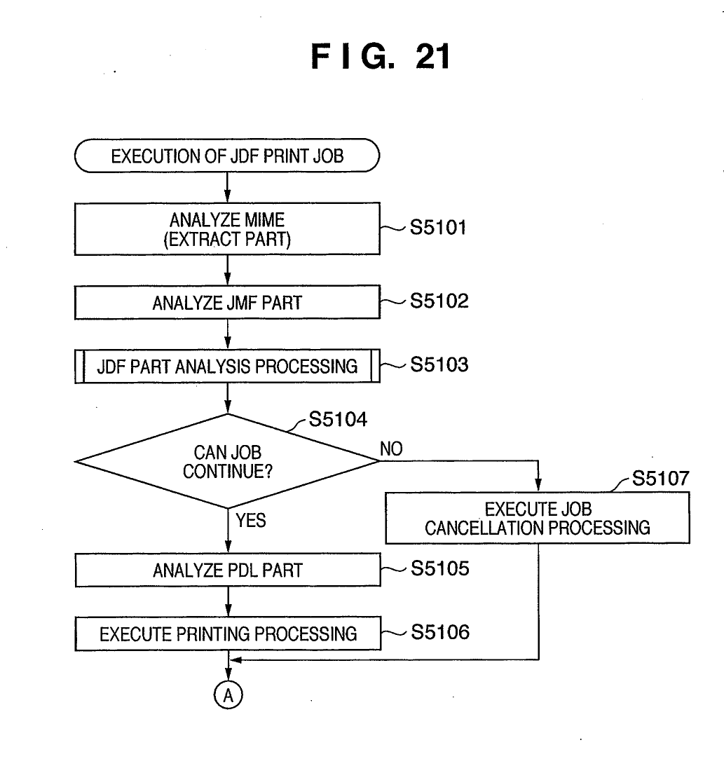

FIG. 21 is a flowchart for explaining a detailed sequence in step S4710 shown in FIG. 19, i.e., when the controller unit 205 executes printing processing for a JDF print job input to the printing system 1000.

First, the controller unit 205 analyzes the MIME format of data building a JDF print job (step S5101). More specifically, the controller unit 205 extracts contents from received MIME data on the basis of MIME header information, and stores the extracted contents in the hard disk 209. In this step, contents extracted from MIME data are three types: JMF, JDF, and PDL contents to be printed. The presence of one or more PDL contents is permitted.

The process advances to step S5102 to analyze the JMF part which has been extracted from the MIME data in step S5101 and is stored in the hard disk 209. The JMF itself is important in managing communication, status, and the like when the JDF workflow system is controlled. However, the JMF is not important for a description of the effects of the embodiment, and a detailed description thereof will be omitted.

Upon completion of the JMF part analysis processing in step S5102, the process advances to step S5103 to analyze the JDF part which has been extracted from the MIME data in step S5101 and is stored in the hard disk 209. Detailed processing in step S5103 will be described later. Based on setting information described in the job ticket, and the device capability and status as a result of the JDF analysis processing in step S5103, the controller unit 205 also determines whether a received can be executed.

In step S5104, based on setting information described in the job ticket determined in step S5103, and the device capability and status, the controller unit 205 determines whether the received job can be executed, and decides subsequent processing. If the controller unit 205 determines in step S5104 that the received job can be executed (YES in step S5104), the process advances to step S5105. If the controller unit 205 determines in step S5104 that no received job can be executed (NO in step S5104), the process advances to step S5107.

In step S5105, the controller unit 205 analyzes PDL contents which have been extracted from the MIME data in step S5101 and are to be printed. More specifically, the controller unit 205 analyzes a PDL command and converts it into image data in accordance with the setting information which is described in the JDF and has been analyzed in step S5103. The controller unit 205 finally converts the image data into a printable raster image, and stores the converted raster image in the hard disk 209. Details of the PDL data analysis processing are not important for a description of the effects of the embodiment, and a detailed description thereof will be omitted.

In step S5106, in accordance with the setting information which is described in the JDF and has been analyzed in step S5103, the controller unit 205 prints the target image data which have been rasterized in step S5105 and is stored in the hard disk 209. That is, the controller unit 205 performs printing processing on the basis of the JDF analysis result table as illustrated in FIG. 18. Of print functions necessary to satisfy printing conditions designated in the JDF, a function the printing system can provide in accordance with the designation is executed. As for a function the printing system cannot provide in accordance with the designation, an operation based on the operation specifications 4302 in the case of not supporting the function is executed. Hence, the configuration according to the embodiment can execute appropriate printing processing by functions the printing system can provide. After the end of the processing in step S5106, the process returns to step S4704 in FIG. 19.

If the controller unit 205 determines in step S5104 that no received job can be executed, it cancels execution of the job in step S5107. After the end of the processing in step S5107, the process returns to step S4704 in FIG. 19.

(JDF Part Analysis Processing)

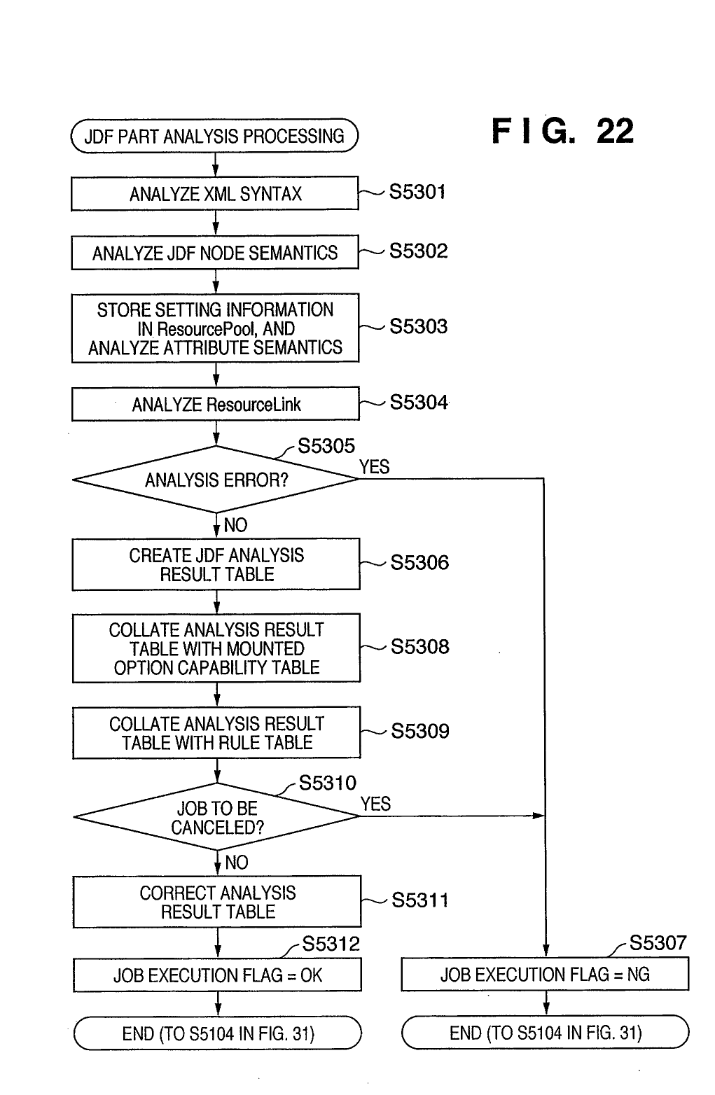

FIG. 22 is a flowchart for explaining details of the operation in step S5103 of FIG. 21, i.e., JDF part analysis processing. First, the controller unit 205 analyzes the XML syntax, and loads elements and attribute information described in the JDF into an internal data structure (step S5301).

In step S5302 and subsequent steps, the controller unit 205 analyzes the semantics of information obtained as a result of the analysis in step S5301. In step S5302, the controller unit 205 analyzes the semantics of a JDF node serving as a root node in the JDF. The JDF node holds information necessary for job management, and information on, e.g., the definition of a process in the JDF.

In step S5303, the controller unit 205 analyzes the semantics of information in a resource pool serving as a setting parameter storage location in the JDF that is used when executing a job. The resource pool stores various kinds of setting information which should be reflected in actual PDL rasterization processing, image processing such as imposition, printing processing, finishing processing, and the like.

In step S5304, the controller unit 205 checks whether link information for the JDF process and resources is properly represented and whether there is any inconsistent link setting. The above-described steps S5301 to S5304 correspond to the syntax analysis and semantic analysis of the JDF part.

After the end of the processing in step S5304, the controller unit 205 determines in step S5305 whether an analysis error has occurred in the processing from steps S5301 to S5304. If the controller unit 205 determines that an analysis error has occurred (YES in step S5305), no job can be executed, and thus the process advances to step S5307 to set the job execution flag to NG. The job execution flag means a specific area allocated in the RAM 208 in order to execute a program which causes the controller unit 205 to execute the processing described in the flowchart of FIG. 22.

If the controller unit 205 determines in step S5305 that no analysis error has occurred in the processing from steps S5301 to S5304 (NO in step S5305), the process advances to step S5306 to create a JDF analysis result table. Details of the JDF analysis result table created in this step have already been described with reference to FIG. 18, and a description thereof will not be repeated. Upon completion of the processing in step S5306, the process advances to step S5308.

In step S5308, the controller unit 205 collates information of the analysis result table created in step S5306 with that of the mounted option capability table shown in FIG. 15. As for job settings held in the analysis result table, functions which cannot be executed by the current configuration of the printing system 1000 are extracted from functions described in the mounted option capability table.

In step S5309, the controller unit 205 collates each function which has been extracted in step S5308 and cannot be executed by the current configuration of the printing system 1000, with a corresponding field of the processing rule table shown in FIG. 17. In step S5310, the controller unit 205 determines whether a value in the operation specification field 4302 of the processing rule table that corresponds to each function extracted in step S5308 exhibits job cancellation as a result of the collation in step S5309.

If the controller unit 205 determines that there is a job setting which cannot be executed by the device configuration or capability, and that there is even one function defined to cancel a job when this function is set (YES in step S5310), the process advances to step S5307. In step S5307, the controller unit 205 cancels the job.

If NO in step S5310, no job need be canceled even when there is a job setting which cannot be executed by the device configuration or capability. In this case, execution of a job can continue by selecting a default value or ignoring the setting in accordance with contents described in the processing rule table. Hence, if NO in step S5310, the process advances to step S5311 to correct the contents of the JDF analysis result table in accordance with contents described in the processing rule table shown in FIG. 17. Then, the process advances to step S5312 to set the job execution flag to OK.

(Device Configuration Change Processing)

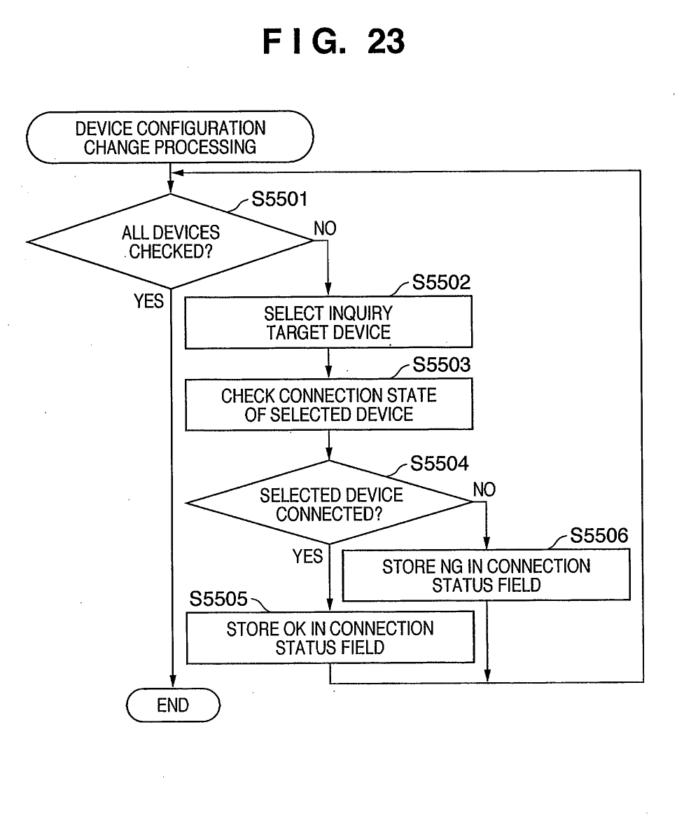

FIG. 23 is a flowchart showing details of device configuration management table correction processing in step S4709 of FIG. 19, i.e., when the device configuration changes upon activation of the printing system 1000.

If the controller unit 205 determines in step S5501 that a device to be checked remains (NO in step S5501), the process advances to step S5502 to select an inquiry target device. At this time, devices are selected in the order of device names in the device name field 4101 of the device configuration management table.

In step S5503, the controller unit 205 determines whether the device selected in step S5502 is connected to the printing system 1000. In the determination process executed at this time, the connection status is confirmed in accordance with a specific protocol via a connection means for electrically connecting devices, and a detailed description thereof will be omitted. In this step, if the inquiry target device exists, the controller unit 205 receives a status to this effect and confirms the connection. To the contrary, if no response is sent back within a predetermined period even upon outputting an inquiry request and time-out occurs, the controller unit 205 determines that the inquiry target device is not connected.

In step S5504, the controller unit 205 determines the inquiry result of step S5503. If the controller unit 205 determines that the inquiry target device is connected (YES in step S5504), the process advances to step S5505 to update the status of the device in the connection status field 4103 of the device configuration management table to “OK”. If the controller unit 205 determines in step S5504 that no inquiry target device is connected (NO in step S5504), the process advances to step S5506. In step S5506, the controller unit 205 updates the status of the device in the connection status field 4103 of the device configuration management table to “NG”.

Upon completion of the processing in step S5505 or S5506, the process returns to step S5501 again to check the next device. Steps S5501 to S5505 and S5506 form a loop, and these steps are repetitively executed till the completion of checking all devices described in the device name field 4101 of the device configuration management table.

If the controller unit 205 determines in step S5501 that the connection states of all devices have been checked (YES in step S5501), the sequence in FIG. 23 ends.

The configuration according to the embodiment can build a user-friendly printing environment adaptable not only to the office environment but also to the POD environment. For example, the printing system 1000 can satisfy needs at actual work site in a printing environment such as the POD environment. Such needs include a need to operate the system at the highest productivity, and a need to reduce the work load on an operator.

Assume that instructions associated with all printing processes are issued from print data containing a JDF job ticket which recent POD printing apparatuses are becoming able to deal with. In this case, the printing system according to the embodiment can cope with instructions associated with a series of work processes not by a single device but by cooperation between devices, including document entry to delivery of printed materials serving as a final product. That is, only one instruction statement can manage a workflow of processes using a plurality of devices. This implements cooperation between devices throughout printing processing and automation of various devices.

Especially assume that a printing system is configured to allow various devices to process jobs in a common format independent of a single device. For example, assume that when a digital MFP supports the JDF, the system receives a created JDF job ticket and executes printing processing and the like without knowing device specifications and configuration information, unlike a conventional printer driver.

In a conventional system, a printing apparatus (printing system) may not be able to completely execute operations designated by a job ticket depending on the execution environment (e.g., device capability or mounted accessories). From the viewpoint of a user, when he designates printing using a job ticket but the printing apparatus (printing system) cannot create designated printed materials, he may want to cancel processing of the job. Alternatively, the user may want the printing apparatus (printing system) to output even printed materials even if some settings are not reflected. JDF data is promising for versatility, device automation, cooperation between devices, device management, and the like. However, JDF data is not prepared for only one device or a specific type of device. For this reason, in the conventional system, an output result the user wants cannot be determined by a single device.

To the contrary, in the configuration according to the embodiment, JDF data contained in an input print job is analyzed to determine whether printing processing which satisfies printing conditions represented by the JDF data is performable, as described above. When it is determined that the printing processing is performable, printing processing is performed on the basis of the input print job. When it is determined that printing processing is unperformable, printing processing based on the print job is canceled. As a result, the configuration according to the embodiment can properly control processing regardless of whether the printing system can perform printing processing on the basis of JDF data contained in an input print job. The configuration according to the embodiment can provide a technique capable of performing proper printing processing without any cumbersome user operation in a printing system which operates on the basis of a print job describing printing conditions in a general-purpose format.

The present invention can provide a technique associated with a printing system capable of flexibly meeting various user needs as described above. The present invention can establish a convenient, flexible printing environment capable of coping with use cases and needs assumable in the POD environment as described in Description of the Related Art. The present invention can provide various mechanisms toward practical use of a product.

In the above-described configuration, if “cancel job” is not designated for all unsupported print functions necessary to satisfy printing conditions represented by the JDF contained in a print job, processing is executed with an alternative function. When executing processing with an alternative function, log information (log file) indicating the result of the printing processing is recorded and controlled in a predetermined storage (e.g., HD or RAM). The recorded log information can be displayed on a display means in accordance with an instruction from the user. This configuration allows the user to know printing processing actually performed using the print function different from the settings of the print job.

In job performable/unperformable determination, if it is determined that a job is unperformable, it is also possible to display unperformable printing conditions on a display means, control them, change them in accordance with an instruction from the user, and perform printing processing. This configuration allows the user to appropriately adjust printing conditions in accordance with functions the printing system can provide, and execute desired printing processing.

If it is determined that printing processing is unperformable, and job cancellation processing is to be executed, the print job may also be stored in a storage (job storage means) such as an HD. This configuration enables reading out the print job later from the storage and performing printing processing again.

It is also possible to display the printing conditions of a canceled print job stored in the storage on the display means, control them, change them in accordance with an instruction from the user, and perform printing processing on the basis of the stored print job. This configuration enables reading out the stored print job later in accordance with a user instruction, properly updating the printing conditions, and executing appropriate printing processing.

### Second Embodiment

The second embodiment will explain a configuration which allows the user to change the contents of a processing rule table. The configuration according to the second embodiment is almost common to that according to the first embodiment. The same reference numerals denote the same parts, and a difference from the first embodiment will be mainly described.

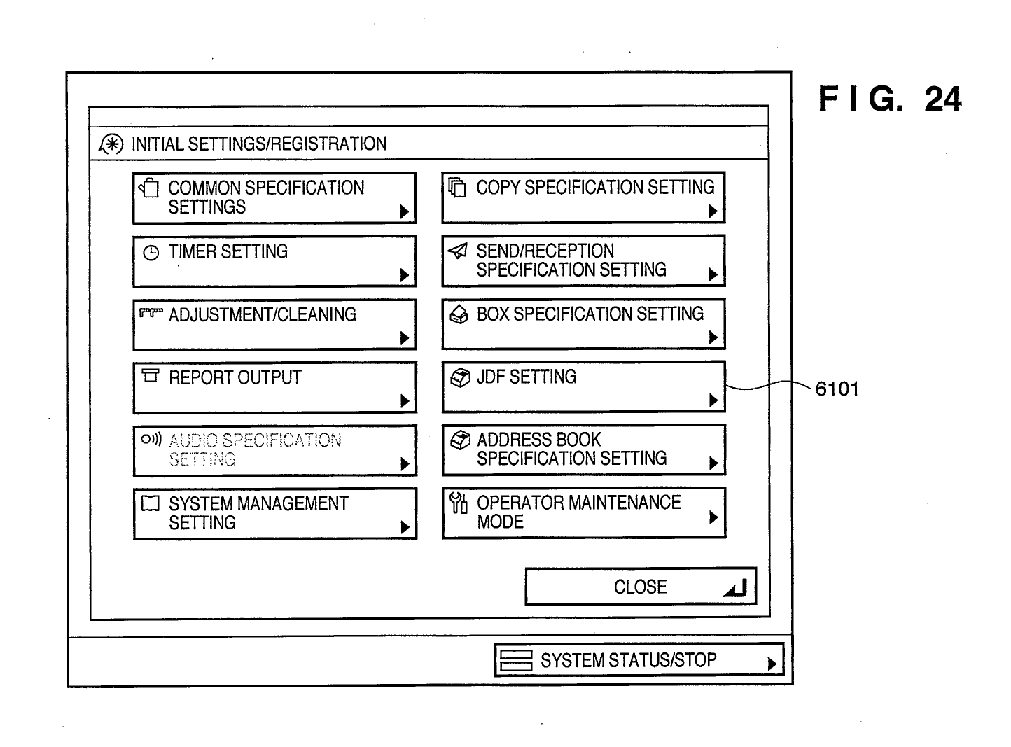

FIG. 24 is a view showing an example of a system setup window displayed on a touch panel unit 401 under the control of a controller unit 205 immediately after the user of a printing system 1000 presses a user mode key 505 shown in FIG. 7. As shown in FIG. 24, the LCD displays buttons corresponding to a variety of system setting functions.

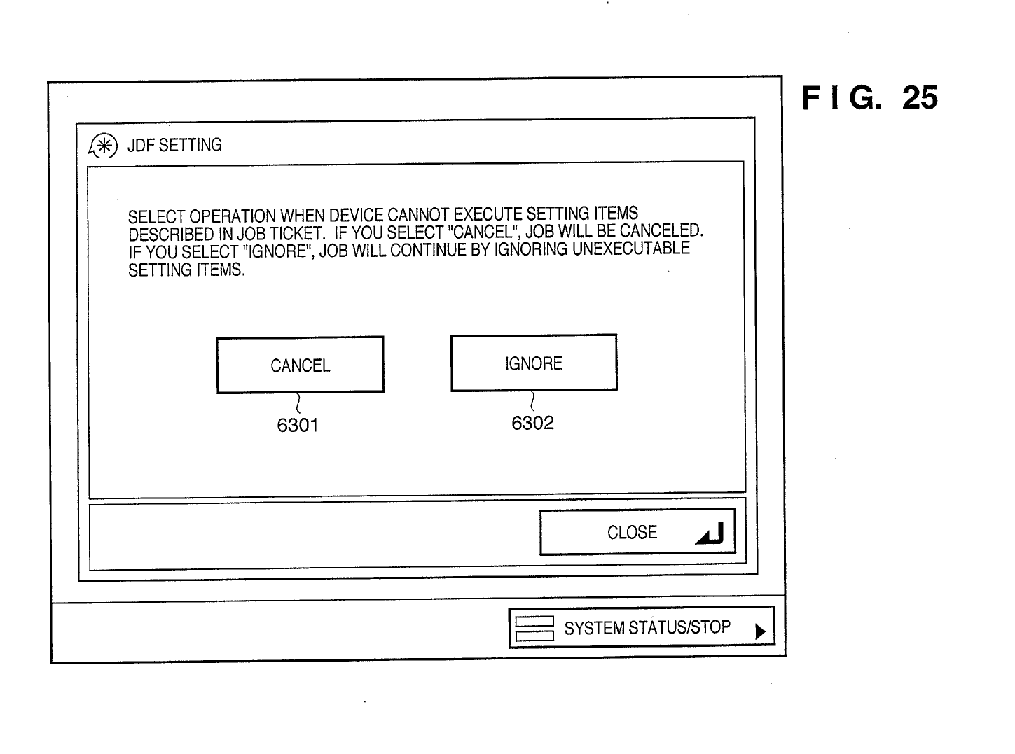

The role of a JDF setting button 6101 among system setting function buttons shown in FIG. 24 will be explained. The JDF setting button is used to display a setup window provided by the printing system 1000 to make the operation settings of a JDF print job. FIG. 25 shows an operation window displayed on the LCD immediately after the user presses the JDF setting button 6101.

The JDF setup window in the printing system 1000 according to the second embodiment provides a function of prompting the user to select an operation, as shown in FIG. 25, when setting items described in a JDF job ticket cannot be executed by the device configuration or capability of the printing system 1000 or the like. In this window, the user can select the following two types of operations:

a mode corresponding to a cancel button 6301 in which a job is canceled when setting items described in a JDF job ticket cannot be executed by the device configuration or capability of the printing system 1000 or the like.

a mode corresponding to an ignore button 6302 in which a job is kept executed by ignoring setting items when setting items described in a JDF job ticket cannot be executed by the device configuration or capability of the printing system 1000 or the like.

In FIG. 25, the ignore button 6302 is selected on the LCD. When the user presses the cancel button 6301, the cancel button 6301 changes to the selected state. This operation is done under the control of the controller unit 205 of the printing system 1000.

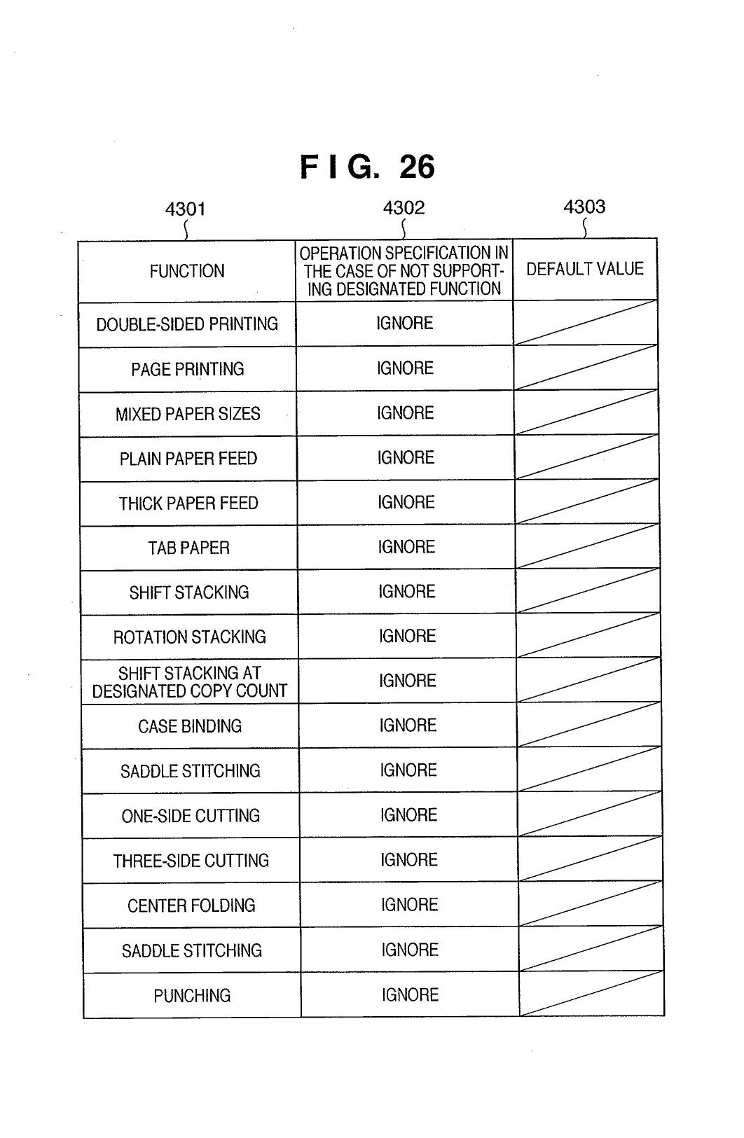

FIG. 26 is a table showing information which is modified and stored in the processing rule table shown in FIG. 17 under the control of the controller unit 205 after the user selects the ignore button 6302 in the JDF setup window shown in FIG. 25. As shown in FIG. 26, a value in an operation specification field 4302 in the case of not supporting a designated function represents “ignore” as a behavior when a function described in a function field 4301 cannot be executed by the device configuration or capability of the printing system 1000 or the like. In the case where the information of the processing rule table is described as shown in FIG. 26, if a JDF print job is input and its JDF job ticket designates an unperformable function, the setting is ignored to continue execution of the job, as shown in FIG. 26. This is because the job continues or is canceled in accordance with contents described in the processing rule table, as described in the first embodiment.

More specifically, assume that a JDF job ticket containing settings such as saddle stitching and case binding is received while no sheet processing apparatus 200 is mounted in the printing system 1000. In this case, settings concerning unperformable sheet processes are ignored, and output materials not reflecting these settings are finally generated. For example, assume that an off-line finisher 110, near-line finisher 107, and the like exist in a workflow by a user who introduces the printing system 1000, as shown in FIG. 1. In this case, the operator can set output materials in the off-line finisher 110 and near-line finisher 107 in the printing system and process them by the finishers 110 and 107. The user can accomplish his purpose to obtain saddle-stitched and case-bound output materials as final outputs.

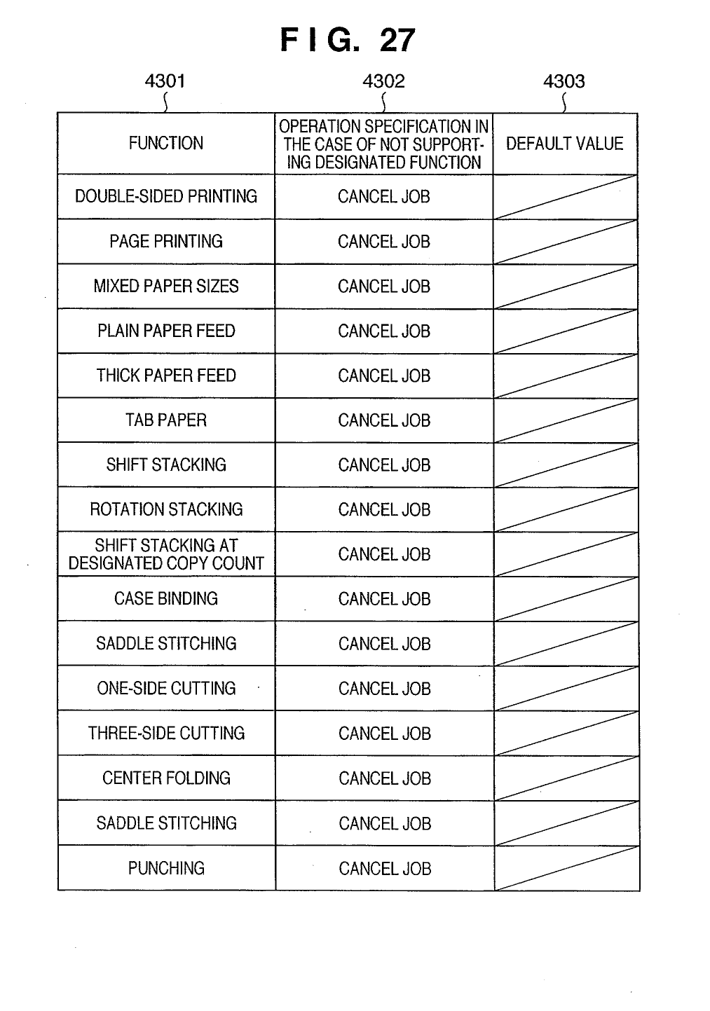

FIG. 27 is a table showing information which is modified and stored in the processing rule table shown in FIG. 17 under the control of the controller unit 205 after the user selects the cancel button 6301 in the JDF setup window shown in FIG. 25. As shown in FIG. 27, a value in the operation specification field 4302 represents “cancel job” as a behavior when a function described in the function field 4301 cannot be executed by the device configuration or capability of the printing system 1000 or the like. Assume that when the information of the processing rule table is in the state shown in FIG. 27, a JDF print job is input to the printing system 1000 and its JDF job ticket designates an unperformable function. In this case, the job continues or is canceled in accordance with contents described in the processing rule table, as described in the first embodiment. Thus, if the unperformable setting exists, execution of the job is canceled, as shown in FIG. 27.

More specifically, assume that a JDF job ticket containing settings such as saddle stitching and case binding is received while no sheet processing apparatus 200 is mounted in the printing system 1000. In this case, if settings concerning unperformable sheet processes exist, the job is canceled not to generate any output material. For example, assume that neither the off-line finisher 110 nor near-line finisher 107 exists in a workflow by a user who introduces the printing system 1000, and the printing system 1000 does not comprise the sheet processing apparatus 200. In this case, if the settings are ignored to continue execution of a job upon receiving the job which designates saddle stitching and case binding, output materials the user does not want are generated as final outputs. By canceling the job, therefore, the user's purpose to prevent defective outputs can be achieved.

(Basic Processing)

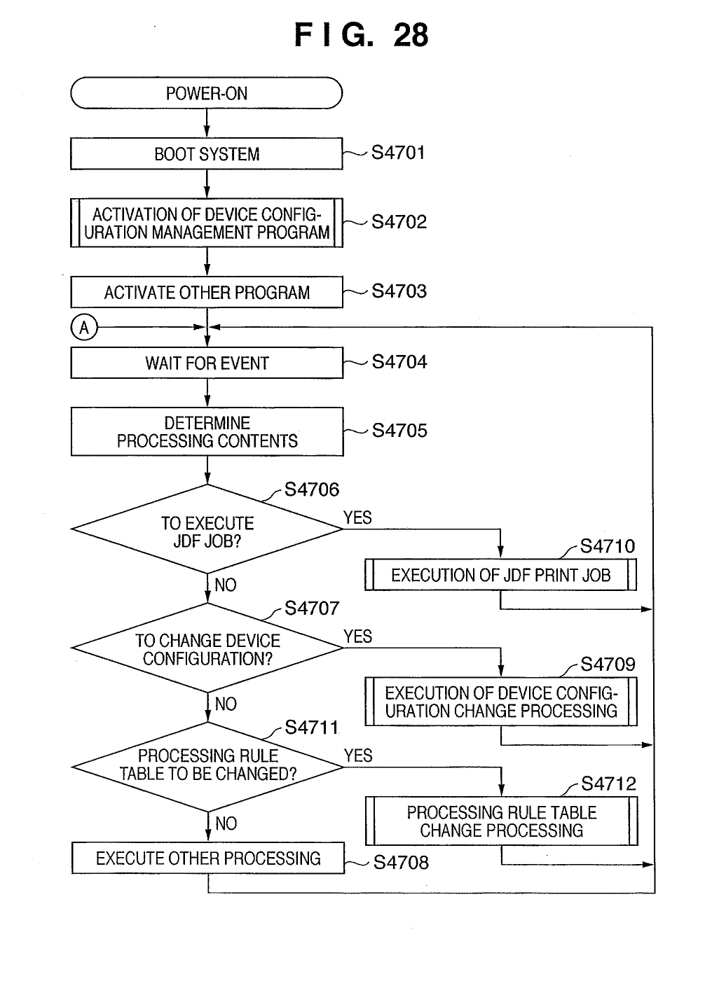

FIG. 28 is a flowchart for explaining a processing sequence concerning control of the overall system serving as an MFP after the controller unit 205 in FIG. 2 in the printing system 1000 according to the second embodiment activates the system. The flowchart in FIG. 28 corresponds to that in FIG. 19 according to the first embodiment. Most of the flowchart in FIG. 28 is common to that in FIG. 19, and only a difference from the sequence in FIG. 19 will be explained in the second embodiment.

In the second embodiment, if NO in step S4707, the process advances to step S4711. In step S4711, the controller unit 205 determines whether the contents of a processing request generated in step S4704 represent a request to change contents described in the processing rule table. In the second embodiment, the request to change contents described in the processing rule table corresponds to an operation when the user selects a behavior from the operation window shown in FIG. 25 in the case where a function in the function field 4301 cannot be executed by the device configuration or capability of the printing system 1000 or the like.

If YES in step S4711, the process advances to step S4712. In step S4712, the controller unit 205 executes the processing rule table content change processing, and upon completion of the processing, shifts to step S4704 to wait for an event. Details of step S4712 will be described later. After executing the processing in step S4712, the process returns to step S4704.

If NO in step S4711, the process advances to step S4708 to execute processing corresponding to the generated event type except for execution of the JDF job, change of the processing rule table, and change of the device configuration. In this step, processes of various contents are executed. However, the type and contents of each operation are not important for a description of the embodiment, so these operations are combined into a single step. However, this step includes execution of various processes, as described above. Upon completion of the processing in step S4708, the process shifts to step S4704 to wait for an event.

(Processing Rule Table Change Processing)

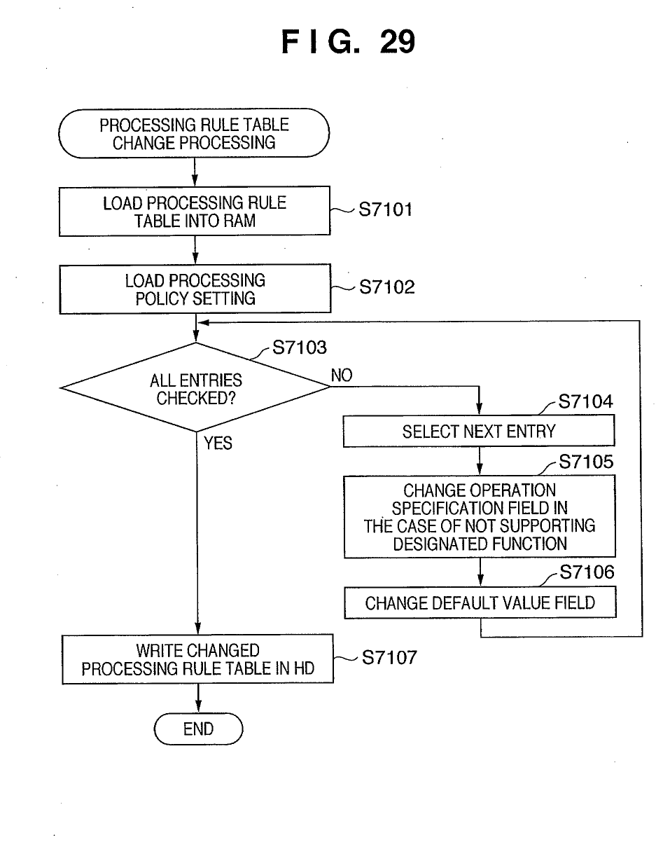

FIG. 29 is a flowchart for explaining details of processing rule table change processing in step S4712 of FIG. 28.

In step S7101, the controller unit 205 loads a processing rule table from a hard disk 209 to a RAM 208. In step S7102, the controller unit 205 loads a processing policy value “cancel” or “ignore” selected by the user in the operation window shown in FIG. 25. The value loaded in step S7102 is stored in the RAM 208 under the control of the controller unit 205 in the operation to the operation window in FIG. 25. This value is loaded in step S7102.

In step S7103, the controller unit 205 determines whether an entry to be scanned still remains in the processing rule table. If an unprocessed entry remains (NO in step S7103), the process advances to step S7104 to select an entry to be processed next in the processing rule table. After the end of the processing in step S7104, the process advances to step S7105.

In step S7105, the controller unit 205 writes the value read out from the RAM 208 in step S7102 in the operation specification field 4302 of the entry selected in step S7104.

In step S7106, the controller unit 205 writes a value in the default value field 4303 of the processing rule table. In the second embodiment, values writable in the operation specification field are only “ignore” and “cancel job”, and no default value need be explicitly set. Hence, the operation in step S7106 according to the second embodiment means that an initial value or a value representing that no value is stored is written in this field.

Upon completion of the processing in step S7106, the process returns to step S7103. Steps S7103 to S7106 form a loop, and the processes in steps S7103 to S7106 are repeated till the completion of the processing for all entries in the processing rule table.

If the controller unit 205 determines in step S7103 that the processing is complete for all entries (YES in step S7103), it writes back the modified processing rule table from the RAM 208 to the hard disk 209, and the process ends.

As described above, the configuration according to the second embodiment accepts a change of the processing rule table from the user. The user can set printing processing appropriate for the application purpose.

A configuration common to all the configurations in the above-described embodiments will be complemented for confirmation.

The printing apparatus 100 of the printing system 1000 according to the embodiments can accept at least roughly two types of jobs as jobs requiring printing processing by the printing apparatus 100.

For example, as described above, the controller 205 controls the system 1000 so that the printing apparatus 100 can accept a “job whose series of processing condition data including printing conditions in printing by the printer unit 203 and post-processing conditions are expressed by the JDF data.” The printing system 1000 according to the embodiments can accept a job which designates various instructions and operation commands to the printing system 1000 by JDF data. In the embodiments, this job is defined as, e.g., a “JDF job” and also called a “first-type job”.

The JDF stands for “Job Definition Format”. The JDF is a data format for designating printing processes proposed by CIP4 (The International Cooperation for Integration of Processes in Prepress, Press and Postpress). The JDF is described in the XML language. CIP4 is an international cooperation for integration of processes in prepress, press and postpress.

The system 1000 is configured to be able to designate instructions to the system 1000 by using JDF data, including an instruction concerning printing processing by the printing apparatus 100, and an instruction concerning post-processing by the in-line finisher 200. In other words, JDF data contains, as commands, various processing execution requests to the system 1000. In the embodiments, the system 1000 is configured to be able to accept a job whose JDF data contains, as a command, even a request to execute processing not corresponding to one performable by the system 1000. That is, the system 1000 is configured to be able to accept JDF data containing both a command to the system 1000 and a command not to the system 1000, as a series of processing condition data for one target job.

In the embodiments, a job which represents various commands by JDF data and corresponds to a job to be accepted by the system 1000 is defined as a “JDF job”.

In this configuration, assume that a target job for which the operator issues a request via the UI unit of the embodiments to execute printing by the printing apparatus 100 of the system 1000 is a JDF job. Upon accepting the JDF job by the system 1000, the controller 205 executes control described in the embodiments, and controls the system 1000 to execute various processes as illustrated above for the JDF job.

The reason why the system 1000 is configured to be able to process a JDF job in the embodiments, and the operation effects of this configuration will be exemplified.

For example, the following effects can be obtained by allowing the system 1000 including the printing apparatus 100 to process a JDF job. For example, in the POD environment 10000 of FIG. 1, “pre-printing processing (prepress) corresponding to processing to be executed for a target job prior to printing processing by the printing apparatus 100”, such as print editing processing by the PC 104, is performed. After this processing, the printing apparatus 100 performs printing processing (press) for the target job. After the printing processing, the in-line finisher 200 or near-line finisher defined at the beginning of the embodiments with reference to FIG. 1 performs post-processing (postpress) for the job. The postpress corresponds to “post-printing processing corresponding to processing to be executed for a target job after printing processing by the printing apparatus 100”.

As described above, the POD environment 10000 in FIG. 1 is configured to be able to execute a series of processes (series of processes: prepress press→postpress) to be executed by independent devices as a workflow (also called a job flow) necessary to complete creation of printed materials of a target job. In other words, according to the embodiments, the POD environment 10000 comprises a plurality of production devices (e.g., the PC 104, printing apparatus 100, and non-off-line finishers (in-line finisher 200 and near-line finisher 108 or 109)) necessary to execute the workflow from “prepress” to “post-processing (postpress)”. The POD environment 10000 is configured to be able to connect these devices via the network 101 to a production control computer (e.g., the server computer PC 103) for managing them, so that the computer 103 can manage these devices.

In this way, the POD environment 10000 according to the embodiments is configured to be able to communicate data between the printing apparatus 100 and the computer 104 via the network 101. The POD environment 10000 is configured to be able to also communicate data between the printing apparatus 100 and non-off-line finishers (e.g., the in-line finisher 200 and near-line finisher 108 or 109) via the network 101. The POD environment 10000 is configured to be able to also communicate data between the computer 104 and non-off-line finishers (e.g., the in-line finisher 200 and near-line finisher 108 or 109) via the network 101. The POD environment 10000 is configured to be able to use highly versatile digital data (XML) for data communication between devices in order to execute different processes necessary to complete creation of printed materials.

As a concrete configuration necessary for this purpose, according to the embodiments, the controller 205 controls the printing apparatus 100 to process a JDF job as a print job using XML data, as described above.

This configuration according to the embodiments can satisfy various needs exemplified as follows which receive attention in the embodiments and may arise in a printing environment such as the POD environment, as exemplary needs which are hardly or not met because the printing system does not support the JDF:

(1) a need “to manage the entire flow from the upstream to downstream and increase the productivity because the efficiencies of each machine and each work have reached their limits.”

(2) a need “to prevent a transmission loss and error of production information.”

(3) a need to improve a “workflow to write a paper order receipt slip by hand by a salesperson though data to be printed is electronic data created by a customer's PC, to make a production plan by production control on the basis of the order receipt slip, and to perform CTP and printing”, i.e., a need to increase the efficiency of a “nonuniform workflow using both paper data and electronic data such that given work is done using paper and another work uses a computer.”

In order to satisfy needs which may arise in a printing environment such as the POD environment, the controller 205 controls the printing apparatus 100 to accept a JDF job, as described above, and the printing system 1000 to execute processing of the JDF job, as described in the embodiments.

Since the printing system 1000 is configured to be able to deal with the JDF format, effects of, e.g., meeting various needs described above can be attained.

For example, the system 1000 can enhance as much as possible a JDF-specific advantage that “all paper documents such as the order receipt slip, work instructions, completion report, and daily report used in a printing company can be electronized.” This advantage is assumed and receives attention as one JDF advantage in the embodiments.

For example, the system 1000 can enhance as much as possible a JDF-specific advantage that “a salesperson can fully grasp CTP and processes in progress and finished in the printing apparatus and bookbinding apparatus.” This advantage is assumed and receives attention as another JDF advantage in the embodiments. Also, the system 1000 can enhance an advantage that “JDF data can be confirmed on a corporate portal, browser, or PDF to issue an instruction because the JDF adopts XML.” This is assumed and receives attention as still another JDF advantage in the embodiments. The system 1000 can contribute to an increase in work efficiency.

The above-described configuration which gives attention to these points is also a remarkable feature of the printing system 1000 according to the embodiments. As another remarkable feature, the printing system 1000 according to the embodiments further employs the following configuration.

As described above, according to the embodiments, the printing system 1000 is configured to be able to accept a “JDF job” corresponding to the first-type job as a job to be printed by the printing apparatus 100. On the premise of this configuration, according to the embodiments, the printing system 1000 is configured to be able to accept even a job of different type from the “JDF job” corresponding to the first-type job as a job to be printed by the printing apparatus 100.

For example, the printing system 1000 is configured to be able to make full use of the functions of the printing apparatus 100 and those of the in-line finisher 200. The printing system 1000 is configured to be independent of another device. Also, the printing system 1000 is configured to be able to accept a print execution request from the user via a printer driver unique to the printing system 1000.

For example, the printing system 1000 is configured to be able to install, in an external apparatus such as the PC 103 or 104 in FIG. 1, a printer driver which is provided by the manufacturer of the printing apparatus 100 and dedicated to the printing apparatus 100. In response to an operator operation using the mouse or keyboard of the external apparatus, its CPU activates the printer driver dedicated to the printing apparatus 100 in the external apparatus, and displays the setup window of the printer driver (e.g., the print setup window in FIG. 10) on the display of the external apparatus. Upon accepting the printing processing conditions and print execution request of a target job by a user operation via the setup window of the printer driver displayed on the display of the external apparatus, the CPU of the external apparatus transmits the job data to the printing apparatus 100 via the network 101. At this time, the CPU of the external apparatus transmits the job data to be printed by the printing apparatus 100 in the format of non-JDF data (e.g., PDL data) which is not the JDF data format and is unique to the manufacturer of the printing apparatus 100. The printing apparatus 100 prints the non-JDF data as a target job.

In this way, the printing system 1000 according to the embodiments is configured to be able to accept, as target jobs, not only a JDF job corresponding to the above-mentioned first-type job but also non-JDF data.

In the embodiments, a job of “non-JDF data” is defined as a “non-JDF job”, and also called a second-type job. In the embodiments, the “non-JDF job” means and is defined as a “job which describes various execution requests to the system 1000 in a language other than the XML language and is permitted to be accepted by the printing system 1000.”

For example, the printing system 1000 is configured to be able to accept even a “PDL job” corresponding to an example of the “non-JDF job” via the external I/F unit 202 of the system 1000. The PDL stands for Page Description Language. In the embodiments, the controller 205 causes the system 1000 to execute processing necessary for the PDL job accepted by the system 1000. In other words, the controller 205 controls the system 1000 so that the printing apparatus 100 can accept a “job whose series of processing condition data including printing conditions in printing by the printer unit 203 and post-processing conditions are expressed in a data format other than the JDF data format.”

The printing system 1000 according to the embodiments is configured to be able to accept a job which designates various instructions and operation commands to the printing system 1000 without using JDF data. In the embodiments, this job is defined as, e.g., a “non-JDF job” and also called a “second-type job”, as described above.

On the premise of this configuration, assume that a target job for which the operator issues a print execution request to the printing apparatus 100 of the system 1000 via the UI unit of the embodiments is a non-JDF job.

Assume that the system 1000 accepts the non-JDF job requiring printing processing via the external I/F unit 202 or the like. On condition of this, the controller 205 reads out a computer-readable control program from the HD 209, and executes it to process a non-JDF job by the system 1000. This control is discriminated from control to process a JDF job as described in the embodiments. By executing the control according to this program, the controller 205 causes the system 1000 to execute processing which should be executed by the system 1000 for the non-JDF job.

As described above, the controller 205 controls the system 1000 not only to be able to execute processing for a JDF job, but also to be able to execute even processing for a non-JDF job distinctively independently of processing for the JDF job. For this purpose, the system 1000 is configured as follows.

For example, assume that a print execution-requested target job is a JDF job. In this case, the controller 205 specifies printing processing conditions set by XML data of the JDF job when storing the JDF job data in the HD 209. In addition, the controller 205 reads out system configuration information of the system 1000 from the HD 209 and confirms it. The controller 205 checks whether the system 1000 can execute all processes necessary to complete printing of the JDF job, and makes the following illustrative determination.

For example, the accepted JDF job is a “job, some of designated processes of which cannot be executed by the system 1000, but the remaining processes of which can be executed by the system 1000.” Alternatively, the JDF job is a “job, none of designated processes of which can be executed by the system 1000.” Assume that the controller 205 makes a determination corresponding to at least either case. A JDF job corresponding to at least either case is defined as a “non-exact match JDF job”.

On condition that the target job is a “non-exact match JDF job”, the controller 205 reads out and refers to “control rule information for processing a JDF job (in the embodiments, corresponding information is managed in the management table format, as described above).” This information is held in advance in the HD 209 of the printing apparatus.

Assume that, as a result of reading out and referring to the control rule information, the system 1000 designates in advance settings “to inhibit the start of printing for a job corresponding to a non-exact match JDF job and execute job cancellation processing to end the job processing.” In this case, the controller 205 inhibits the printer unit 203 from starting printing the print data of the “non-exact match JDF job” accepted via the external I/F 202. At the same time, the controller 205 automatically ends the job processing without receiving any processing stop request from the operator. The controller 205 controls to erase, from the HD 209, the job data including the print data held in the HD 209.

The controller 205 controls the system 1000 to be able to automatically cancel a “non-exact match JDF job” in accordance with rule information set in advance for the JDF job in the system 1000.

Assume that, as a result of confirming the JDF job control rule information, the system 1000 designates in advance settings “to perform processes performable by the system 1000 for a job corresponding to a non-exact match JDF job, and ignore (not perform) processes unperformable by the system 1000, thereby permitting the printer unit 203 to execute printing processing without inhibiting the start of printing.” In this case, the controller 205 reads out, from the HD 209, print data of the “non-exact match JDF job” accepted via the external I/F 202, and prints the print data without inhibiting the printer unit 203 from starting printing it. Further, the controller 205 controls the system 1000 not to execute processes unperformable by the system 1000 among a plurality of processes designated by the JDF job, or to change unperformable processes to default processes performable by the system 1000 and execute the changed processes. The controller 205 causes the system 1000 to execute designated processes performable by the system 1000 among a plurality of processes designated by the JDF job.

The controller 205 controls the system 1000 to be able to automatically execute printing processing in accordance with rule information set in advance for a “non-exact match JDF job” in the system 1000 while inhibiting cancellation of the JDF job. In the embodiments, control to execute processes performable by the system 1000 and complete printing processing itself by the system 1000 without canceling the processing of a “non-exact match JDF job” is also called “non-exact match JDF job contraction processing”.

For example, the accepted JDF job is a “job, all of designated processes of which can be executed by the system 1000.” A JDF job for which the controller 205 makes a determination corresponding to this case is defined as a “processing condition exact match JDF job”. In this case, the controller 205 reads out, from the HD 209, print data of the “exact match JDF job” accepted via the external I/F 202 and prints the print data without referring to the rule information or inhibiting the start of printing the print data. The controller 205 causes the system 1000 to execute all processes necessary for the job.

On the premise of this configuration, assume that a non-JDF job is accepted via the external I/F while the printer unit 203 executes printing processing of a JDF job. In response to this, the controller 205 queues the non-JDF job in the HD 209, and makes the start of printing the non-JDF job wait for the end of processing the preceding JDF job. On condition that the controller 205 confirms from status information of the system 1000 that the processing of the preceding JDF job has ended in the system 1000, the controller 205 causes the printer unit 203 to start printing processing of the subsequent non-JDF job. Upon accepting the non-JDF job, the controller 205 refers to non-JDF job control rule information which is managed in advance in the HD 209 to be distinctive from JDF job control rule information. Based on the non-JDF job control rule information, the controller 205 controls the processing of the non-JDF job. In this fashion, the controller 205 controls the system 1000 to execute, for a non-JDF job, control and processing different from JDF job processing.

For example, the non-JDF job accepted by the system 1000 is a “job, some of designated processes of which cannot be executed by the system 1000, but the remaining processes of which can be executed by the system 1000.” Alternatively, the non-JDF job is a “job, none of designated processes of which can be executed by the system 1000.” Assume that the controller 205 makes a determination corresponding to at least either case. A non-JDF job corresponding to at least either case is defined as a “non-exact match non-JDF job”.

On condition that the target job is a “non-exact match non-JDF job”, the controller 205 reads out and refers to “control rule information for processing a non-JDF job.” This information is held in advance in the HD 209 of the printing apparatus.

Assume that, as a result of reading out and referring to the control rule information, the system 1000 designates in advance settings “to inhibit the start of printing for a job corresponding to a non-exact match non-JDF job and execute job cancellation processing to end the job processing.” In this case, the controller 205 inhibits the printer unit 203 from starting printing the print data of the “non-exact match non-JDF job” accepted via the external I/F 202. At the same time, the controller 205 automatically ends the non-JDF job processing without receiving any processing stop request from the operator. The controller 205 controls to erase, from the HD 209, the non-JDF job data including the print data held in the HD 209.

As described above, the controller 205 controls the system 1000 to be able to automatically cancel a “non-exact match non-JDF job” in accordance with rule information set in advance for the non-JDF job in the system 1000.

Assume that, as a result of reading out and referring to the “control rule information for processing a non-JDF job”, the system 1000 designates in advance settings “to perform processes performable by the system 1000 for a job corresponding to a non-exact match non-JDF job, and ignore (not perform) processes unperformable by the system 1000, thereby permitting the printer unit 203 to execute printing processing without inhibiting the start of printing.” In this case, the controller 205 reads out, from the HD 209, print data of the “non-exact match non-JDF job” accepted via the external I/F 202, and prints the print data without inhibiting the printer unit 203 from starting printing it. Further, the controller 205 controls the system 1000 not to execute processes unperformable by the system 1000 among a plurality of processes designated by the non-JDF job, or to change unperformable processes to default processes performable by the system 1000 and execute the changed processes. The controller 205 causes the system 1000 to execute designated processes performable by the system 1000 among a plurality of processes designated by the non-JDF job.

The controller 205 controls the system 1000 to be able to automatically execute printing processing in accordance with rule information set in advance for a “non-exact match non-JDF job” in the system 1000 while inhibiting cancellation of the non-JDF job. In the embodiments, control to execute processes performable by the system 1000 and complete printing processing itself by the system 1000 without canceling the processing of a “non-exact match non-JDF job” is also called “non-exact match non-JDF job contraction processing”.

For example, the accepted non-JDF job is a “job, all of designated processes of which can be executed by the system 1000.” A non-JDF job for which the controller 205 makes a determination corresponding to this case is defined as a “processing condition exact match non-JDF job”. In this case, the controller 205 reads out, from the HD 209, print data of the “exact match non-JDF job” accepted via the external I/F 202 and prints the print data without referring to the non-JDF job rule information or inhibiting the start of printing the print data. The controller 205 causes the system 1000 to execute all processes necessary for the job.

Also in the embodiments, the system 1000 is configured to be able to execute non-JDF job control distinctively independently of the above-mentioned JDF job control. For example, as the first control example, the controller 205 controls the system 1000 to be able to automatically execute cancellation processing of a “non-exact match non-JDF job” in accordance with rule information set in advance for the non-JDF job in the system 1000, as described above.

In the embodiments, the controller 205 executes the non-JDF job cancellation control even “in a case where the controller 205 controls the system 1000 to be able to automatically execute cancellation processing of a non-exact match JDF job in accordance with rule information set in advance for the JDF job in the system 1000.”

In this situation, the controller 205 allows the system 1000 to accept a JDF job even while controlling the system 1000 to execute cancellation processing of a “non-exact match non-JDF job”. During this period, the controller 205 causes the system 1000 to execute processing complying with the JDF job rule information on condition that the system 1000 has accepted a JDF job. For example, the controller 205 causes the system 1000 to execute JDF job cancellation processing on condition that the JDF job is a “non-exact match JDF job”.

As the second control example different from the first control example, assume that the controller 205 controls the system 1000 to be able to automatically execute cancellation processing of a “non-exact match non-JDF job” in accordance with rule information set in advance for the non-JDF job in the system 1000, as described above.

In the embodiments, the controller 205 executes the non-JDF job cancellation control even “in a case where the controller 205 controls the system 1000 to be able to automatically execute contraction processing of a non-exact match JDF job in accordance with rule information set in advance for the JDF job in the system 1000.”

In this situation, the controller 205 allows the system 1000 to accept a JDF job even while controlling the system 1000 to execute cancellation processing of a “non-exact match non-JDF job”. During this period, the controller 205 causes the system 1000 to execute processing complying with the JDF job rule information on condition that the system 1000 has accepted a JDF job. For example, the controller 205 causes the system 1000 to execute JDF job contraction processing on condition that the JDF job is a “non-exact match JDF job”.

As the third control example different from the second control example, assume that the controller 205 controls the system 1000 to be able to automatically execute contraction processing of a “non-exact match non-JDF job” in accordance with rule information set in advance for the non-JDF job in the system 1000, as described above.

In the embodiments, the controller 205 executes the non-JDF job contraction control even “in a case where the controller 205 controls the system 1000 to be able to automatically execute contraction processing of a non-exact match JDF job in accordance with rule information set in advance for the JDF job in the system 1000.”

In this situation, the controller 205 allows the system 1000 to accept a JDF job even while controlling the system 1000 to execute contraction processing of a “non-exact match non-JDF job”. During this period, the controller 205 causes the system 1000 to execute processing complying with the JDF job rule information on condition that the system 1000 has accepted a JDF job. For example, the controller 205 causes the system 1000 to execute JDF job contraction processing on condition that the JDF job is a “non-exact match JDF job”.

As the fourth control example different from the third control example, assume that the controller 205 controls the system 1000 to be able to automatically execute contraction processing of a “non-exact match non-JDF job” in accordance with rule information set in advance for the non-JDF job in the system 1000, as described above.

In the embodiments, the controller 205 executes the non-JDF job contraction control even “in a case where the controller 205 controls the system 1000 to be able to automatically execute cancellation processing of a non-exact match JDF job in accordance with rule information set in advance for the JDF job in the system 1000.”

In this situation, the controller 205 allows the system 1000 to accept a JDF job even while controlling the system 1000 to execute contraction processing of a “non-exact match non-JDF job”. During this period, the controller 205 causes the system 1000 to execute processing complying with the JDF job rule information on condition that the system 1000 has accepted a JDF job. For example, the controller 205 causes the system 1000 to execute JDF job cancellation processing on condition that the JDF job is a “non-exact match JDF job”.

As described above, according to the embodiments, the system 1000 is configured to be able to accept a plurality of types of jobs including the first-type job corresponding to a JDF job and the second-type job corresponding to a non-JDF job.

On the premise of this configuration, on condition that an accepted target job is a JDF job, the controller 205 confirms whether the JDF job is a non-exact match JDF job. If the controller 205 confirms that the JDF job is a non-exact match JDF job, it controls the system 1000 to process the JDF job in the above-described manner.

On the premise of the above-mentioned configuration, on condition that an accepted target job is a non-JDF job, the controller 205 confirms whether the non-JDF job is a non-exact match non-JDF job. If the controller 205 confirms that the non-JDF job is a non-exact match non-JDF job, it controls the system 1000 to process the non-JDF job in the above-described manner.

In this way, the system 1000 is configured to be able to execute JDF job control and non-JDF job control distinctively and independently.

On the premise of this configuration, the controller 205 allows the system 1000 to accept a non-JDF job processing request while printing processing necessary for a JDF job is in progress in the system 1000 in the above-described manner. Moreover, the controller 205 controls the system 1000 to make a non-JDF job, which has been accepted during printing of the JDF job, wait as a queued job in the HD 209. On condition that the system 1000 completes printing processing of the JDF job, the controller 205 allows the system 1000 to execute printing processing of the non-JDF job.

On the premise of this configuration, the controller 205 allows the system 1000 to accept a JDF job processing request while printing processing necessary for a non-JDF job is in progress in the system 1000 in the above-described manner. In addition, the controller 205 makes a JDF job, which has been accepted during printing of the non-JDF job, wait as a queued job in the HD 209. On condition that the system 1000 completes printing processing of the non-JDF job, the controller 205 allows the system 1000 to execute printing processing of the JDF job.

This configuration is also a main feature of the printing system 1000 according to the embodiments.

The printing system 1000 according to the embodiments comprises at least a JDF-compatible printing apparatus 100. The JDF-compatible printing apparatus 100 can utilize a digital format (also called an instruction statement or job ticket) which is common to all printing processes and will be expected in systems toward the POD market.

The system 1000 is configured to obtain as many JDF advantages described above as possible. As the advantages, the embodiments pay attention to, e.g., the following point.

For example, the JDF uses the basic Web format “XML”. By utilizing this feature, the JDF provides an advantage in management of all printing processes such that production control, and confirmation of the operating states of devices such as a printing apparatus and bookbinding apparatus can be done on a Web site. As a feature of the embodiments, the printing system 1000 can also have this advantage.

The JDF instruction statement can describe instructions associated with a series of work processes not by a single device but by cooperation between devices, including document entry to delivery of printed materials serving as a final product. With this feature, the JDF implements even management of a workflow of processes using a plurality of devices by one instruction statement. The JDF can achieve cooperation between devices engaged in all printing processes and automation of various devices. As a feature of the embodiments, the printing system 1000 can also have this advantage.

As another remarkable feature in addition to these advantages, the embodiments can solve the following exemplary problems which have not been fully examined.

(Problem 1) It is difficult to meet a user need to inhibit a printing apparatus and printing system from executing printing processing of a JDF job if the printing apparatus and printing system, which are configured to simply deal with a JDF job at most, cannot create printed materials as designated by the JDF.

For example, JDF settings can be made without knowing the specifications and configuration information of a printing apparatus, unlike a printer driver prepared for each printing apparatus. This configuration makes best use of the advantages of the JDF aimed at processing jobs by as various devices as possible in a common format independent of a single device.

In other words, this situation means the possibility of occurrence of a case where a printing apparatus and printing system cannot completely execute operations designated by a JDF job depending on the execution environment (e.g., the capabilities or equipment of the printing apparatus and system).

When viewed from a user, an assumable user need is that when he designates printing using the JDF but the printing apparatus (printing system) cannot create designated printed materials, he may want to cancel processing of the job.

Especially in a printing environment such as the POD environment receiving attention as a representative example in the embodiments, it is assumed that the system 1000 creates printed materials as a product to be delivered to a customer.

In a printing environment such as the POD environment where the system 1000 creates printed materials as a product, printed materials the customer does not want may be wasteful and raise the cost of failure.

The embodiments can solve even the above-described (problem 1), and satisfy the above-described user need unique to a printing environment such as the POD environment.

(Problem 2) It is difficult to meet a user need to process a JDF job even if a printing apparatus and system, which are configured to simply deal with a JDF job at most, cannot create printed materials as designated by the JDF.

Assume that a JDF job designates finishing unperformable by the in-line finisher 200 of the system 1000. In this case, the system 1000 cannot execute this processing. However, assume that a non-in-line type finisher such as an off- or near-line finisher described at the beginning of the embodiments is prepared at printing work site where the system 1000 is installed, like the POD environment 10000 in FIG. 1. In this case, even finishing unperformable by the in-line finisher of the system 1000 may be executed using the non-in-line type finisher to create printed materials as a product without any problem.

In this case, for example, “printed materials designated by the JDF cannot be completed by only the system 1000, but can be completed using a non-in-line type finisher without any problem. Hence, even if the printing system 1000 cannot complete printed materials serving as a product, the user wants the system 1000 to execute processes of a JDF job such as printing processing performable by the system 1000. This is efficient for processing many print jobs from a larger number of customers.”

This user need considering the total productivity of jobs may arise from the operator of the system 1000 at work site of the system 1000 in a printing environment such as the POD environment.

The embodiments pay attention to the fact that the user need to process a JDF job intentionally even if a printing apparatus and system cannot create printed materials as designated by the JDF may arise in a printing environment such as the POD environment.

However, a printing apparatus and printing system, which are configured to simply deal with a JDF job at most, hardly satisfy this need.

The embodiments can solve even the above-described (problem 2), and satisfy the above-described user need unique to a printing environment such as the POD environment.

As described above, JDF data is promising for versatility, device automation, cooperation between devices, device management, and the like. However, JDF data is not prepared for only one device or a specific type of device. This will lead to the above-mentioned cases. There is room to study in order to provide a printing system and printing apparatus capable of flexibly meeting various user needs as described above. The system 1000 can provide a mechanism for improving the status quo as much as possible, which is also a remarkable feature.

For this purpose, the system 1000 comprises various constituent features as illustrated in FIGS. 1 to 29, and the controller 205 can execute various control operations as described above for the system 1000.

As for the above-mentioned configurations, the system 1000 need not comprise all the configurations. In other words, the system 1000 can be configured arbitrarily as long as it can obtain at least one JDF operation effect described in the embodiments. However, the system 1000 is desirably configured to comprise at least the following building components.

The system 1000 is configured such that the printing apparatus 100 can process a plurality of types of jobs as jobs requiring printing processing. The controller 205 controls the system 1000 to be able to accept a JDF job designating a plurality of processing conditions in the XML language, and a non-JDF job (e.g., PDL job) designating a plurality of processing conditions in a language other than the XML language.

On the premise of this configuration, the controller 205 executes the following exemplary control. For example, the target job is “not the non-JDF job but the JDF job”. This is defined as condition A. In addition, the JDF job is “not a JDF job including no processing condition unperformable by the system 1000 but a JDF job including processing conditions unperformable by the system 1000”. This is defined as condition B. When both conditions A and B are satisfied, the controller 205 controls the system 1000 to be able to cancel printing processing of the JDF job.

On the premise of this configuration, the controller 205 also executes the following exemplary control. For example, the target job is “not the non-JDF job but the JDF job”. In addition, the JDF job is “not a JDF job including no processing condition unperformable by the system 1000 but a JDF job including processing conditions unperformable by the system 1000”. As described above, when both conditions A and B are satisfied, the controller 205 controls the system 1000 to be able to execute processes performable by the system 1000 among a plurality of processes necessary for the JDF job without canceling printing processing of the JDF job.

On the premise of this configuration, the controller 205 also executes the following exemplary control. For example, the target job is “not the non-JDF job but the JDF job”. In addition, the JDF job is “not a JDF job including no processing condition unperformable by the system 1000 but a JDF job including processing conditions unperformable by the system 1000”. As described above, when both conditions A and B are satisfied, the controller 205 allows the system 1000 to selectively execute the first processing to cancel printing processing of the JDF job by the system 1000, and the second processing to execute processes performable by the system 1000 among a plurality of processes necessary for the JDF job without canceling printing processing of the JDF job.

On the premise of this configuration, the controller 205 also executes the following exemplary control. For example, the target job is “not the non-JDF job but the JDF job”. That is, condition A is satisfied. However, this JDF job is “not a JDF job including processing conditions unperformable by the system 1000 but a JDF job including no processing condition unperformable by the system 1000”. This is defined as condition C. When both conditions A and C are satisfied, the controller 205 causes the system 1000 to execute printing processing of the JDF job.

On the premise of this configuration, the controller 205 also executes the following exemplary control. The controller 205 determines processing for the JDF job including processing conditions unperformable by the system 1000 on the basis of JDF job rule information stored in the HD 209. As a result, the controller 205 determines processing to be executed for a JDF job which satisfies both conditions A and B.

On the premise of this configuration, the controller 205 also executes the following exemplary control. The controller 205 allows the system 1000 to accept the non-JDF job while the printing apparatus 100 executes printing processing of the JDF job. Upon accepting the non-JDF job while the printing apparatus 100 executes printing processing of the JDF job, the controller 205 allows the system 1000 to execute printing processing of the non-JDF job upon completion of printing processing of the JDF job.

On the premise of this configuration, the controller 205 also executes the following exemplary control. The controller 205 executes control for the non-JDF job which is independent of control for the JDF job.

On the premise of this configuration, the controller 205 also executes the following exemplary control. The controller 205 determines processing for the non-JDF job including processing conditions unperformable by the system 1000 on the basis of non-JDF job rule information stored in the HD 209. As described above, the controller 205 allows the system 1000 to execute either cancellation processing of a non-exact match non-JDF job or contraction processing of a non-exact match non-JDF job on the basis of the non-JDF job rule.

On the premise of this configuration, the controller 205 also executes the following exemplary control. The controller 205 stores, in advance in the HD 209, JDF job rule information for determining processing for a JDF job including processing conditions unperformable by the system 1000. In addition, the controller 205 also stores, in advance in the HD 209, rule information for determining processing for a non-JDF job including processing conditions unperformable by the system 1000, so as to be distinctive of the JDF job rule information. The controller 205 controls the HD 209 to hold the contents of these pieces of rule information on the basis of setting information registered as the device settings of the system 1000 by the operator via the user interface unit (e.g., the operation unit 204) of the embodiments. Further, the controller 205 controls the HD 209 to be able to store print data of the JDF job and that of the non-JDF job. When the printing apparatus 100 is to print, the controller 205 controls the printing apparatus 100 to read out both print data of the JDF job and that of the non-JDF job from the HD 209 and print them by the printer unit 203.

In other words, the above-described configuration means that the system 1000 comprises the following illustrative configuration. For example, the controller 205 allows the system 1000 to accept, via the above-mentioned user interface unit of the embodiments, user settings necessary to determine processing for a JDF job including processing conditions unperformable by the system 1000. Based on the accepted user settings necessary to determine processing for a JDF job, the controller 205 determines whether to cancel or contract printing processing of the JDF job including processing conditions unperformable by the system 1000.

The embodiments incorporate a configuration having at least one of various building components described above.

The above-mentioned configuration can provide at least one of JDF job-associated effects described in the embodiments. The embodiments can solve problems arising from a JDF job, which have not been fully dealt with. In particular, the embodiments can contribute to practical application of a product capable of meeting future user needs in a printing environment such as the POD environment, which user needs are assumed when a printing apparatus or system is configured to be compatible with the JDF.

### Third Embodiment

The third embodiment according to the present invention will be described. The same reference numerals as those in the first and second embodiments denote the same parts, and a description thereof will not be repeated.

In the above-described embodiments, an operation to be performed when the printing apparatus (printing system) cannot completely execute an operation designated by a job ticket owing to the execution environment of the printing system 1000 can be selected in accordance with a user case the user of the printing system wants. The printing system can, therefore, deal with a variety of use forms demanded of the POD printing system. However, the operation to be performed when the printing apparatus or the like cannot completely execute an operation designated by a job ticket includes an operation of canceling the job, and an operation of ignoring an unperformable setting and continuing the processing. Factors which determine the execution environment of the printing system 1000 include the device performance, mounting accessories, and the like.

To the contrary, the third embodiment assumes an exemplary case where, when the printing apparatus (printing system) cannot completely execute an operation designated by a job ticket in executing a JDF job, execution of the job is reserved. In addition, the third embodiment further improves the convenience of the printing system.

(Outline of Operation)

An outline of the operation of a configuration according to the third embodiment will be described with reference to the accompanying drawings. As described above, a printing system 1000 according to the third embodiment includes a printing apparatus which performs printing processing on the basis of a print job. In this configuration, read processing is performed to read out, from a storage device (first storage means), a print job including a JDF part (condition information) representing printing conditions and a PDL part (description information) describing an image to be printed. Then, processing (first determination processing) is performed to analyze the JDF part included in the readout print job, and determine whether the printing apparatus can execute printing processing which satisfies printing conditions described in the JDF part. If it is determined in the determination processing that the printing apparatus cannot execute the printing processing, it is controlled to read out another print job from the storage device and start processing based on this print job. In this configuration, if it is turned out during analysis of a JDF part that processing of a print job cannot be executed, the process shifts to the next target print job without performing unnecessary processing such as rendering of a PDL part. This can increase the system productivity.

This operation will be further explained with reference to FIG. 23 which has already been referred to. In the configuration according to the third embodiment, when a print job as illustrated in FIG. 23 is input, it is determined by referring to a JDF part 3503 whether the print job can be executed in this configuration. If it is determined that no print job can be executed in this configuration, processing of the print job is reserved, and the next print job is processed. If it is determined that the print job can be executed in this configuration, a PDL file 1 3504 is rendered into image data. At this time, based on whether the image data matches the description of the JDF part 3503, it is determined whether printing processing can be executed based on the image data. If it is determined that no printing processing can be executed, processing of the print job is reserved, and the next print job is processed. If it is determined that printing processing can be executed, processing continues for the next PDL file (PDL file 2 3505). In this way, in the configuration according to the third embodiment, it is determined during processing whether printing processing of an input print job can be executed. If it is determined that no printing processing can be executed, processing of the print job is reserved, and the next print job is processed. The third embodiment can provide a technique capable of increasing the system productivity while suppressing an output result the user does not want.

An outline of the operation of the configuration according to the third embodiment when viewed from the user will be explained through a description of a window displayed on a touch panel unit 401 by the printing system 1000 and change of the window.

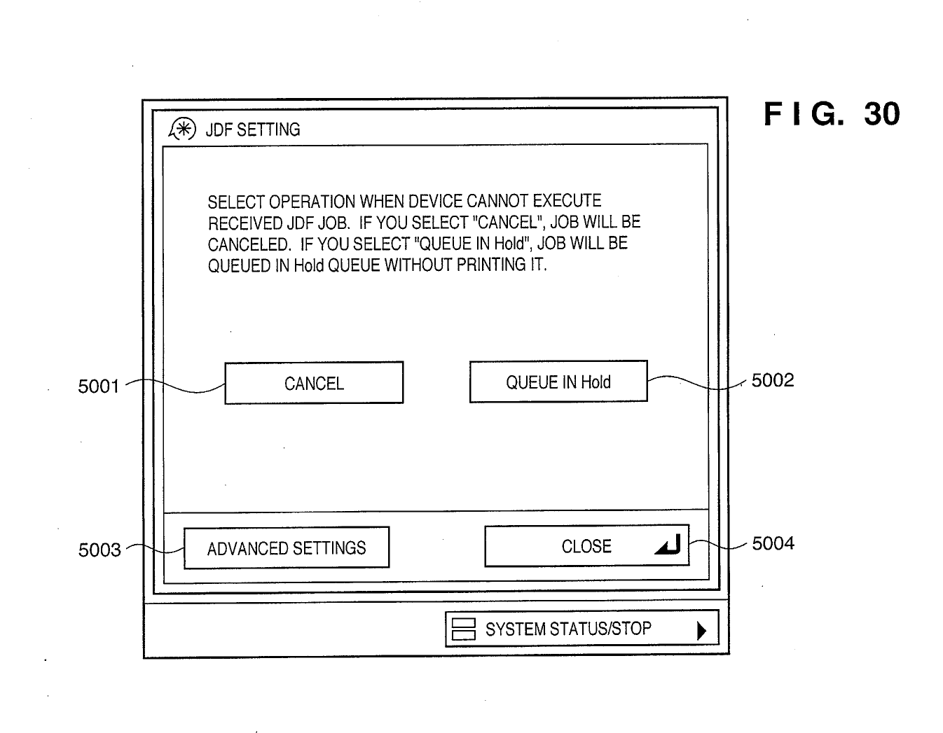

FIG. 30 is a view showing an example of a window displayed immediately after the user presses a JDF setting button in FIG. 24 referred to in the first embodiment in a system setup window displayed on the touch panel unit 401 under the control of a controller unit 205.

The window illustrated in FIG. 30 appears when a JDF job is transmitted to the printing system 1000 according to the third embodiment, and the controller unit 205 determines that the JDF job cannot be completely executed owing to the execution environment. This window prompts the user to select an operation to be performed by the printing system. The execution environment includes the device performance, mounting accessories, and the like.

Situations in which the printing system 1000 cannot completely execute an operation designated by a job ticket can be classified into the following two cases:

(1) a case where it is determined from settings described in a job ticket described in JDF that the device cannot execute a job.

(2) a case where it is determined from the print data (content data) analysis result and settings described in a job ticket that the device cannot execute a job.

In the former case, for example, the JDF designates stapling processing, but an apparatus capable of executing stapling processing is not mounted in the printing system 1000. In the latter case, for example, the JDF designates stapling the first to 100th pages of output materials, but print data include only 50 pages. These are merely examples for explaining the configuration and effects of the third embodiment, as a matter of course.

In FIG. 30, buttons 5001 and 5002 are used to select processing to be executed when the controller unit 205 determines that a JDF job input to the printing system 1000 cannot be completely executed owing to the execution environment. The cancel button 5001 is selected when the controller unit 205 determines that no input JDF job can be completely executed, and an operation to be performed by the printing system is job cancel processing. The “queue in Hold” button 5002 in FIG. 30 is selected when the controller unit 205 determines that no input JDF job can be completely executed, and an operation to be performed by the printing system is processing of queuing the job in a hold queue.

The hold queuing function is a function of storing, in an HDD 209, print data and setting information to be reflected in output materials in printing without performing printing processing when executing a JDF job input to the printing system 1000. That is, the hold queue (Hold, Hold queue, hold) means a storage device which temporarily stores print data, setting information, and the like. In a normal operation, a printer unit 203 performs printing processing under the control of the controller unit 205.

As for a job queued in the hold queue, JDF print setting conditions of the job upon inputting the job to the device can be changed via a job setting change window before performing printing processing. The controller unit 205 controls the job setting change window and displays it on an operation unit 204. This window permits the user to change the printing conditions of a job on the device even after the job is transmitted to the device. This function is provided to finally obtain an output material the user wants by repeating test printing. The job setting change window will be exemplified later.

A close button 5004 is used to instruct the controller unit 205 about display control of the UI unit to complete settings in the window shown in FIG. 30 and return again to the device setup window shown in FIG. 24. An advanced setting button 5003 is used to display and control, on the UI unit, a window for setting the advanced item of the JDF setting shown in FIG. 30.

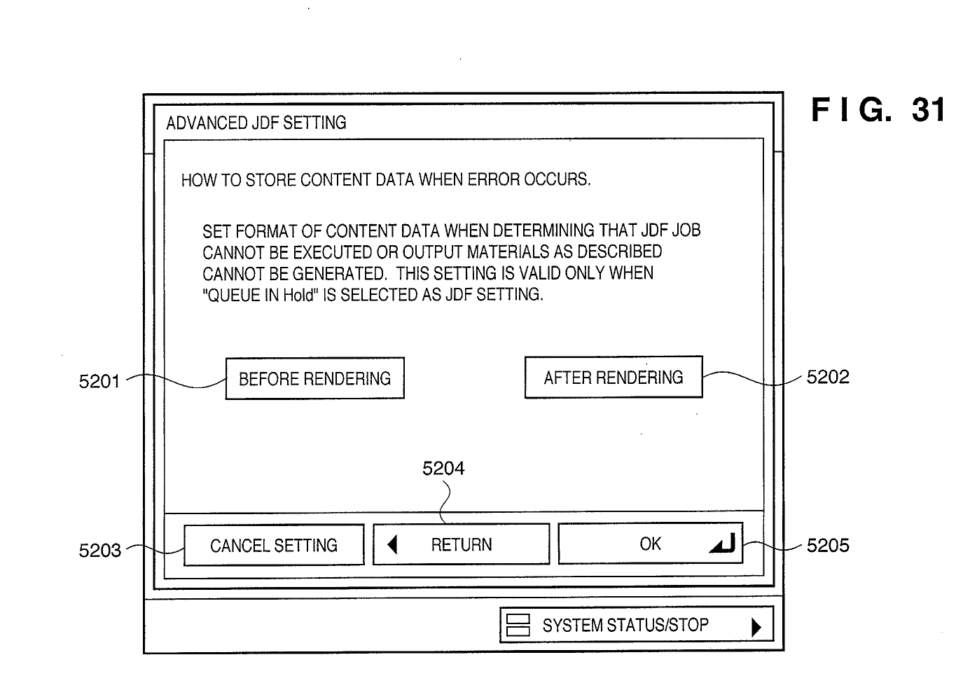

FIG. 31 is a view showing an example of a window displayed in response to press of the advanced setting button 5003 shown in FIG. 30 in the system setup window displayed on the touch panel unit 401 under the control of the controller unit 205. FIG. 31 illustrates a window which prompts the user to select an operation to be performed by the printing system 1000 when a JDF job is received and the controller unit 205 determines that no JDF job can be completely executed owing to the execution environment. More specifically, FIG. 31 illustrates a window which allows the user to select the save format of print data (content data) when an operation which is set in FIG. 30 and is to be performed when no JDF job can be completely executed is queuing in the Hold.

As shown in FIG. 31, two types of print data (content data) save formats are provided in this setup window, and can be selected. In FIG. 31, a pre-rendering button 5201 is selected to save print data (content data) in a format before rendering. This means that, when job data is transmitted to the printing system 1000, it is saved in the Hold in the format of content data. A post-rendering button 5202 is selected to save print data (content data) in the Hold in a format after rendering.

The format of data to be saved in the Hold when printing is unperformable can be selected by selecting either the pre-rendering button 5201 or post-rendering button 5202. The reason of this setting is that these two save formats have advantages and disadvantages contradictory to each other.

When the pre-rendering button 5201 is selected to save print data (content data) in the Hold in a data format before rendering, the data is stored before generating image information. Thus, the save format selected by the pre-rendering button 5201 has an advantage capable of changing settings, which are changeable by the print setting change function of the Hold, even for setting items concerning image generation. However, this save format has a disadvantage of prolonging the time until an output material is generated upon reception of a print instruction because data needs to be rendered when printing it from the Hold.

In contrast, when the post-rendering button 5202 is selected to save print data (content data) in the Hold in a format after rendering, this format has an advantage and disadvantage contradictory to those when the pre-rendering button 5201 is selected to store print data in the Hold. That is, data is stored after generating image information. The print data has already been rendered upon reception of a print instruction in the Hold state, so the time till the completion of printing is shorter than that in a case where print data is saved in a data format before rendering. However, since the print data has already been converted into image information and is saved in the Hold, settings changeable by the print setting change function of the Hold are limited. For example, setting information applied when generating an image from print data cannot be changed because the settings have already been applied.

In this fashion, the formats of data saved in the Hold when printing is unperformable have advantages and disadvantages. For this reason, the configuration according to the third embodiment allows the user to select the data format in accordance with the application purpose.

The functions of the remaining buttons in FIG. 31 will be explained. A setting cancel button 5203 is used to instruct the controller unit 205 to end setting processing in the advanced JDF setting window in FIG. 31, discard the contents of settings made by the user, and restore the display on the touch panel unit 401 to the basic window shown in FIG. 6. A return button 5204 is used to instruct the controller unit 205 to end the window display in FIG. 31 on the touch panel unit 401, and return to the window shown in FIG. 30. An OK button 5205 is used to instruct the controller unit 205 to complete settings in the window shown in FIG. 31, control the display on the UI unit, and return again to the device setup window shown in FIG. 24.

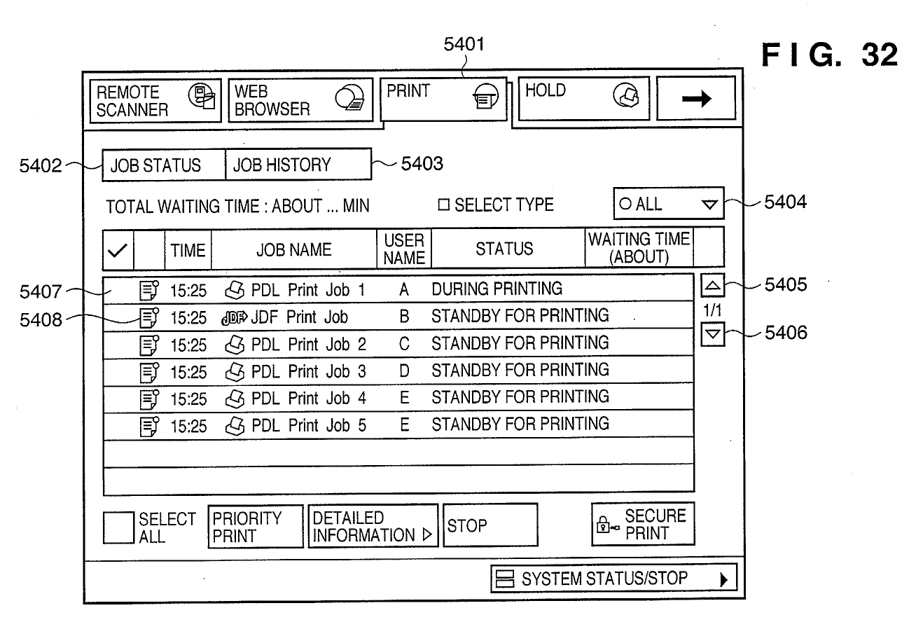

FIG. 32 is a view showing an example of a print job status confirmation window displayed on the touch panel unit 401 of the printing system 1000, in order to explain the configuration and effects of the third embodiment. The controller unit 205 executes display processing on the touch panel unit 401 in FIG. 32, and prompts the user to perform an operation and the like.

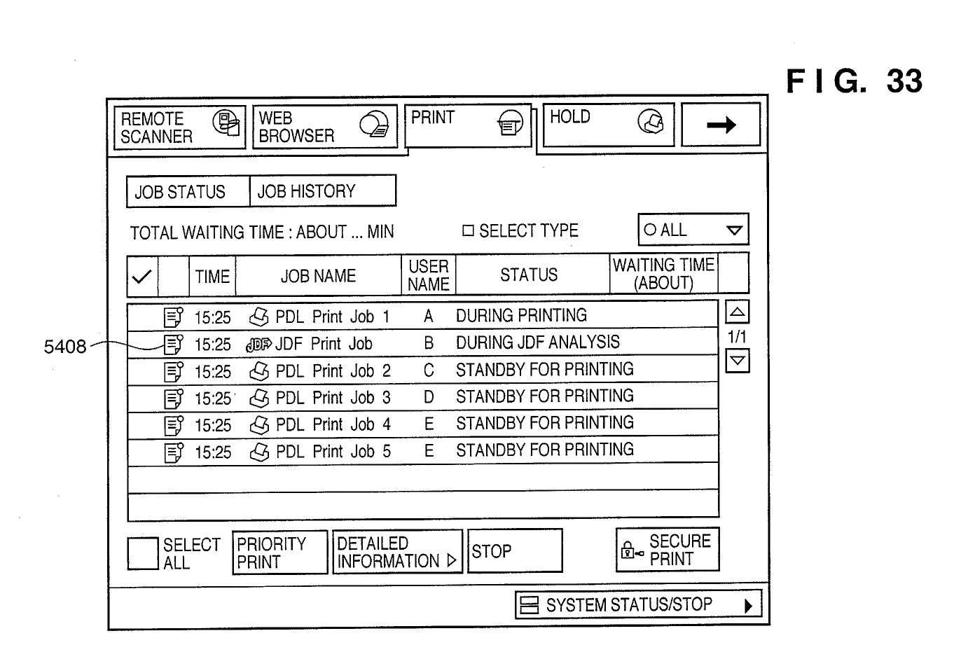

In order to explain the configuration and effects of the third embodiment, important part of display information and operation button functions in the print job status confirmation window shown in FIG. 32 will be described. A description of common buttons and display information in FIGS. 33 to 38 to be described below is common to the following description of FIG. 32, and will not be repeated.

A print tab 5401 is used to instruct the controller unit 205 to display the print job status confirmation window shown in FIG. 32 on the touch panel unit 401. In FIG. 32, tabs corresponding to various functions except the print tab are displayed in FIG. 32. However, a detailed description of these tabs is not essential to a description of the configuration and effects of the third embodiment, and will be omitted. Various function tabs are displayed at the top of the window even while another function tab is selected (the print tab is selected in FIG. 32). Hence, even while a given function tab is selected, the user can select another function tab and execute an operation based on the selected function tab.

A job status button 5402 is used to instruct the controller unit 205 to display a list of print jobs queued in the printing system 1000 and a list of pieces of detailed information of the jobs. In the example of FIG. 32, the color of the job status button 5402 is highlighted to represent that the button 5402 is selected. A job history button 5403 is used to instruct the controller unit 205 to display the processing history of print jobs having undergone any processes in the printing system 1000.

A job list 5407 is a window area where the job list is displayed while the job status button 5402 is selected. As shown in FIG. 32, items displayed in the job list 5407 as detailed information of a print job include the job acceptance time, job name, user name, job execution status, and the like. As shown in FIG. 32, an icon (mark) is displayed at the head of the job name character string in the job name field. The icon type allows the user to easily identify the type of job. In the state of the job list 5407 in FIG. 32, for example, the icons of the first and second jobs are different. The icon of the first job represents that the type of job is a normal PDL print job. The icon of the second job represents that the type of job is a JDF print job. In the state shown in FIG. 32, a total of six print jobs are input. Of these jobs, the second job is a JDF print job, and all the remaining jobs are PDL print jobs. The first PDL print job is during printing, and the printing system 1000 is currently printing out this job in the state shown in FIG. 32. The second and subsequent jobs stand by for printing. The printing system 1000 has already received these jobs, but has not started processing them.

An up scroll button 5405 and down scroll button 5406 are used when no entire job list can be displayed in the window area of the job list 5407 while a plurality of jobs are input to the printing system 1000. Images representing up and down arrows are displayed in these buttons. By selecting either arrow image, the job list display can be moved in the direction indicated by the arrow. In the example of FIG. 32, all jobs can be displayed in the job list 5407, so these scroll buttons are grayed out and cannot be selected. The controller unit 205 controls the display operation of the job list 5407 with the up scroll button 5405 and down scroll button 5406, gray-out processing of the scroll buttons, and the like.

A filter button 5404 is used to restrict jobs to be displayed in the job list 5407. In the example of FIG. 32, all jobs are selected (“all” is selected), and a list of all types of print jobs input to the printing system 1000 is displayed. When the user issues an instruction to display only a specific type of job, only a list of jobs of the specific type is displayed, and other types of jobs are not displayed in the job list 5407. This function becomes valid when many jobs are input to the printing system 1000 and the user wants to display only the status of a specific type of job.

A second job 5408 displayed in the job list 5407 is a JDF job. This job will be repetitively referred to in order to explain, with reference to FIG. 33 and subsequent drawings, control by the controller unit 205 on the basis of settings shown in FIGS. 30 and 31 when executing a JDF job in the printing system 1000. That is, a case where processing of the second job 5408 is executed will be exemplified. In FIG. 32, the second job 5408 stands by for printing. In other words, the printing system 1000 has received the job ticket and print data of the second job 5408, but has not started analysis processing of them, and the like.

[Operation Example of Job List When Execution of JDF Job Normally Ends]

FIG. 33 is a view showing an example of the print job status confirmation window when the job execution status changes from the job status of the printing system 1000 shown in FIG. 32 upon the lapse of time. The difference of the window in FIG. 33 from that illustrated in FIG. 32 is that the job status of the second job 5408 changes from “standby for printing” to “during JDF analysis”.

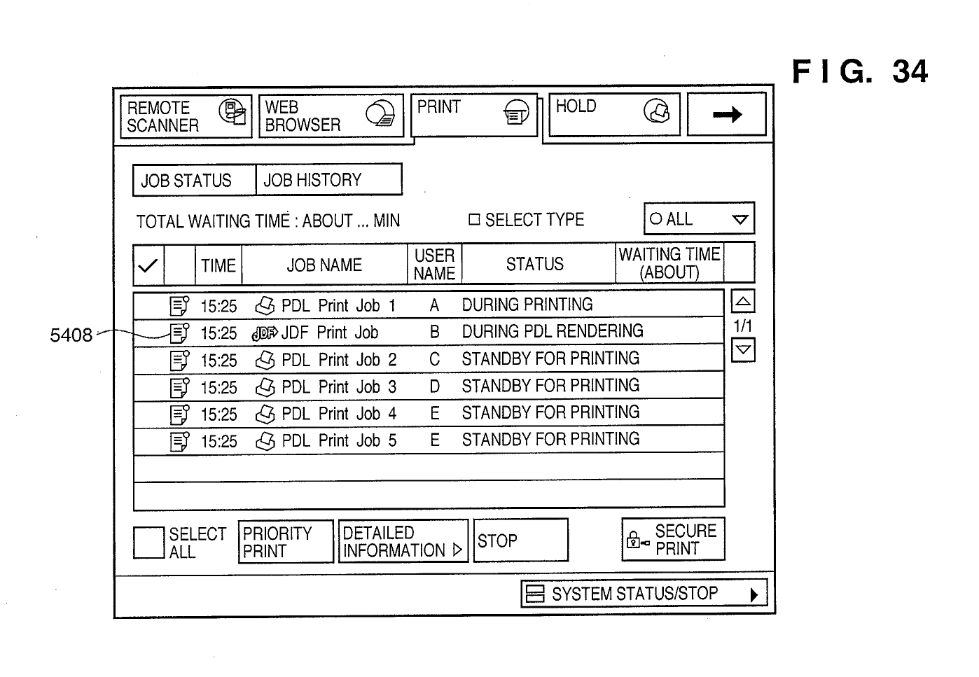

FIG. 34 is a view showing an example of the print job status confirmation window when the processing further progresses, and the job execution status changes from the job status of the printing system 1000 shown in FIG. 33. The difference of the window in FIG. 34 from that illustrated in FIG. 33 is that the job status of the second job 5408 changes from “during JDF analysis” to “during PDL rendering”. This represents that JDF analysis processing normally ends, and the controller unit 205 starts print data (content data) analysis processing which is the next processing of the JDF job.

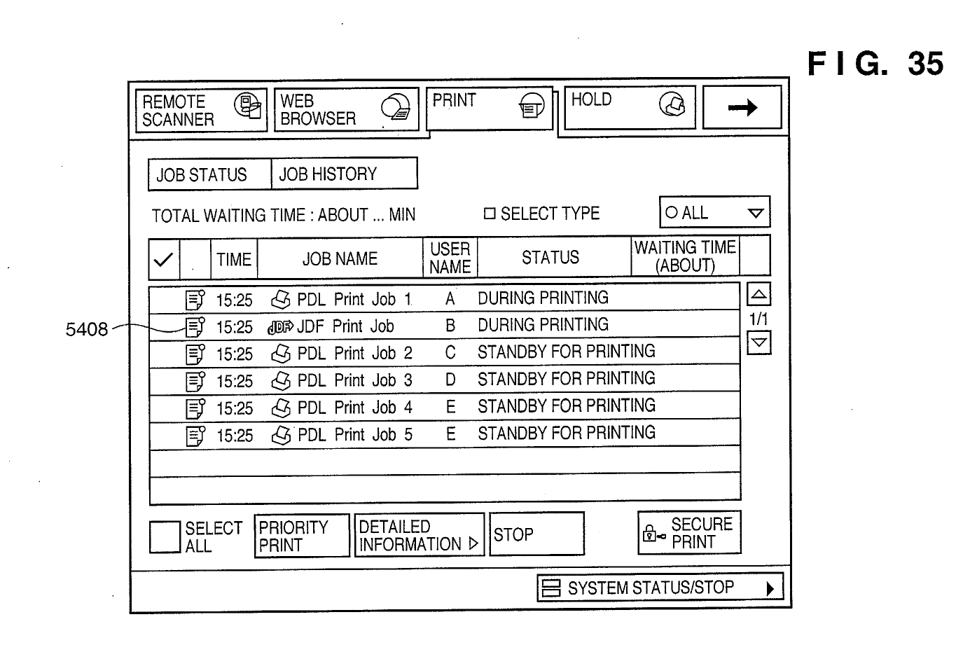

FIG. 35 is a view showing an example of the print job status confirmation window when the processing further progresses, and the job execution status changes from the job status of the printing system 1000 shown in FIG. 34. The difference of the window in FIG. 35 from that illustrated in FIG. 34 is that the job status of the second job 5408 changes from “during PDL rendering” to “during printing”.

This represents that both JDF analysis processing and print data (content data) analysis processing normally end, and the controller unit 205 starts printing processing which is the next processing step of the JDF job. Since the JDF analysis and print data analysis end, it is turned out that the input JDF job can be executed in the printing system 1000.

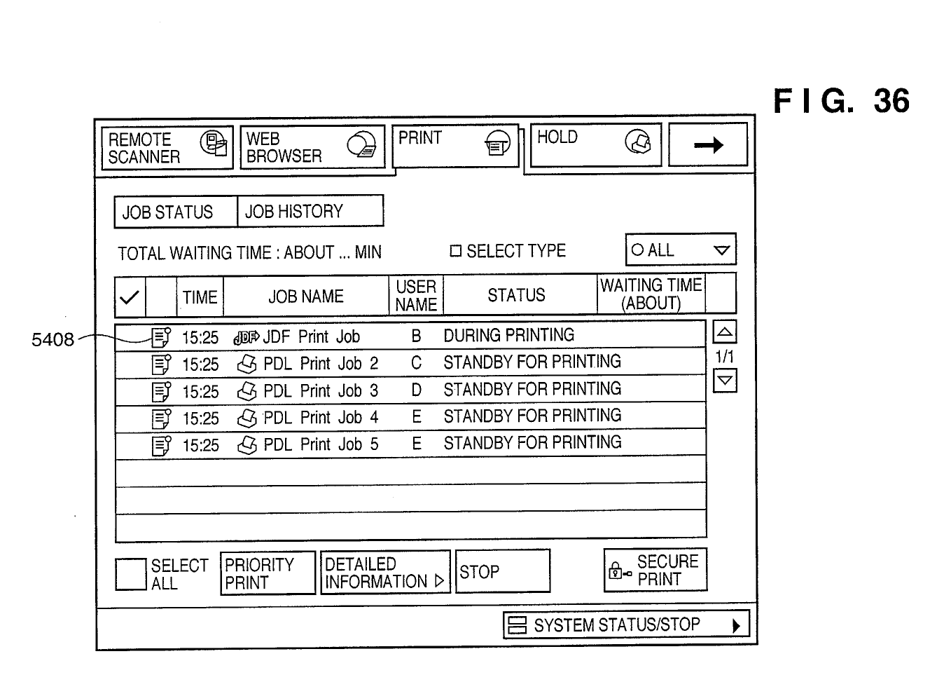

FIG. 36 is a view showing an example of the print job status confirmation window when the processing further progresses, and the job execution status changes from the job status of the printing system 1000 shown in FIG. 35. The difference of the window in FIG. 36 from that illustrated in FIG. 35 is that execution of the first job in FIG. 35 ends, the entry of the job disappears from the job list 5407, and as a result, the JDF job 5408 moves to the top of the job list. The job status of the JDF job 5408 in FIG. 36 is still “during printing”, and has not changed from the status in FIG. 35.

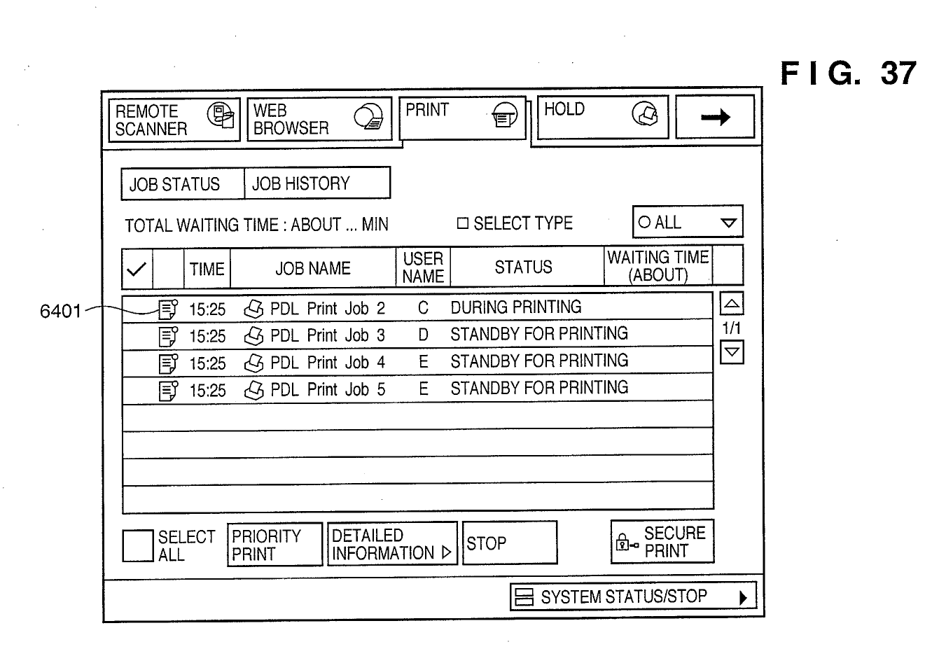

FIG. 37 is a view showing an example of the print job status confirmation window when the processing further progresses, and the job execution status changes from the job status of the printing system 1000 shown in FIG. 36. The difference of the window in FIG. 37 from that illustrated in FIG. 36 is that the entry of the JDF job 5408 of interest disappears from the job list 5407 in response to the end of printing processing of the JDF job. After the entry of the JDF job 5408 disappears, a subsequent job, i.e., a job 6401 of a job name “PDL Print Job 2” in the example of FIG. 37 changes to the execution state.

The operation of a normal JDF job when JDF analysis and print data (content data) analysis are successful and printing processing of the JDF job is normally complete has been described.

### OPERATION EXAMPLE (1) OF JOB LIST WHEN EXECUTION OF JDF JOB ABNORMALLY ENDS

An operation when execution of a JDF job abnormally ends will be explained. The execution abnormally ends when the JDF part of a JDF job is invalid or it is determined from the results of content data analysis and JDF part analysis that execution of the job cannot be continued. As an example of the operation when execution of a JDF job abnormally ends, a case where an operation to be performed when a JDF job ends upon occurrence of an error is job cancellation will be described.

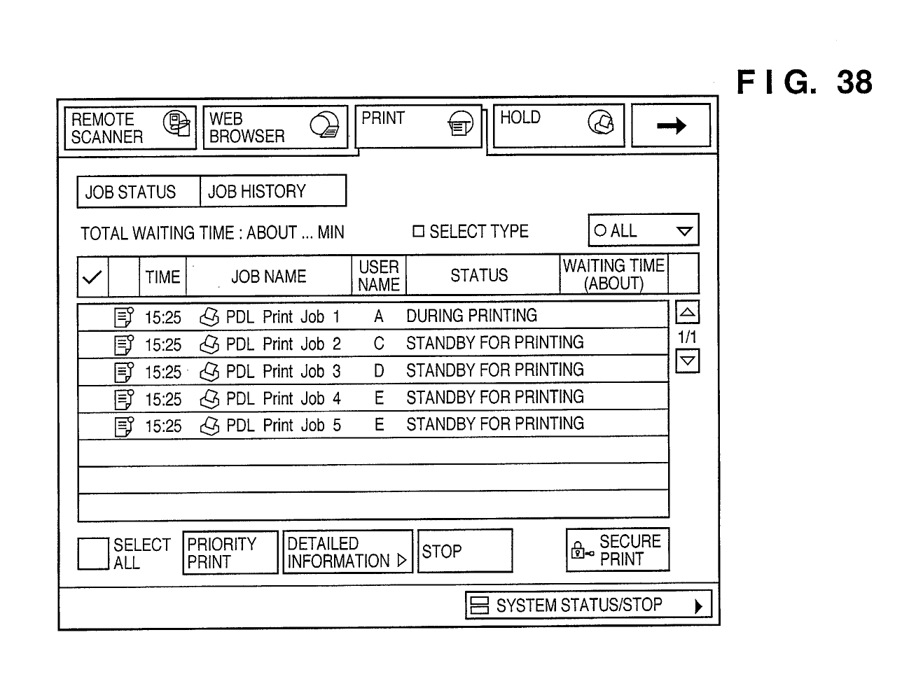

In a description of the configuration and effects of the third embodiment with reference to FIG. 38, assume that job execution processing is done in the printing system 1000 while the cancel button 5001 is selected in the JDF setup window of FIG. 30. Also in the following description, assume that the JDF part of an input JDF job is invalid.

FIG. 38 is a view showing an example of the print job status confirmation window. Assume that, while the cancel button is selected in the JDF setup window of FIG. 33, a JDF job is input to the printing system 1000, and the JDF part of the JDF job includes an invalid setting which inhibits execution of the job. FIG. 38 illustrates the print job status confirmation window when the processing further progresses, and the job execution status changes from the job status of the printing system 1000 shown in FIG. 33.

In FIG. 33, the JDF job 5408 undergoes JDF analysis. As a result of the JDF analysis, if the JDF part includes an invalid setting which inhibits execution of the job, the JDF job is processed in accordance with an operation set by the user of the printing system 1000 via the window shown in FIG. 30. In the situation assumed in the description of FIG. 38, the user has selected job cancellation, so the JDF job 5408 is canceled. Consequently, the entry of the JDF job disappears from the job list shown in FIG. 38.

This description assumes that the JDF part is invalid. In another case, the JDF part is not invalid, but it is determined from the results of print data (content data) analysis and JDF part analysis that printing processing of a JDF job cannot be executed. A concrete example of this situation has been described above, and a description thereof will not be repeated. In this case, the job list status shown in FIG. 34 changes to one shown in FIG. 38. In other words, in this situation, after a JDF job changes from “during JDF rendering” to “during PDL rendering”, the job is canceled, and the job list status changes to one illustrated in FIG. 38.

### OPERATION EXAMPLE (2) OF JOB LIST WHEN EXECUTION OF JDF JOB ABNORMALLY ENDS

Another operation when execution of a JDF job abnormally ends will be explained. As another operation when the execution abnormally ends, a case where an operation to be performed when a JDF job ends upon occurrence of an error is queuing in the Hold will be described. In a description of the configuration and effects of the third embodiment, assume that job execution processing is done in the printing system 1000 while the “queue in Hold” button 5002 is selected in the JDF setup window of FIG. 30. Also in the description of the configuration and effects of the third embodiment, assume that the JDF part of an input JDF job is invalid.

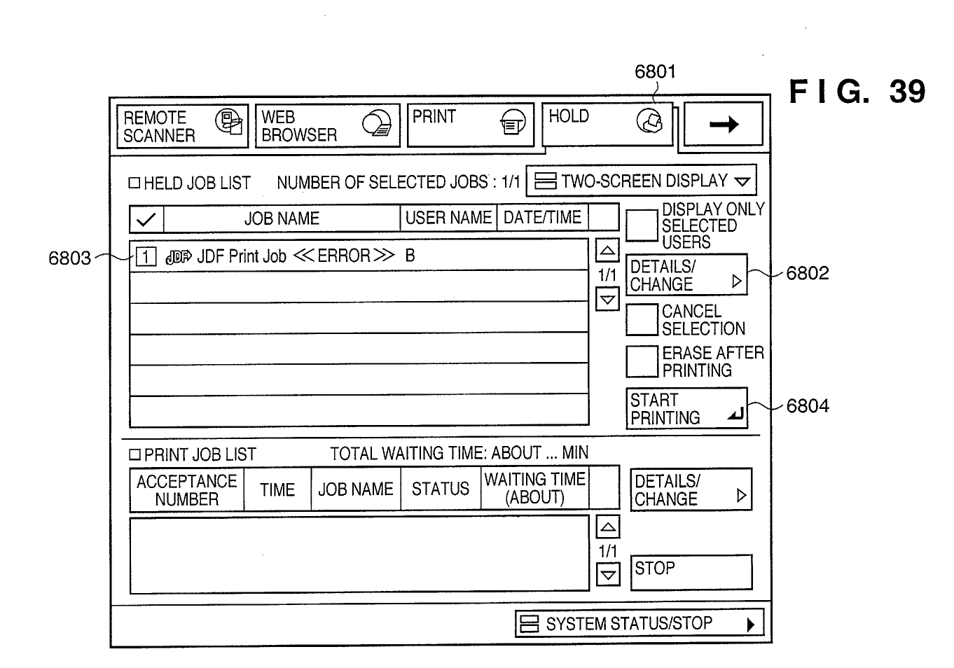

FIG. 39 is a view showing an example of a hold window when a job is queued in the hold queue. A window as shown in FIG. 39 appears when a JDF job is input to the printing system 1000 and includes an unprintable setting or data while the “queue in Hold” button 5002 is selected in the JDF setup window (FIG. 30).

When the user presses a hold tab 6801, the hold window appears on the touch panel unit 401 under the control of the controller unit 205. The hold function provided in the printing system 1000 includes many functions, and allows various settings via the hold window. However, the third embodiment will describe only minimum functions necessary to explain the configuration and effects of the third embodiment.

A held job list is an area where a list of jobs queued in the hold queue of the printing system 1000 is displayed. In the example of FIG. 39, only one JDF print job 6803 is queued. This represents a state in which, while the “queue in Hold” button 5002 is selected, a JDF job including an unprintable setting or data is input and queued in the hold queue without performing printing processing. In the example of FIG. 39, the job list has only one job. When a plurality of jobs are queued in the hold queue, they are displayed. In the example of FIG. 39, the background color of the job field in the job list is highlighted to represent that this job is selected.

A print start button 6804 is used to cause the controller unit 205 to execute printing processing of a selected job. Since the job 6803 includes invalid data, no printing processing can be executed from the hold tab even by pressing the print start button 6804. To print the job 6803, the setting of the selected job needs to be changed to a printable state with a details/change button 6802. A detailed description of setting change processing using the details/change button 6802 is not essential to a description of the configuration and effects of the third embodiment, and will be omitted.

In FIG. 39, a description <<ERROR>> is displayed on the right side of the job name of the selected job 6803. This information is added when the controller unit 205 determines as a result of executing the JDF job by the printing system 1000 that the input JDF job includes an unprintable setting and data. This information allows the user to determine whether printing processing of a job queued in the hold can be started with the print start button 6804, or the settings need to be changed with the details/change button 6802.

As described above, as for a JDF job, the JDF part of transmitted job data is analyzed first. At this time, if it is determined that no job can be executed in accordance with the contents described in the JDF, printing processing of the job can be reserved. If the analysis result of JDF part is normal, but it is determined from a subsequent comparison between the results of print data (content data) analysis and JDF analysis that printing processing cannot be executed, printing processing of the job can also be reserved. Thus, in the configuration according to the third embodiment, whether a JDF job can be executed can be detected at a plurality of points in the initial stage of processing throughout the entire execution process of the JDF job. As features of the configuration according to the third embodiment, execution of a JDF job is reserved in a plurality of stages, and the user can select an operation to be performed when the JDF job is reserved.

As described in Description of the Related Art, the printing apparatus (printing system) may not be able to completely execute an operation designated by the job ticket of a JDF job owing to the execution environment (device performance, mounting accessories, and the like). In this situation, execution of an invalid JDF job is reserved as quickly as possible, and a subsequent job is executed. This can increase the rate of operation and productivity of the printing system 1000.

(Print Job Acceptance Processing)

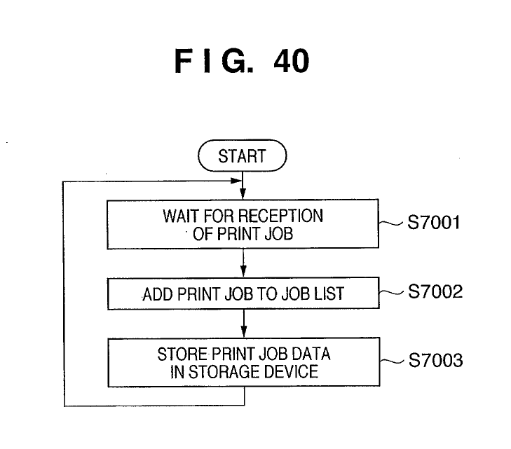

The operation of the printing system 1000 under the control of the controller unit 205 in the third embodiment will be described with reference to FIG. 40. FIG. 40 is a flowchart showing the sequence of print job acceptance processing in print job execution control performed by the controller unit 205 in FIG. 2 in the printing system 1000. While the controller unit 205 in the printing system 1000 is active, it accepts a print execution request from a PC 103 or 104 or the like present in a POD system 10000 in FIG. 1. In other words, the printing system 1000 always waits for a job during power-on.

In step S7001, a print execution request from the PC 103 or 104 or the like present in the POD system 10000 is waited. The process stands by in step S7001 until job data is externally received. If the controller unit 205 detects a printing from the PC 103 or 104 or the like present in the POD system 10000, the process proceeds to step S7002.

In step S7002, the detected/received job is added to a job list managed by the controller unit 205. The job list is managed by the controller unit 205 and held in a RAM 208.

In step S7003, the controller unit stores the received job data in a storage device such as the HDD 209. Upon completion of this processing, the process returns to step S7001 again to wait for reception of a print job.

(Basic Processing)

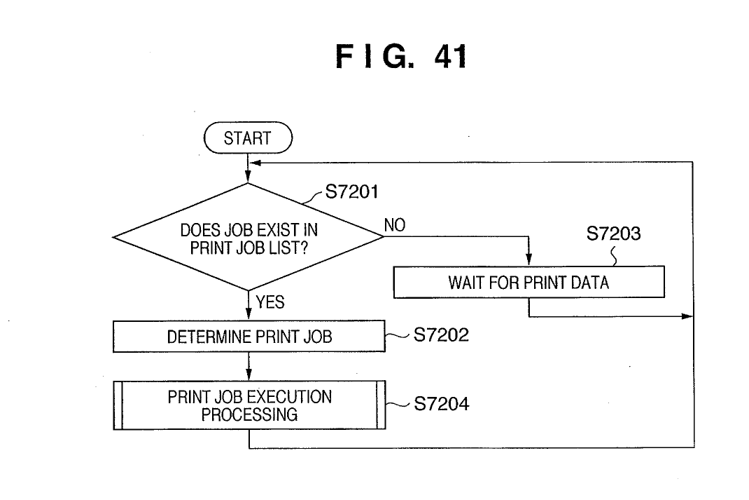

The operation of the main sequence (basic processing) of print job execution in print job execution control performed by the controller unit 205 in FIG. 2 in the printing system 1000 will be described with reference to FIG. 41. FIG. 41 is a flowchart showing the main sequence of print job execution.

In step S7201, a job list which is managed by the controller unit 205 and held in the RAM 208 is checked to determine whether a print job exists. If it is determined in step S7201 that a print job exists (YES in step S7201), the process proceeds to step S7202.

In step S7202, a target print job is determined. The job determined in step S7202 is generally a job at the top of the job list. However, the job to be executed may also be determined based on another criterion. For example, the job execution order may also be determined in the descending order of job priority. Needless to say, any criterion may be used to select a job to be executed next.

If a job to be executed next is determined in step S7202, processing of the job is executed in step S7204. Details of print job execution processing in step S7202 will be described later. Upon completion of the processing in step S7204, the process returns to step S7201 again. The process from steps S7201 to S7204 is looped and repeated as long as a job exists in the job list.

If it is determined in step S7201 that no print job exists in the job list which is managed by the controller unit 205 and held in the RAM 208 (NO in step S7201), the process proceeds to step S7203. In step S7203, the process waits until print data is received. The timing when the process changes from the standby state in step S7203 is the same timing when the process changes from step S7001 shown in FIG. 40. After the end of the processing in step S7203, the process proceeds to step S7201, and the controller unit 205 executes the printing processing sequence in steps S7201 to S7204 described above.

(Print Job Execution Processing)

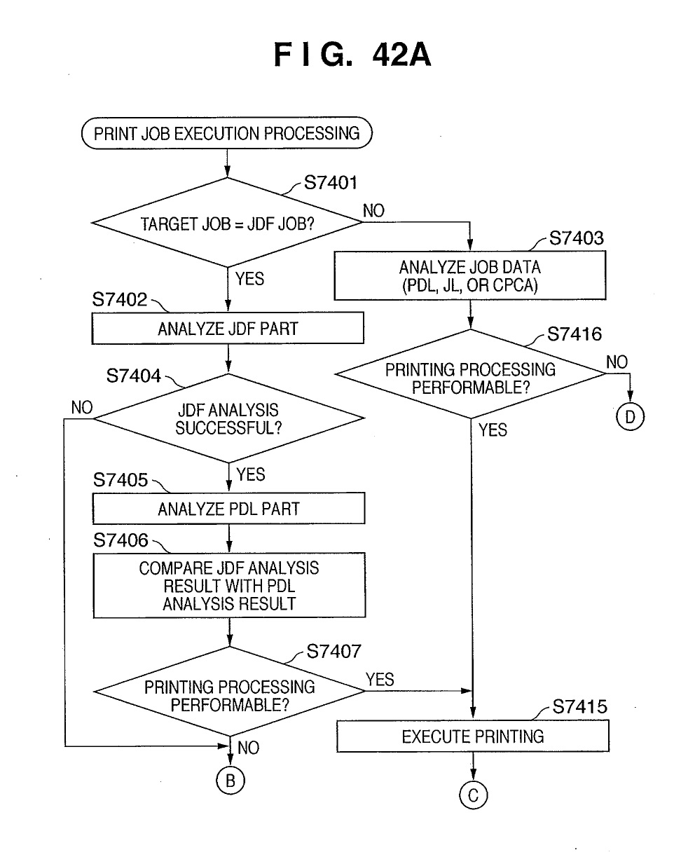

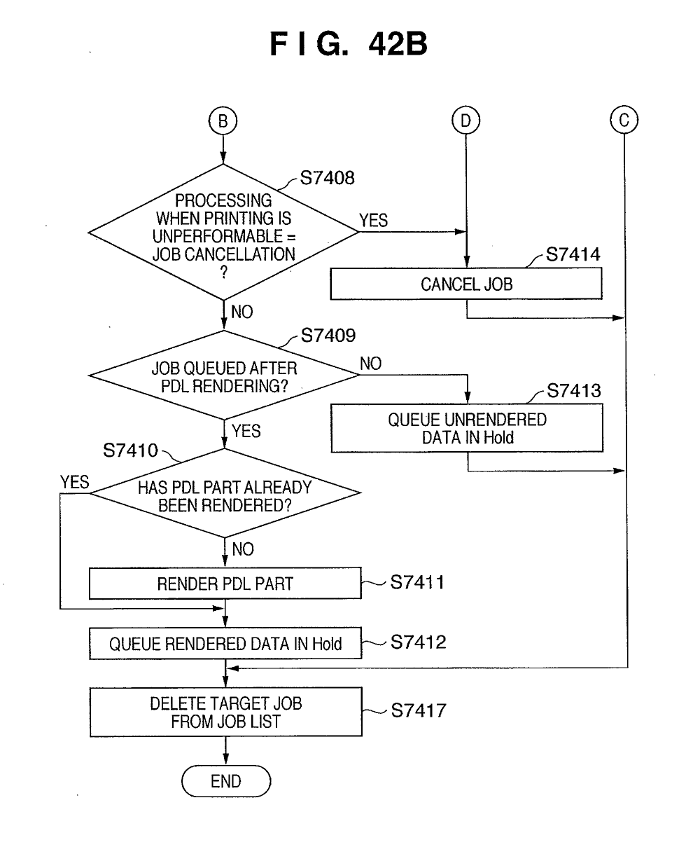

Details of print job execution processing in step S7204 shown in FIG. 41 in print job execution control performed by the controller unit 205 in FIG. 2 in the printing system 1000 will be described with reference to FIGS. 42A and 42B. FIGS. 42A and 42B are flowcharts showing the detailed sequence of print job execution processing.

In step S7401, it is determined whether the job to be executed is a JDF job or a normal PDL print job. If it is determined that the job to be executed is a JDF job (YES in step S7401), the process proceeds to step S7402.

In step S7402, the controller unit 205 analyzes the JDF part of JDF job data which is received by the printing system 1000 and stored in the HDD 209. After the end of the processing in step S7402, the process proceeds to step S7404.

In step S7404, the result of JDF part analysis processing executed in step S7402 is determined. Based on setting information described in the JDF part as a result of the analysis processing in step S7402, it is determined whether the JDF print job can be executed in the printing system 1000. If it is determined in step S7404 that the JDF print job can be executed in the printing system 1000 (YES in step S7404), the process proceeds to step S7405. If it is determined that no JDF print job can be executed in the printing system 1000 (NO in step S7404), the process proceeds to step S7408.

In step S7405, the controller unit 205 analyzes the print data (content data) of the JDF job data which is received by the printing system 1000 and stored in the HDD 209. Concrete contents of the processing in step S7405 include PDL data rendering processing and the like. Upon completion of the processing in step S7405, the process proceeds to step S7406.

In step S7406, the result of JDF analysis executed in step S7402 is compared with the result of PDL data rendering processing executed in step S7406, and it is determined whether printing processing can be executed based on the received JDF job data. This determination processing is executed by determining based on settings designated in the JDF whether printing processing of the rendered print data (content data) can be executed.

Assume that the JDF designates stapling the first to 100th pages, but print data (content data) include only 50 pages. In this situation, output materials described in the JDF cannot be generated. In this case, it is determined that no JDF job can be executed. Similarly, as for another condition, it is determined in step S7406 based on setting information described in the JDF whether printing processing of print data (content data) can be executed. Although the conditions of various determination processes will not be listed, the determination in step S7406 may be concerned with any condition. After the end of the processing in step S7406, the process proceeds to step S7407.

In step S7407, it is determined based on the result of determination in step S7406 whether printing processing of the JDF job can be continued. If it is determined that printing processing can be executed (YES in step S7407), the process proceeds to step S7415, and the controller unit 205 executes printing processing of the job. If it is determined that no printing processing can be executed (NO in step S7407), the process proceeds to step S7408.

Up to this processing, whether to continue printing processing of the JDF job has been determined twice in steps S7402 and S7407. By these two determinations, whether execution of the JDF job can be continued can be determined in the initial stage of job execution processing. More specifically, if it is determined that no JDF job can be executed, execution of the job can be reserved quickly to quicken the timing to start executing a subsequent job.

In step S7408, it is determined whether the operation of the printing system 1000 when it is determined that no print JDF job can be executed is cancellation processing of the job. The user makes the setting subjected to this determination via the window illustrated in FIG. 30 under the control of the controller unit 205. The setting result in the window illustrated in FIG. 30 is stored in the RAM 208 by the controller unit 205.

If it is determined in step S7408 that the operation of the printing system 1000 when it is determined that no print JDF job can be executed is cancellation processing of the job (YES in step S7408), the process proceeds to step S7414. In step S7414, the controller unit 205 cancels the job.

If it is determined that the operation of the printing system 1000 when it is determined that no print JDF job can be executed is not cancellation processing of the job, this means that an operation to queue the job in the Hold is selected in the window shown in FIG. 30. Hence, if it is determined in step S7408 that the operation of the printing system 1000 when it is determined that no print JDF job can be executed is not cancellation processing of the job (NO in step S7408), the process proceeds to step S7409.

In step S7409, the controller unit 205 determines a setting selected as a content data storage method upon occurrence of an error that has been described with reference to FIG. 31. Since the setting in FIG. 31 is also stored in the RAM 208 in FIG. 2, the controller unit 205 reads out the setting from the RAM 208 and refers to it in step S7409.

If it is determined in step S7409 that the user has selected in FIG. 31 a setting to queue a job in a format before rendering (NO in step S7409), the process proceeds to step S7413. In step S7413, unanalyzed print data (content data) of the JDF job is queued in the Hold.

If it is determined in step S7409 that the user has selected in FIG. 31 a setting of queuing a job in a format after rendering (YES in step S7409), the process proceeds to step S7410.

In step S7410, it is determined whether there is rendered print data (content data) to be queued in the Hold. In other words, it is determined whether the print data (content data) has already been rendered. This step is necessary because the process reaches step S7410 in two ways: a case where it is determined in step S7404 that no JDF job can be executed, and a case where it is determined in step S7407 that no JDF job can be executed.

If it is determined in step S7407 that no JDF job can be executed, print data (content data) has already been rendered in step S7405 before step S7407. If it is determined in step S7404 that no JDF job can be executed, print data (content data) has not been rendered yet. For this reason, it is determined in step S7410 whether there is rendered print data. If there is no rendered print data (NO in step S7410), the process proceeds to step S7411. In step S7411, the controller unit 205 renders the print data (content data). The processing in step S7411 is the same as PDL data rendering processing in step S7405. Upon completion of the print data (content data) rendering processing in step S7411, the rendered print data is queued in the Hold in step S7412.

If it is determined in step S7410 that there is rendered print data (content data) to be queued in the Hold (YES in step S7410), the process proceeds to step S7412. In step S7412, the rendered print data is queued in the Hold.

The sequence of JDF job printing processing controlled and executed by the controller unit 205 has been described. A processing sequence controlled and executed by the controller unit 205 for a print job other than a JDF job, i.e., a normal PDL print job will be explained.

If it is determined in step S7401 that the job to be executed is not a JDF job (NO in step S7401), the process proceeds to step S7403. In step S7403 and subsequent steps, printing processing of the PDL print job is executed. More specifically, the process proceeds to step S7403, and the controller unit 205 analyzes the PDL print job data which is received by the printing system 1000 and stored in the HDD 209.

Then, the process proceeds to step S7416, and the controller unit 205 determines whether the PDL print job analyzed in step S7403 can be executed in the printing system 1000. If it is determined that the PDL print job can be executed (YES in step S7416), the process proceeds to step S7415 to execute printing processing of the job. If it is determined that no PDL print job can be executed (NO in step S7416), the process proceeds to step S7414 to execute cancellation processing of the job.

After the end of the processes in steps S7412, S7413, S7414, and S7415, the process proceeds to step S7417 to delete the processed job from the job list managed by the controller unit 205.

The detailed sequence of print job execution in step S7204 shown in FIG. 41 in print job execution control performed by the controller unit 205 in FIG. 2 in the printing system 1000 has been described.

As described above, in the configuration according to the third embodiment, it is determined during processing whether printing processing of an input print job can be executed. If it is determined that no printing processing can be executed, processing of the print job is reserved, and the next print job is processed. The third embodiment can provide a technique capable of increasing the system productivity while suppressing an output result the user does not want.

In the configuration according to the third embodiment, any one of the following processes is executed when it is determined that no input print job can be executed:

cancellation of printing processing based on a print job

storage control of a print job in a storage device (second storage means)

storage control of image data obtained based on a print job in a storage device.

The third embodiment can, therefore, provide a technique capable of performing proper printing processing without any cumbersome user operation in a configuration in which the system operates based on a print job (e.g., JDF job) describing printing conditions in a specific format.

In the configuration according to the third embodiment, the system performs processing of accepting, from the user, the setting of processing to be performed when it is determined that no input print job can be executed. When it is determined that no print job can be executed, the set processing is executed. The user can freely set appropriate processing by a simple operation.

In the configuration according to the third embodiment, a PDL print job (second print job) including a PDL part (description information) describing an image to be printed is read out from a storage device, and the PDL part included in the readout PDL print job is rendered into image data. Then, processing (third determination processing) is performed to determine whether the printing apparatus can execute printing processing based on the image data. If it is determined in this determination that the printing apparatus cannot execute the printing processing, either cancellation of the printing processing based on the print job or storage control of the image data in the storage device is executed. According to the configuration of the third embodiment, proper processing can be done in accordance with the type of job. Hence, the third embodiment provides a technique capable of improving the job processing productivity of the overall system, the device use efficiency, the device convenience, and the operability of the operator in a configuration in which printing processing is performed based on various types of jobs such as a JDF job and non-JDF job.

### Other Embodiments

The embodiments of the present invention have been described in detail. The present invention can take embodiments of a system, apparatus, method, program, storage medium, and the like. More specifically, the present invention may also be applied to a system including a plurality of devices, or an apparatus formed by a single device.

A host computer (e.g., the PC 103 or 104) may use an externally installed program to achieve the functions shown in the drawings. In this case, the host computer can externally install data for displaying the same operation windows as those described in the embodiments including operation windows, and provide various user interface windows on the display of the host computer. An example of this operation has been described using the configuration of the UI window in FIG. 17. In this configuration, the present invention is applied to even a case where pieces of information including programs are supplied to an output device from a storage device such as a CD-ROM, flash memory, or FD, or from an external storage medium via a network.

The present invention is also achieved by supplying a program for implementing the functions of the above-described embodiments to a system or apparatus directly or from a remote place, and reading out and executing the supplied program codes by the computer of the system or apparatus.

Hence, the program codes installed in the computer to implement functional processing of the present invention by the computer also fall within the technical scope of the present invention. That is, the present invention also includes the computer program for implementing functional processing of the present invention.

In this case, the program may take the form of an object code, a program executed by an interpreter, or script data supplied to an OS as long as the functions of the program can be provided.

Examples of the recording medium for supplying the program are a floppy® disk, hard disk, optical disk, magneto-optical disk, MO, CD-ROM, CD-R, CD-RW, magnetic tape, nonvolatile memory card, ROM, and DVD (DVD-ROM and DVD-R).

The program can also be supplied by the following method. More specifically, a client computer connects to an Internet homepage via the browser of the client computer, and downloads the computer program of the present invention or a compressed file including an automatic installing function from the homepage to a recording medium such as a HD. The program can also be supplied by grouping program codes which form the program of the present invention into a plurality of files, and downloading the files from different homepages. That is, the present invention also includes a WWW server which allows a plurality of users to download the program files for implementing functional processing of the present invention by a computer.

The program can also be supplied by the following method. More specifically, the program according to the present invention is encrypted, stored in a storage medium such as a CD-ROM, and distributed to users. A user who satisfies a predetermined condition is prompted to download decryption key information from a homepage via the Internet. The user executes the encrypted program using the key information, and installs it in a computer, implementing the configuration according to the present invention.

The following embodiment is also assumed in addition to implementing the functions of the above-described embodiments by executing the readout program by the computer. More specifically, an OS or the like running on the computer performs part or all of actual processing on the basis of the instructions of the program. This processing can also implement the functions of the above-described embodiments.

Further, the program read out from the recording medium is written in the memory of a function expansion board inserted into the computer or the memory of a function expansion unit connected to the computer. Then, the functions of the above-described embodiments are implemented based on the instructions of the program. That is, the functions of the above-described embodiments can also be implemented by performing part or all of actual processing by the CPU of the function expansion board or function expansion unit.

The present invention is not limited to the above-described embodiments, and various modifications (including organic combinations of embodiments) can be made without departing from the scope of the invention, and are not excluded from the scope of the invention. For example, in the embodiments, the control unit 205 in the printing apparatus 100 mainly performs various control operations. Instead, for example, an external controller in a housing different from the printing apparatus 100 may also execute some or all of various control operations.

The present invention incorporates a configuration having all configurations individually described in the embodiments and a configuration having the configuration of at least one embodiment unless configurations are incompatible.

For example, the present invention incorporates a configuration corresponding to the following configuration which is an embodiment of the present invention. A description of the following configuration example also includes a description for explaining the configuration of the main part of the above-described embodiments in more detail from another viewpoint, and a supplementary description for confirmation.

As a presupposed constituent feature, the system 1000 is a printing system in which the printing apparatus 100 can execute printing processing of a print job having undergone rendering processing. The rendering processing is to generate an image to be actually printed on a print medium on the basis of input print data. On the premise of this configuration, the control unit 205 according to the embodiment executes analysis processing of condition information of the first print job before the completion of rendering processing of the first print job. Based on the execution result of the analysis processing, the control unit 205 allows the printing apparatus 100 to execute printing processing of the second print job, print execution of which is requested after the first print job, without causing the printing apparatus 100 to start printing processing of the first print job. In the embodiment, the control unit 205 executes this control in the system 1000. In this example, the first print job will be called the first job, and the second print job will be called the second job.

In the embodiment, based on the execution result of the analysis processing which needs to be executed before the start of rendering processing of the first job, the control unit 205 allows the printing apparatus 100 to execute printing processing of the second job without causing the printing apparatus 100 to start printing processing of the first job.

The analysis processing executed before the start of rendering processing of the first job is processing executed by the control unit 205 on condition that the first print job is not the second type print job but the first type print job. Under this condition, based on the execution result of the analysis processing, the control unit 205 allows the printing apparatus 100 to execute printing processing of the second job without causing the printing apparatus 100 to start printing processing of the first job.

Assume that the first job is not the second type print job but the first type print job, as described above. In this case, the control unit 205 executes the second determination processing using rendering processing of the print job as determination processing different from the determination result of the first determination processing corresponding to the execution result of the condition information analysis processing. In the embodiment, the control unit 205 can determine processing to the first job on the basis of the second determination result. In this case, depending on the determination result of the first determination processing, the control unit 205 allows the printing apparatus 100 to execute printing processing of the second job without executing the second determination processing and without causing the printing apparatus 100 to start printing processing of the first job. The control unit 205 executes even this control for the system 1000.

According to the embodiment, the control unit 205 can determine processing to a print job on the basis of the determination result of the first determination processing corresponding to analysis processing of condition information of the print job. In addition, the control unit 205 determines processing to a print job on the basis of the determination result of the second determination processing corresponding to the execution result of rendering processing of the print job. The control unit 205 can also execute this processing. On the premise of this configuration, assume that a target print job whose print execution request is accepted by the system 1000 is not the second type print job but the first type print job. In this case, the control unit 205 executes the first determination processing prior to the second determination processing. To the contrary, assume that the target print job is not the first type print job but the second type print job. In this case, the control unit 205 executes the second determination processing without executing the first determination processing. In this fashion, a plurality of types of determination processes are executed in accordance with the type of job to be processed.

A typical example of a job corresponding to the above-mentioned “first type job” is a “JDF job whose processing conditions are designated in the XML language”. A typical example of a job corresponding to the “second type job” is a “non-JDF job (e.g., PDL job) whose processing conditions are designated in a language other than the XML language”. The above-described configuration is premised on this.

More specifically, the first job is a JDF job out of JDF and non-JDF jobs. In this case, the control unit 205 executes, as the first determination processing, determination processing using the execution result of analysis processing of JDF data of the first job. Based on the first determination result, the control unit 205 allows the printing apparatus 100 to execute printing processing of the second job without executing rendering processing of print data of the first job and without causing the printing apparatus 100 to start printing processing of the first job. In the embodiment, the control unit 205 executes this control for the system 1000.

According to the embodiment, when the first job is a JDF job, the control unit 205 executes the first determination processing corresponding to analysis processing of JDF data of the first job. Based on the determination result of the first determination processing, the control unit 205 determines whether the first job includes processing unperformable by the printing system 1000. Assume that the control unit 205 determines that the first job includes processing unperformable by the printing system 1000. In this case, the control unit 205 controls the system 1000 to inhibit the printing apparatus 100 from starting printing processing of the first job and allow it to execute printing processing of the second job. Assume that, based on the determination result of the first determination processing corresponding to the execution result of analysis processing of JDF data of the first job, the control unit 205 determines that the first job does not include processing unperformable by the system 1000. In this case, the control unit 205 can determine processing to the first job on the basis of the determination result of the second determination processing corresponding to the execution result of rendering processing of print data of the first job.

Various exemplary constituent features described above are also typical features of the printing system 1000 in the embodiment.

As described above, when causing the printing apparatus 100 to execute printing processing of the second job without causing it to start printing processing of the first job, the control unit 205 cancels printing processing of the first job by the printing apparatus 100. The control unit 205 can execute the job cancellation control in the system 1000.

As described above, when causing the printing apparatus 100 to execute printing processing of the second job without causing it to start printing processing of the first job, the control unit 205 reserves printing processing of the first job by the printing apparatus 100. The control unit 205 can execute even the job holding control in the system 1000. When reserving printing processing of the first job by the printing apparatus 100, the control unit 205 holds, in the HD 209, print data necessary for printing processing of the first job. At this time, the control unit 205 can hold, in the HD 209, print data necessary for printing processing of the first job after rendering the print data. The control unit 205 can execute even the storage processing control in the job holding control.

Assume that the control unit 205 inhibits the printing apparatus 100 from starting printing processing of the first job, and instead causes it to execute printing processing of the second job, as described above. In this case, the control unit 205 controls the system 1000 to be able to determine whether to cancel printing processing of the first job in accordance with a user instruction input via the user interface unit.

Assume that the control unit 205 inhibits the printing apparatus 100 from starting printing processing of the first job, and instead causes it to execute printing processing of the second job, as described above. In this case, the control unit 205 controls the system 1000 to be able to determine whether to hold, in the HD 209, print data necessary for printing processing of the first job in accordance with a user instruction input via the user interface unit.

By these configurations, the printing system 1000 of the embodiment capable of attaining various effects exemplified below can be built:

An effect capable of increasing the system productivity while suppressing an output result the user does not want, even in a configuration in which printing processing of a print job (e.g., JDF job) describing printing conditions in a specific format is possible.

An effect capable of performing proper printing processing without any cumbersome user operation even in a configuration in which the system (e.g., the system 1000) can operate based on a print job (e.g., JDF job) describing printing conditions in a specific format.

An effect capable of improving the productivity of jobs in the overall system, the device use efficiency, the device convenience, and the operability of the operator even in a configuration in which printing processing of various types of print jobs such as a JDF job and non-JDF job is possible.

Various examples and embodiments of the present invention have been described. It is apparent to those skilled in the art that the spirit and scope of the invention are not limited to a specific description in the specification.

The present invention can provide a technique capable of increasing the system productivity while suppressing an output result the user does not want, in a configuration in which printing processing of a print job (e.g., JDF job) describing printing conditions in a specific format is performed. The present invention can provide a technique capable of performing proper printing processing without any cumbersome user operation in a configuration in which the system operates based on a print job (e.g., JDF job) describing printing conditions in a specific format. The present invention can provide a technique capable of improving the job processing productivity of the overall system, the device use efficiency, the device convenience, and the operability of the operator in a configuration in which printing processing is performed based on various types of jobs such as a JDF job and non-JDF job.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-012963, filed Jan. 23, 2007, which is hereby incorporated by reference herein in its entirety.

What is claimed is:

1. A system adapted to enable a printing system to perform a plurality of print jobs, the system comprising:
a checker adapted to check data about processing conditions of a certain print job having a certain attribute, a markup language being used for the certain print job; and
a controller adapted to control the printing system to give priority to printing of another print job over printing of the certain print job based on a checking result by the checker.

2. The system according to claim 1, wherein the other print job has another attribute that is different from the certain attribute, and the processing conditions of the other print job are defined by using data different from XML data.

3. The system according to claim 1, wherein, in case that the checker obtains a checking result that the certain print job satisfies a predetermined condition, another checker which performs another checking based on a result of rendering processing of print data performs the other checking to the certain print job.

4. The system according to claim 3, wherein, in case that the checker does not obtain the checking result that the certain print job satisfies the predetermined condition, priority is given to the printing of the other print job without performing the other checking by the other checker.

5. The system according to claim 3, wherein, in case that the checker does not obtain the checking result that the certain print job satisfies the predetermined condition, print data of the certain print job is held in a storage unit without rendering the print data into image data.

6. The system according to claim 3, wherein the other checker performs the other checking to the other print job without performing the checking by the checker.

7. The system according to claim 1, wherein priority is given to the printing of the other print job over the printing of the certain print job by canceling the printing of the certain print job or by suspending the printing of the certain print job.

8. A program product comprising a computer usable storage medium including a program code for causing a computer system to perform a method for enabling a printing system to perform a plurality of print jobs, the method comprising:
using a checker adapted to check data about processing conditions of a certain print job having a certain attribute, a markup language being used for the certain print job; and
controlling the printing system to give priority to printing of another print job over printing of the certain print job based on a checking result by the checker.
